(19) United States
(12) Patent Application Publication
(10) Pub. No.: US 2018/0365796 A1
(43) Pub. Date: Dec. 20, 2018

(54) IMAGE PROCESSING DEVICE

(71) Applicant: OLYMPUS CORPORATION, Tokyo (JP)

(72) Inventors: Keisuke Nakazono, Tokyo (JP); Akira Ueno, Tokyo (JP)

(73) Assignee: OLYMPUS CORPORATION, Tokyo (JP)

(21) Appl. No.: 16/110,083

(22) Filed: Aug. 23, 2018

Related U.S. Application Data
(63) Continuation of application No. PCT/JP2016/056015, filed on Feb. 29, 2016.

(51) Int. Cl. G06T 1/20; G06F 9/38; G06T 1/60

(52) U.S. Cl. CPC G06T 1/20; H04N 5/23229; G06T 1/60; G06F 9/38

(57) ABSTRACT

There is provided an image processing device in which an image processing section of a pipeline configuration in which a plurality of processing modules for performing predetermined processing on input data are connected in series performs image processing on data read from a data storage section via a data bus. The image processing section includes an input/output module incorporated into the pipeline as a processing module configured to perform processing different from the processing to be performed by each of the processing modules. The input/output module performs data transmission from and to an external processing section outside the image processing section via an external interface section without involving the data bus at a position where the input/output module is incorporated into the pipeline and the external interface section converts a format of pixel data to be transmitted by the input/output module.

This application is a continuation application based on PCT Patent Application No. PCT/JP 2016/056015, filed Feb. 29, 2016.

### TECHNICAL FIELD

The present invention relates to an image processing device.

### BACKGROUND ART

In an imaging device such as a still-image camera, a moving-image camera, a medical endoscope camera, or an industrial endoscope camera, various image processing is performed by an image processing device such as a mounted system LSI. Also, various models of imaging devices have been developed according to installed functions, a processing capability (speed), or a price thereof. Thus, it is desirable for an image processing device to have an image processing function for implementing the functions installed in the imaging device. However, from the viewpoint of a development period and costs of an image processing device, developing image processing devices having a necessary image processing function for each model to be developed for an imaging device is not a useful means. Also, a process of developing only an image processing device having many image processing functions and mounting the developed image processing device in common for all imaging devices becomes a cause of hindering low-cost implementation in an imaging device equipped with few functions.

Therefore, technologies of various image processing devices having a configuration in which an image processing function to be executed can be extended have been conventionally proposed. For example, Japanese Unexamined Patent Application, First Publication No. 2008-301090 discloses technology for implementing various image processing devices having different functions and processing capabilities with a plurality of ASICs. In Japanese Unexamined Patent Application, First Publication No. 2008-301090, a low-performance image processing device is implemented at an optimum cost by using a basic functional ASIC having the minimum functions necessary for image processing and a multifunctional high-performance image processing device is implemented using a basic functional ASIC and a high-performance ASIC having many functions. It is conceivable to develop various models of imaging devices by applying the technology disclosed in Japanese Unexamined Patent Application, First Publication No. 2008-301090 to an imaging device. In other words, it is considered that a low-cost imaging device could be implemented by mounting only a low-performance image processing device and a high-performance imaging device with high processing capability could be implemented by mounting both a low-performance image processing device and a high-performance image processing device.

Meanwhile, in many image processing devices mounted in an imaging device, one dynamic random access memory (DRAM) connected thereto is shared by a plurality of built-in processing blocks. In such an image processing device, a plurality of built-in processing blocks are connected to a data bus inside the image processing device, and each processing block accesses the DRAM by direct memory access (DMA) via a data bus.

Also, there is also a processing block for performing pipeline processing by adopting a configuration in which a plurality of processing modules are connected in series among processing blocks included in an image processing device having such a configuration. For example, in an image processing device, an image processing section configured to perform a series of image processing in the imaging device is a processing block configured to perform pipeline processing. In the image processing device having such a configuration, speeding up of a series of image processing in the imaging device is implemented by the pipeline processing in the image processing section in which a plurality of image processing modules configured to perform image processing are connected in series. Also, in the image processing device having such a configuration, overload on a bus bandwidth of the DRAM at the time of image processing is avoided and the power consumption of the image processing device is also reduced because access to the DRAM by each image processing module configured to perform pipeline processing is eliminated except for processing modules at data input and output sides provided in the image processing section.

However, in the imaging device, for the purpose of extending a function, it may be also necessary to insert other image processing for extending the function into any image processing to be performed by configuring a pipeline.

However, although a configuration in which a high-performance image processing device performs processing subsequent to a low-performance image processing device and a configuration using a CPU and a memory provided separately from a low-performance image processing device and a high-performance image processing device are disclosed in the technology disclosed in Japanese Unexamined Patent Application, First Publication No. 2008-301090, a configuration in which a high-performance image processing device performs processing while a low-performance image processing device performs processing and the low-performance image processing device performs processing again is not disclosed therein. In other words, technology for inserting processing of a high-performance image processing device while a low-performance image processing device performs processing is not disclosed in the technology disclosed in Japanese Unexamined Patent Application, First Publication No. 2008-301090. Thus, in the technology disclosed in Japanese Unexamined Patent Application, First Publication No. 2008-301090, a configuration for meeting requirements in an imaging device for inserting other image processing into any image processing for performing pipeline processing cannot be implemented to extend a function.

In the image processing device to which the technology disclosed in Japanese Unexamined Patent Application, First Publication No. 2008-301090 is applied, a configuration in which data is exchanged via the DRAM is conceived when a configuration in which a function is extended by inserting other image processing into any image processing performed according to pipeline processing is conceived. In the case of this configuration, processing in the following procedure is required.

(Procedure 1): The image processing section provided in the low-performance image processing device stores image processed data in the DRAM until the function to be extended is inserted. More specifically, the image processing section provided in the low-performance image processing device acquires the data to be processed from the DRAM connected to the low-performance image processing device by DMA via the data bus and stores image processed data until other image processing for extending a function is inserted in the DRAM connected to the low-performance image processing device by DMA via the data bus according to pipeline processing.

(Procedure 2): Data is transmitted from the low-performance image processing device to the high-performance image processing device. More specifically, an external interface section provided in the low-performance image processing device acquires the data stored in procedure 1 from the DRAM connected to the low-performance image processing device by DMA via the data bus and transmits the data to an external interface section provided in the high-performance image processing device. The external interface section provided in the high-performance image processing device stores the data transmitted from the external interface section provided in the low-performance image processing device in the DRAM connected to the high-performance image processing device by DMA via the data bus.

(Procedure 3): The image processing section provided in the high-performance image processing device stores data obtained by performing image processing of the function to be extended in the DRAM. More specifically, the image processing section provided in the high-performance image processing device acquires data transmitted from the low-performance image processing device from the DRAM connected to the high-performance image processing device by DMA via the data bus and stores data obtained by performing image processing for extending the function in the DRAM connected to the high-performance image processing device by DMA via the data bus.

(Procedure 4): Data is transmitted from the high-performance image processing device to the low-performance image processing device. More specifically, the external interface section provided in the high-performance image processing device acquires the data stored in procedure 3 from the DRAM connected to the high-performance image processing device by DMA via the data bus and transmits the data to the external interface section provided in the low-performance image processing device. The external interface section provided in the low-performance image processing device stores data transmitted from the external interface section provided in the high-performance image processing device in the DRAM connected to the low-performance image processing device by DMA via the data bus.

(Procedure 5): The image processing section provided in the low-performance image processing device performs subsequent image processing on data obtained by performing the image processing of the function to be extended. More specifically, the image processing section provided in the low-performance image processing device acquires the data transmitted from the high-performance image processing device from the DRAM connected to the low-performance image processing device by DMA via the data bus and performs subsequent image processing for pipeline processing and stores data obtained by completing all the image processing in the pipeline processing in the DRAM connected to the low-performance image processing device by DMA via the data bus.

When a case in which other image processing is inserted into any image processing by applying the technology disclosed in Japanese Unexamined Patent Application, First Publication No. 2008-301090 to an image processing device in which a pipeline is configured as described above is conceived, it is necessary to transmit data between DRAMs connected to the image processing devices and the pipeline processing configured in the image processing device is divided into parts, so that a series of image processing cannot be performed at high speed.

For this reason, it is difficult to apply the technology disclosed in Japanese Unexamined Patent Application, First Publication No. 2008-301090 to an image processing device configured to perform pipeline processing. In other words, in the technology disclosed in Japanese Unexamined Patent Application, First Publication No. 2008-301090, it is difficult to implement a configuration in which a function of image processing is extended by configuring a pipeline and inserting an image processing module configured to perform other image processing into any image processing module configured to perform a series of image processing.

Also, it is considered that the technology disclosed in Japanese Unexamined Patent Application, First Publication No. 2008-301090 can be applied to an image processing device that does not perform pipeline processing. In this case, however, because data transmission between the DRAMs connected to the image processing devices is necessary, it is not possible to avoid overload on the bus bandwidth of the DRAM when image processing is performed or to reduce power consumption of the image processing device. This is because speeding up of image processing due to the reduction of a processing time required for accessing the DRAM, the avoidance of overload on the bus bandwidth of the DRAM when image processing is performed, the reduction of power consumption of the image processing device, and the like are implemented without accessing the DRAM until image processing of all image processing modules for performing pipeline processing is completed in the image processing device configured to perform pipeline processing.

### SUMMARY OF INVENTION

### Solution to Problem

According to a first aspect of the present invention, an image processing device is an image processing device in which an image processing section for configuring a pipeline by connecting a plurality of processing modules for performing predetermined processing on input data in series and performing pipeline processing by each of the processing module sequentially performing the processing is connected to a data bus and performs image processing on data read from a data storage section connected to the data bus via the data bus, wherein the image processing section includes an input/output module incorporated into the pipeline as a processing module configured to perform processing different from the processing to be performed by each of the processing modules, and wherein the input/output module outputs processed data obtained by performing the processing of a first processing module which is the processing module located at a stage previous to a position where the input/output module is incorporated into the pipeline to an external processing section outside the image processing section, via an external interface section for inputting and outputting data to and from the external processing section without involving the data bus, and outputs externally processed data input by the external processing section performing external processing on the processed data to a second processing module which is the processing module located at a stage subsequent to the first processing module in the pipeline via the external interface section without involving the data bus, wherein the external interface section converts data to be transmitted in a format according to a specification of the image processing section when pixel data is received from the input/output module into a format of pixel data to be processed by the external processing section, and wherein the external interface section converts a format of externally processed pixel data output from the external processing section into a format in which the image processing section performs image processing when the externally processed pixel data is transmitted from the external processing section.

According to a second aspect of the present invention, an image processing device is an image processing device in which an image processing section for configuring a pipeline by connecting a plurality of processing modules for performing predetermined processing on input data in series and performing pipeline processing by each of the processing module sequentially performing the processing is connected to a data bus and performs image processing on data read from a data storage section connected to the data bus via the data bus, wherein the image processing section includes an input/output module incorporated into the pipeline as a processing module configured to perform processing different from the processing to be performed by each of the processing modules, and wherein the input/output module outputs processed data obtained by performing the processing of a first processing module which is the processing module located at a stage previous to a position where the input/output module is incorporated into the pipeline to an external processing section outside the image processing section, via an external interface section for inputting and outputting data to and from the external processing section without involving the data bus, outputs externally processed data input from the external processing section to a second processing module which is the processing module located at a stage subsequent to the position where the input/output module is incorporated into the pipeline via the external interface section without involving the data bus, or performs both output of the processed data to the external processing section via the external interface section without involving the data bus and output of the externally processed data input by the external processing section performing the external processing an the processed data to the second processing module via the external interface section without involving the data bus, wherein the external interface section converts data to be transmitted in a format according to a specification of the image processing section when pixel data is received from the input/output module into a format of pixel data to be processed by the external processing section, and wherein the external interface section converts a format of externally processed pixel data output from the external processing section into a format in which the image processing section performs image processing when the externally processed pixel data is transmitted from the external processing section.

According to a third aspect of the present invention, in the image processing device according to the above-described first aspect, the input/output module may include an output buffer section configured to temporarily store the processed data; and an input buffer section configured to temporarily store the externally processed data, the input/output module may temporarily store the processed data output by the first processing module in the output buffer section and output the processed data stored in the output buffer section in response to a request from the external processing section, and the input/output module may temporarily store the externally processed data output by the external processing section in the input buffer section and output the externally processed data stored in the input buffer section in response to a request from the second processing module.

According to a fourth aspect of the present invention, in the image processing device according to the above-described third aspect, the input/output module may further include a processing module input control section configured to control writing of the processed data in the output buffer section on the basis of a storage capacity of the output buffer section; an external output control section configured to control reading of the processed data from the output buffer section on the basis of the amount of the processed data stored in the output buffer section; an external input control section configured to control writing of the externally processed data in the input buffer section on the basis of the storage capacity of the input buffer section: and a processing module output control section configured to control reading of the externally processed data from the input buffer section on the basis of the amount of the externally processed data stored in the input buffer section.

According to a fifth aspect of the present invention, in the image processing device according to the above-described fourth aspect, the processing module input control section may write the processed data in the output buffer section for each unit for performing the processing in the first processing module, the external output control section may read the processed data stored in the output buffer section for each unit for performing the external processing in the external processing section, the external input control section may write the externally processed data in the input buffer section for each unit for performing the external processing in the external processing section, and the processing module output control section may read the externally processed data stored in the input buffer section for each unit for performing the processing in the second processing module.

According to a sixth aspect of the present invention, in the image processing device according to the above-described fifth aspect, the external output control section may add output destination information indicating any external processing section to which the processed data is output among a plurality of external processing sections to the processed data.

According to a seventh aspect of the present invention, in the image processing device according to the above-described sixth aspect, the output destination information may be included in additional information in which information of settings of the external processing to be performed on the processed data by the external processing section is shown.

According to an eighth aspect of the present invention, in the image processing device according to the above-described first aspect, the input/output module may be incorporated at at least one position of a beginning, a middle, and an end of the pipeline.

According to a ninth aspect of the present invention, in the image processing device according to the above-described fifth aspect, the processed data and the externally processed data may be image data, each of a unit for performing the processing in the first processing module and the second processing module and a unit for performing the external processing in the external processing section may be a size in which the image data of one frame is divided into a plurality of predetermined blocks, and the storage capacity of the output buffer section and the storage capacity of the input buffer section may be less than the storage capacity for storing pixel data included in the image data of one frame.

### BRIEF DESCRIPTION OF DRAWINGS

FIG. 1 is a block diagram showing a schematic configuration of an image processing device according to a first embodiment of the present invention.

FIG. 2 is a block diagram showing a concept of a configuration of an input/output module provided in an image processing section within the image processing device according to the first embodiment of the present invention.

FIG. 3 is a block diagram showing a schematic configuration of the input/output module provided in the image processing section within the image processing device according to the first embodiment of the present invention.

FIG. 4 is a timing chart showing an example of an operation of an external output section in the input/output module provided in the image processing section within the image processing device according to the first embodiment of the present invention.

FIG. 5 is a timing chart showing an example of an operation of the external input section in the input/output module provided in the image processing section within the image processing device according to the first embodiment of the present invention.

FIG. 6 is a diagram schematically showing a flow of pixel data including the input/output module provided in the image processing section within the image processing device according to the first embodiment of the present invention.

FIG. 7 is a block diagram showing a schematic configuration of an image processing device according to a second embodiment of the present invention.

FIG. 8 is a block diagram showing a schematic configuration of an input/output module provided in an image processing section within the image processing device according to the second embodiment of the present invention.

FIG. 9 is a diagram showing an example of a configuration of external output data output by the input/output module provided in the image processing section within the image processing device according to the second embodiment of the present invention.

FIG. 10 is a diagram schematically showing a flow of pixel data including the input/output module provided in the image processing section within the image processing device according to the second embodiment of the present invention.

FIG. 11 is a block diagram showing a schematic configuration of an image processing device according to a third embodiment of the present invention.

FIG. 12 is a diagram schematically showing a flow of pixel data including an input/output module provided in an image processing section within the image processing device according to the third embodiment of the present invention.

FIG. 13 is a block diagram showing a schematic configuration of a first application example in which the image processing device according to the first embodiment of the present invention is mounted.

FIG. 14 is a diagram schematically showing a flow of pixel data including the input/output module provided in the image processing section within the image processing device according to a first application example of the present invention.

FIG. 15 is a block diagram showing a schematic configuration of a second application example in which the image processing device according to the first embodiment of the present invention is mounted.

FIG. 16 is a diagram schematically showing a flow of pixel data including the input/output module provided in the image processing section within the image processing device according to a second application example of the present invention.

### DESCRIPTION OF EMBODIMENTS

### First Embodiment

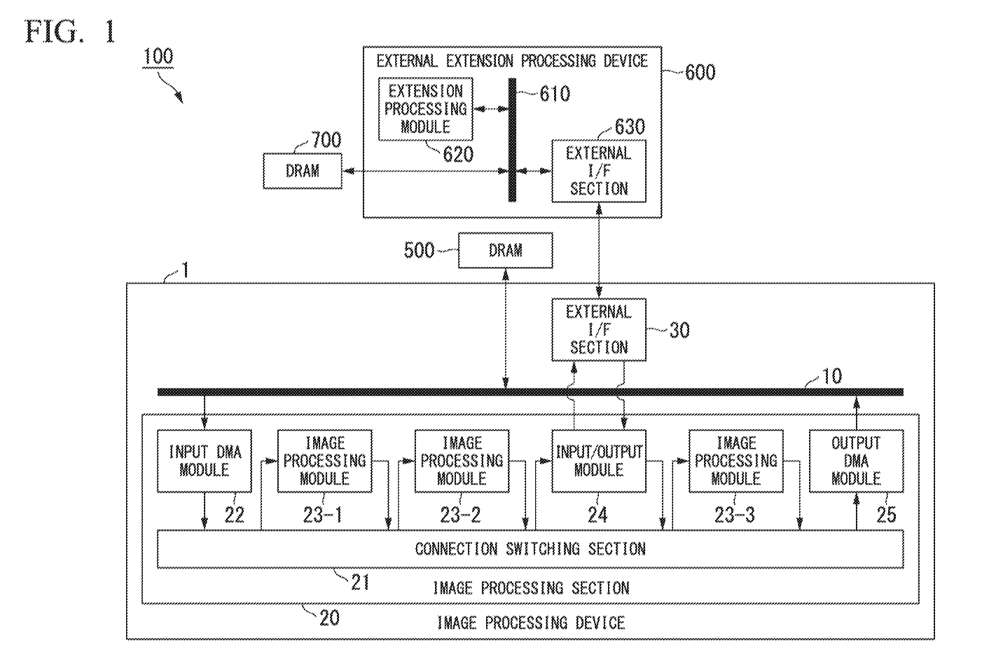

Hereinafter, embodiments of the present invention will be described with reference to the drawings. In the following description, for example, a case in which an image processing device according to a first embodiment of the present invention is mounted in an imaging device such as a still-image camera (hereinafter referred to as an “imaging device 100”) will be described. FIG. 1 is a block diagram showing a schematic configuration of the image processing device according to the first embodiment of the present invention. In FIG. 1, an external extension processing device 600 including a DRAM 500, a DMA bus 610, an extension processing module 620, and an external interface (I/F) section 630 and a DRAM 700 are collectively shown as components within an imaging device 100 related to an image processing device 1 according to the first embodiment of the present invention.

The image processing device 1 shown in FIG. 1 includes a DMA bus 10, an image processing section 20, and an external interface (I/F) section 30. The image processing section 20 includes a connection switching section 21, an input DMA module 22, three image processing modules 23-1 to 23-3, an input/output module 24, and an output DMA module 25.

In FIG. 1, shown of other components connected to each component provided in the imaging device 100 and the DMA bus 10 in the image processing device 1 is omitted. Also, other components included in the image processing device 1 include, for example, an imaging processing section for controlling a solid-state imaging device configured to photoelectrically convert an optical image of a subject formed by a lens provided in the imaging device 100, a recording processing section for performing a recording process of recording data of an image processed by the image processing section 20, a display processing section for displaying data of an image processed by the image processing section 20 on a display section provided in the image processing device 1, and the like. Also, for example, there are also a system control section for controlling the components provided in the image processing device 1 and the external extension processing device 600 and the like as other components included in the imaging device 100.

The DRAM 500 is a data storage section connected to the DMA bus 10 within the image processing device 1 and configured to store various data processed in the imaging device 100. For example, the DRAM 500 stores still-image data output from the solid-state imaging device (not shown) provided in the imaging device 100. In the image processing device 1, still-image data of one frame stored in the DRAM 500 is divided into a plurality of predetermined small blocks and the image processing section performs image processing for each block. In the following description, data included in each block obtained by dividing still-image data of one frame is referred to as “block image data”.

The image processing section 20 is a pipeline processing section configured to perform various image processing predetermined in the image processing device 1 on the input block image data. More specifically, the image processing section 20 sequentially performs image processing in the image processing device 1 according to pipeline processing in which the input DMA module 22, the image processing modules 23-1 to 23-3, and the output DMA module 25 are connected in series. The image processing section 20 reads data of each pixel (hereinafter referred to as “pixel data”) included in the block image data, for example, from the DRAM 500 for every predetermined number of columns and performs image processing by using the read pixel data as one processing unit. In the following description, in terms of pixel data of one processing unit for performing image processing in the image processing section 20, a plurality of pieces of consecutive pixel data included in the same column is referred to as a “unit line”.

Also, the image processing section 20 has a function of selecting image processing included in pipeline processing and a function of changing the order of image processing to be performed according to the pipeline processing, i.e., a function of changing the configuration of a pipeline. More specifically, the image processing section 20 can configure a pipeline for sequentially performing image processing of the image processing modules 23-1 to 23-3, but the image processing section 20 can configure a pipeline for performing image processing of one or more of the image processing modules 23-1 to 23-3 and a pipeline for performing image processing by changing the order of the image processing modules 23-1 to 23-3. In the following description, the image processing modules 23-1 to 23-3 are referred to as an “image processing module 23” when they are represented without distinction. Also, the configuration of the pipeline in the image processing section 20 is changed (set), for example, by the system control section (not shown).

Also, the image processing section 20 has a function of incorporating image processing different from image processing to be executed by each of the image processing modules 23-1 to 23-3 into the pipeline processing. Here, the image processing to be incorporated into the pipeline processing is image processing which is not executed in any of the image processing modules 23-1 to 23-3 and is image processing to be executed by a component provided outside the image processing section (hereinafter referred to as “external image processing”).

In the configuration of the imaging device 100 shown in FIG. 1, the image processing to be executed by the external extension processing device 600 provided outside the image processing device 1 can be incorporated into the pipeline processing as external image processing. In the image processing section 20, the input/output module 24 is incorporated into the pipeline configuration as an image processing module for executing external image processing, so that the external image processing to be executed by the external extension processing device 600 is incorporated into the pipeline processing. Also, as described above, the configuration of the pipeline in the image processing section 20 is changed (set) by, for example, the system control section (not shown). Accordingly, in the image processing section 20, the setting of whether or not to incorporate the input/output module 24 into the pipeline, the setting of a position of the input/output module 24 when the input/output module 24 is incorporated into the pipeline, or the like is performed by, for example, the system control section (not shown), together with the setting of the function of changing the configuration of the pipeline as described above.

In FIG. 1, a configuration in which external image processing to be executed by the external extension processing device 600 is incorporated into the pipeline by incorporating the input/output module 24 between the image processing module 23-2 and the image processing module 23-3 is shown. In other words, in the image processing section 20 shown in FIG. 1, a state in which a pipeline for sequentially performing image processing of the image processing module 23-1, image processing of the image processing module 23-2, image processing of the external extension processing device 600, and image processing of the image processing module 23-3 is configured is shown.

As described above, for example, the position where the input/output module 24 is incorporated into the pipeline is set by the system control section (not shown). In other words, the position where the input/output module 24 is incorporated into the pipeline is not limited to the position shown in FIG. 1, and the input/output module 24 can be incorporated at any position in the pipeline. In other words, the input/output module 24 can be incorporated at any position such as a beginning, a middle, or an end of the pipeline.

The connection switching section 21 switches an output destination of pixel data output by each component provided in the image processing section 20, i.e., switches a connection between the components provided in the image processing section 20. In other words, the connection switching section 21 changes the order of image processing to be performed by the image processing section 20 and the position of external image processing to be incorporated into the pipeline.

For example, if image processing of only the image processing module 23-2 is performed by the image processing section 20, the connection switching section 21 switches a connection of each component so that an output terminal of the input DMA module 22 and an input terminal of the image processing module 23-2 are connected and an output terminal of the image processing module 23-2 and an input terminal of the output DMA module 25 are connected. Also, for example, if the image processing section 20 performs image processing in the order of the image processing module 23-3 and the image processing module 23-1, the connection switching section 21 switches a connection of each component so that the output terminal of the input DMA module 22 and an input terminal of the image processing module 23-3 are connected, an output terminal of the image processing module 23-3 and an input terminal of the image processing module 23-1 are connected, and an output terminal of the image processing module 23-1 and an input terminal of the output DMA module 25 are connected. Also, for example, if the image processing section 20 performs image processing in the order of the image processing module 23-2 and the external extension processing device 600, the connection switching section 21 switches a connection of each component so that the output terminal of the input DMA module 22 and an input terminal of the image processing module 23-2 are connected, an output terminal of the image processing module 23-2 and an input terminal of the input/output module 24 are connected, and an output terminal of the input/output module 24 and an input terminal of the output DMA module 25 are connected. Also, for example, the connection switching section 21 switches a connection of each component provided in the image processing section 20 in accordance with control from the system control section (not shown).

Also, as described above, in the image processing section 20, the input/output module 24 can be incorporated at any position such as a beginning, a middle, or an end of the pipeline. For example, if the image processing section 20 performs image processing in the order of the external extension processing device 600 and the image processing module 23-1, i.e., if the input/output module 24 is incorporated at the beginning of the pipeline, the connection switching section 21 switches a connection of each component so that an output terminal of the input DMA module 22 and an input terminal of the input/output module 24 are connected, the output terminal of the input/output module 24 and the input terminal of the image processing module 23-1 are connected, and the output terminal of the image processing module 23-1 and the input terminal of the output DMA module 25 are connected. Also, for example, if the image processing section 20 performs image processing in the order of the image processing module 23-2, the external extension processing device 600, and the image processing module 23-3, i.e., if the input/output module 24 is incorporated at the middle of the pipeline, the connection switching section 21 switches a connection of each component so that the output terminal of the input DMA module 22 and the input terminal of the image processing module 23-2 are connected, the output terminal of the image processing module 23-2 and the input terminal of the input/output module 24 are connected, the output terminal of the input/output module 24 and the input terminal of the image processing module 23-3 are connected, and the output terminal of the image processing module 23-3 and the input terminal of the output DMA module 25, are connected. Also, for example, if the image processing section 20 performs image processing in the order of the image processing module 23-3 and the external extension processing device 600, i.e., if the input/output module 24 is incorporated at the end of the pipeline, the connection switching section 21 switches a connection of each component so that the output terminal of the input DMA module 22 and the input terminal of the image processing module 23-3 are connected, the output terminal of the image processing module 23-3 and the input terminal of the input/output module 24 are connected, and the output terminal of the input/output module 24 and the input terminal of the output DMA module 25 are connected.

Also, in the image processing section 20, it is possible to incorporate only the input/output module 24 into the pipeline. More specifically, the connection switching section 21 switches a connection of each component so that the output terminal of the input DMA module 22 and the input terminal of the input/output module 24 are connected and the output terminal of the input/output module 24 and the input terminal of the output DMA module 25 are connected. Thereby, in the image processing section 20, it is possible to perform the processing of only the input/output module 24, i.e., only the external image processing of the external extension processing device 600, as the pipeline processing.

The input DMA module 22 is a processing module for reading pixel data included in block image data stored in the DRAM 500 for each unit line by DMA via the DMA bus 10 and outputting the read pixel data to any image processing module 23 which is a processing module for performing the next image processing or the input/output module 24 via the connection switching section 21. The input DMA module 22 reads pixel data from the DRAM 500 via the DMA bus 10, for example, in accordance with the control from the system control section (not shown), and outputs the read pixel data to any image processing module 23 or the input/output module 24 which is a connection destination to which a connection is switched by the connection switching section 21.

Also, the input DMA module 22 may be configured to include a data buffer capable of temporarily storing pixel data for a predetermined number of unit lines. In the case of such a configuration, the input DMA module 22 may temporarily store the pixel data read from the DRAM 500 via the DMA bus 10 in the data buffer and output the pixel data temporarily stored in the data buffer to any image processing module 23 or the input/output module 24 which is a connection destination to which a connection has been switched by the connection switching section 21.

Each of the image processing modules 23-1 to 23-3 is a processing module configured to perform various predetermined digital image processing on pixel data input via the connection switching section 21 from the input DMA module 22, another image processing module 23, or the input/output module 24 which is a connection destination to which a connection has been switched by the connection switching section 21. The image processing to be performed by each of the image processing modules 23-1 to 23-3 includes various image processing. The image processing to be performed by the image processing module 23 includes, for example, YC processing for generating a Y (luminance) signal and a C (color) signal corresponding to pixel data, a noise reduction process of reducing noise included in pixel data, LPF processing of suppressing a high-frequency component in an image represented by pixel data, an edge enhancement process of enhancing the outline of a subject in an image, and the like. For example, each of the image processing modules 23-1 to 23-3 performs image processing on the pixel data input via the connection switching section 21, for example, in accordance with control from the system control section (not shown), and outputs the pixel data obtained by performing the image processing to another image processing module 23, the input/output module 24, or the output DMA module 25 which is a connection destination to which a connection has been switched by the connection switching section 21.

Also, each of the image processing modules 23-1 to 23-3 may be configured to include a data buffer capable of temporarily storing pixel data for a predetermined number of unit lines. In the case of such a configuration, each of the image processing modules 23-1 to 23-3 may temporarily store pixel data input via the connection switching section 21 in the data buffer and output the pixel data temporarily stored in the data buffer to another image processing module 23, the input/output module 24, or the output DMA module 25 which is a connection destination to which a connection has been switched by the connection switching section 21. Alternatively, each of the image processing modules 23-1 to 23-3 may perform image processing on pixel data input via the connection switching section 21 to temporarily store the pixel data in the data buffer and output the pixel data temporarily stored in the data buffer to another image processing module 23, the input/output module 24, or the output DMA module 25 which is a connection destination to which a connection has been switched by the connection switching section 21.

Also, in the following description, pixel data after image processing is performed will be referred to as “processed pixel data” when distinguished from pixel data to be subjected to image processing stored in the DRAM 500.

The input/output module 24 is an interface module configured to incorporate external image processing to be executed by a component provided outside the image processing section 20 into pipeline processing. For example, in accordance with control from the system control section (not shown), the input/output module 24 directly outputs the pixel data input via the connection switching section 21 from either the input DMA module 22 or the image processing module 23 which is a connection destination to which a connection has been switched by the connection switching section 21 to the connected external interface section 30 without involving the DMA bus 10. Also, for example, in accordance with control from the system control section (not shown), the input/output module 24 outputs pixel data obtained by performing external image processing directly input without involving the DMA bus 10 from the connected external interface section 30 to one of the image processing modules 23 or the output DMA module 25 which is a connection destination to which a connection has been switched by the connection switching section 21.

A detailed description of a configuration of the input/output module 24, an operation when the input/output module 24 incorporates external image processing into the pipeline processing of the image processing section 20, and the like will be given below. Also, in the following description, pixel data after the external image processing is performed is referred to as “externally processed pixel data” when the pixel data subjected to the external image processing is distinguished from pixel data to be subjected to image processing stored in the DRAM 500 or pixel data after any one of the image processing modules 23 performs image processing (processed pixel data).

The output DMA module 25 is a processing module for writing (storing) processed pixel data input via the connection switching section 21 from any one of the image processing modules 23 which is a connection destination to which a connection has been switched by the connection switching section 21 or externally processed pixel data input via the connection switching section 21 from the input/output module 24 in the DRAM 500 by DMA via the DMA bus 10. The output DMA module 25 outputs processed pixel data or externally processed pixel data input via the connection switching section 21 to the DRAM 500 via the DMA bus 10, for example, in accordance with control from the system control section (not shown).

Also, the output DMA module 25 may be configured to include a data buffer capable of temporarily storing processed pixel data or externally processed pixel data for a predetermined number of unit lines. In the case of such a configuration, the output DMA module 25 may temporarily store the processed pixel data or the externally processed pixel data input via the connection switching section 21 in the data buffer and output the processed pixel data or the externally processed pixel data temporarily stored in the data buffer to the DRAM 500 via the DMA bus 10.

Also, in the following description, processed pixel data output by each of the image processing modules 23 and externally processed pixel data output by the input/output module 24 are simply referred to as “processed pixel data” when they are represented without distinction.

In this manner, in the image processing section 20, each image processing module 23 performs a series of image processing based on pipeline processing on block image data by dividing still-image data of one frame into block image data and sequentially performing image processing according to, for example, control from the system control section (not shown), on pixel data included in the block image data for each unit line. Also, in the image processing section 20, external image processing which is not executed by any one of the image processing modules 23 is executed by, for example, a component provided outside the image processing section 20 (for example, the external extension processing device 600 in FIG. 1) and incorporated into the pipeline processing, for example, in accordance with control from the system control section (not shown). At this time, the image processing section 20 incorporates the input/output module 24 into the pipeline configuration as an image processing module for executing the external image processing. Thereby, in the case of image processing that cannot be executed by the image processing section 20 in the image processing device 1, it is possible to perform processing as in the pipeline processing performed by the image processing section 20. In other words, in the image processing device 1, the pipeline processing in the image processing section 20 can be extended.

The external interface section 30 is a connection section configured to connect the image processing device 1 and an external extension processing device 600 provided outside the image processing device 1 to be incorporated into the pipeline configuration and exchange data between the image processing device 1 and the external extension processing device 600. The external interface section 30 directly transmits the pixel data input from the input/output module 24 to the external extension processing device 600 without involving the DMA bus 10. Also, the external interface section 30 directly outputs the externally processed pixel data transmitted from the external extension processing device 600 to the input/output module 24 without involving the DMA bus 10.

As a scheme of transmitting data to the external extension processing device 600 in the external interface section 30, for example, schemes according to various predetermined specifications such as an advanced extensible interface (AXI) specification and a high-speed serial bus specification such as a peripheral component interconnect-express (PCI-Express) specification to be used between two or more system LSIs are adopted. Also, the specifications or schemes for transmitting data to the external extension processing device 600 in the external interface section 30 are not limited to the above-described specifications or schemes. In other words, various existing specifications or schemes used for transmitting data between two or more system LSIs can be adopted as the data transmission scheme in the external interface section 30. Also, the external interface section 30 may have a configuration in which a plurality of specifications or schemes for use in transmitting data between two or more system LSIs are adopted and a data transmission scheme is changed in accordance with a data transmission specification or scheme adopted in the system LSI (the external extension processing device 600 in FIG. 1) connected to the image processing device 1.

Also, the external interface section 30 may include a function of matching the format of the pixel data output from the input/output module 24 and the format of the data to be processed by the external extension processing device 600 when data is received and transmitted from and to the external extension processing device 600. For example, when the pixel data is transmitted to the external extension processing device 600, the external interface section 30 may include a function of converting a format of pixel data output from the input/output module 24 into a format according to a specification during transmission to the external extension processing device 600 when the pixel data is transmitted to the external extension processing device 600. Also, the external interface section 30 may include a function of converting data to be transmitted in a format according to a specification of the external extension processing device 600 into a format to be processed by the input/output module 24, i.e., a format of pixel data on which the image processing module 23 continues to perform image processing, when externally processed pixel data is received from the external extension processing device 600.

The external extension processing device 600 is an image processing device (system LSI) provided outside the image processing device 1 in the imaging device 100 and configured to perform image processing incorporated into a pipeline configured within the image processing section 20 provided in the image processing device 1. The external extension processing device 600 executes image processing that is not executed in any image processing modules 23 within the image processing section 20 provided in the image processing device 1, i.e., external image processing for extending image processing to be executed in the image processing device 1. The external extension processing device 600 performs predetermined digital external image processing on pixel data input from the image processing device 1 via the external interface section 630 and outputs pixel data obtained by the external image processing (externally processed pixel data) to the image processing device 1 via the external interface section 630.

Also, in FIG. 1, the external extension processing device 600 of a configuration using the connected DRAM 700 in various processes and operations other than the external image processing in the external extension processing device 600 is shown. However, the external extension processing device 600 may be configured to use the DRAM 700 when external image processing is executed.

The external interface section 630 is a connection section connected to the external interface section 30 provided in the image processing device 1 and configured to exchange data between the external extension processing device 600 and the image processing device 1. The external interface section 630 outputs pixel data transmitted from the image processing device 1, i.e., pixel data output from the external interface section 30 provided in the image processing device 1 (pixel data output from the input/output module 24 within the image processing section 20 provided in the image processing device 1), to the extension processing module 620. Also, the external interface section 630 transmits the externally processed pixel data obtained by performing the external image processing output from the extension processing module 620 to the image processing device 1, i.e., transmits the externally processed pixel data to the external interface section 30 provided in the image processing device 1. Thereby, externally processed pixel data obtained by the external extension processing device 600 executing the external image processing is output to the input/output module 24 within the image processing section 20 provided in the image processing device 1. In other words, the external extension processing device 600 is incorporated into the pipeline configured within the image processing section 20 provided in the image processing device 1.

Also, in place of the external interface section 30 provided in the image processing device 1, the external interface section 630 may include a function of matching the format of the pixel data output from the input/output module 24 and the format of the data to be processed by the extension processing module 620 when data is received and transmitted from and to the external interface section 30 provided in the image processing device 1. For example, the external interface section 630 may include a function of converting data transmitted in a format corresponding to the specification of the image processing device 1 into a format of pixel data to be processed by the extension processing module 620 when the pixel data is received from the image processing device 1. Also, the external interface section 630 may include a function of converting the format of the externally processed pixel data output from the extension processing module 620 into a format according to a specification during transmission to the image processing device 1, i.e., a format in which the image processing module 23 continues to perform image processing, when externally processed pixel data is transmitted to the image processing device 1.

The extension processing module 620 is a processing module configured to perform predetermined external image processing on the pixel data input from the external interface section 630 via the DMA bus 610. The external image processing to be performed by the extension processing module 620 includes various image processing. The external image processing to be performed by the extension processing module 620 also includes, for example, an image interpolation process accompanied by the conversion of a position (coordinates) of each pixel included in the block image data, and the like. The image interpolation process includes, for example, various processes such as a resizing process of changing (enlarging or reducing) the size of an image, a distortion correction process of correcting distortion such as magnification chromatic aberration and distortion aberration included in an image, and a shape correction process of performing correction of the shape of an image such as trapezoidal correction. For example, in accordance with control from the system control section (not shown), the extension processing module 620 performs external image processing on the pixel data input via the external interface section 630 and outputs the externally processed pixel data obtained by performing the external image processing to the external interface section 630.

Also, when the extension processing module 620 performs the external image processing on the input pixel data, it is also possible to use the DRAM 700 connected to the external extension processing device 600.

The DRAM 700 is a data storage section connected to the DMA bus 610 within the external extension processing device 600 and configured to store various data when external image processing is executed in the imaging device 100. For example, the DRAM 700 temporarily stores pixel data input from the image processing device 1 via the external interface section 630, data during external image processing of the extension processing module 620, a result of completing processing (externally processed pixel data), or the like.

According to such a configuration, in the imaging device 100, external image processing to be executed by the external extension processing device 600 is incorporated into the pipeline processing based on the image processing to be executed by each of the image processing modules 23 within the image processing section 20 provided in the image processing device 1. Thereby, in the imaging device 100, it is also possible to extend image processing as in the pipeline processing performed by the image processing section 20 provided in the image processing device 1 by connecting the external extension processing device 600 to the image processing device 1 with respect to image processing which cannot be executed by only the image processing device 1.

Next, the configuration and operation of the input/output module 24 provided in the image processing section 20 in the image processing device 1 will be described.

Also, although the input/output module 24 can be incorporated at any position in the pipeline as described above, the input/output module 24 will be described as being incorporated at a position between two image processing modules 23, i.e., the image processing module 23 will be described as being connected to each of a stage previous to the input/output module 24 and a stage subsequent to the input/output module 24, in the following description.

First, a concept of an operation in which pixel data is received and transmitted from and to the external interface section 30 in the input/output module 24 provided in the image processing section 20 will be described. As described above, pixel data for performing the external image processing in the image processing section 20 is output to the external extension processing device 600 via the external interface section 30 connected to the input/output module 24. Also, as described above, in the image processing section 20, each image processing module 23 performs image processing using a plurality of unit lines as one processing unit. Thus, the pixel data to be subjected to the external image processing in the image processing section 20 is also input to the input/output module 24 for each processing unit and externally processed pixel data obtained by performing the external image processing is also output from the input/output module 24 for each processing unit. In other words, in the image processing section 20, the exchange of pixel data between the input/output module 24 and the image processing module 23 connected to a stage previous to the input/output module 24 and a stage subsequent to the input/output module 24 is also performed for each processing unit. However, as in each image processing module 23 provided in the image processing section 20, the external extension processing device 600 connected to the image processing device 1 does not necessarily perform external image processing for each processing unit. Thus, the input/output module 24 receives the pixel data output from the image processing module 23 connected to the previous stage for each processing unit and outputs the received pixel data to the external extension processing device 600 for each processing unit for performing external image processing. Also, the input/output module 24 receives the externally processed pixel data output from the external extension processing device 600 for each processing unit of the external image processing and outputs the received externally processed pixel data to the image processing module 23 connected to the subsequent stage for each processing unit for performing image processing of each image processing module 23.

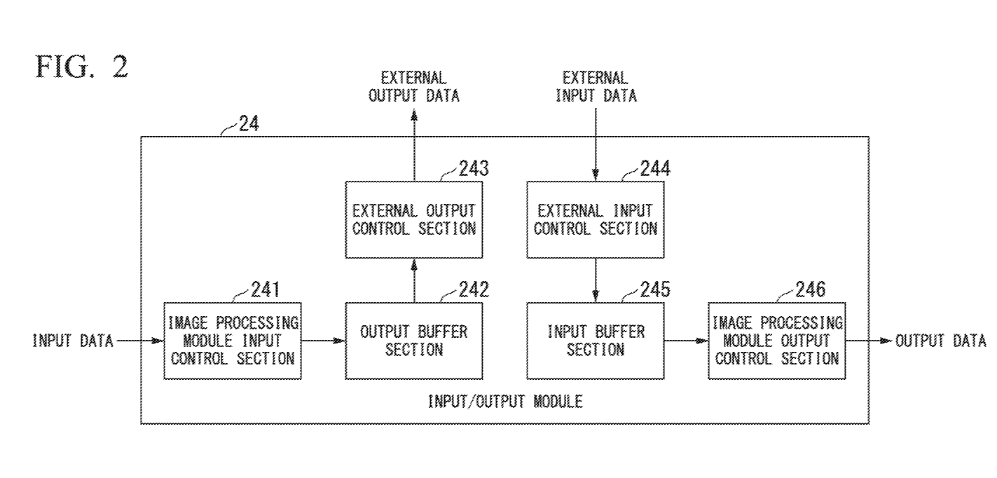

FIG. 2 is a block diagram showing a concept of a configuration of the input/output module 24 provided in the image processing section 20 within the image processing device 1 according to the first embodiment of the present invention. FIG. 2 shows a basic configuration for describing a conceptual operation of the input/output module 24. As shown in FIG. 2, the input/output module 24 includes an image processing module input control section 241, an output buffer section 242, an external output control section 243, an external input control section 244, an input buffer section 245, and an image processing module output control section 246.

The image processing module input control section 241 performs control for causing input data (pixel data) output from the image processing module 23 connected to a stage previous to the input/output module 24, i.e., pixel data to be output to the external extension processing device 600 via the external interface section 30, to be temporarily stored in the output buffer section 242.

The output buffer section 242 is a data buffer configured to temporarily store input data (pixel data) input to the input/output module 24. For example, the output buffer section 242 includes a memory such as a static random access memory (SRAM).

The output buffer section 242 has a storage capacity capable of temporarily storing the pixel data of a predetermined number of unit lines output from the image processing module 23 connected to a stage previous to the input/output module 24. The output buffer section 242 temporarily stores input data (pixel data) which has been input in accordance with the control of the image processing module input control section 241. Also, in accordance with the control from the external output control section 243, the output buffer section 242 outputs the stored pixel data as external output data to the external interface section 30. Thereby, the stored pixel data is transmitted to the external extension processing device 600 via the external interface section 30.

The external output control section 243 performs control for reading the input data (pixel data) stored in the output buffer section 242 and causing the read input data (pixel data) to be output to the external interface section 30 connected to the input/output module 24.

The external input control section 244 performs control for causing external input data (externally processed pixel data) output from the external interface section 30, i.e., externally processed pixel data output from the external extension processing device 600 via the external interface section 30, to be temporarily stored in the input buffer section 245.

The input buffer section 245 is a data buffer configured to temporarily store external input data (externally processed pixel data) input to the input/output module 24. Similar to the output buffer section 242, the input buffer section 245 also includes a memory such as, for example, an SRAM. The input buffer section 245 has a storage capacity capable of temporarily storing the externally processed pixel data for a predetermined number of unit lines output from the external extension processing device 600 via the external interface section 30 as output data. The input buffer section 245 temporarily stores input data (externally processed pixel data) which has been input in accordance with control from the external input control section 244. Also, in accordance with the control from the image processing module output control section 246, the input buffer section 245 outputs the stored externally processed pixel data as output data to the image processing module 23 connected to the stage subsequent to the input/output module 24.

The image processing module output control section 246 performs control for reading the external input data (externally processed pixel data) stored in the input buffer section 245 and causing the read external input data (externally processed pixel data) to be output to the image processing module 23 connected to the stage subsequent to the input/output module 24.

According to such a configuration, the input/output module 24 controls a timing at which pixel data is exchanged between the external extension processing device 600 connected to the image processing device 1 and the image processing modules 23 connected to the previous stage and the subsequent stage. In other words, the input/output module 24 controls a timing at which pixel data is exchanged between the external extension processing device 600 and the image processing module 23 as if the external extension processing device 600 were the image processing module 23 provided within the image processing section 20.

Also, in the external extension processing device 600, the number of pieces of input data (pixel data), i.e., the number of unit lines, necessary for performing the external image processing differs according to details of the external image processing to be executed by the external extension processing device 600. Thus, it is desirable that storage capacities of the output buffer section 242 and the input buffer section 245 be storage capacities capable of satisfying at least the number required for the external extension processing device 600 to perform external image processing, i.e., a unit of external image processing in the external extension processing device 600, and storing a number of pieces of pixel data or externally processed pixel data on which the pipeline processing in the image processing section 20 is smoothly performed. For example, it is desirable that the storage capacities of the output buffer section 242 and the input buffer section 245 be predetermined to be storage capacities for performing the pipeline processing normally on the basis of details of the assumed external image processing, a delay time until the externally processed image data is output to the image processing module 23 assumed to be connected to the subsequent stage after processed pixel data is output from the image processing module 23 assumed to be connected to the previous stage, or the like. Also, if the data buffer is provided in the image processing modules 23 assumed to be connected to the previous and subsequent stages, it is desirable that the storage capacities of the output buffer section 242 and the input buffer section 245 be predetermined to be storage capacities for performing the pipeline processing normally on the basis of the storage capacity of a data buffer provided in each image processing module 23, a delay time, or the like. Also, the storage capacity of the output buffer section 242 or the input buffer section 245 may be determined to be a storage capacity with a predetermined margin.

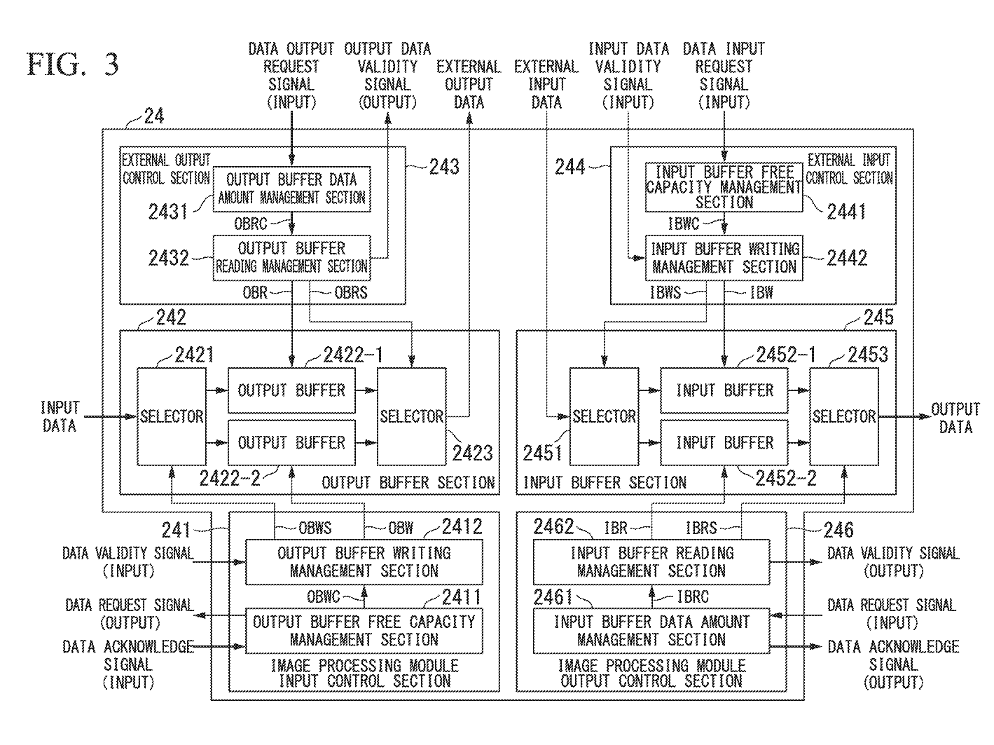

Next, the configuration of the input/output module 24 provided in the image processing section 20 in the image processing device 1 will be described. FIG. 3 is a block diagram showing a schematic configuration of the input/output module 24 provided in the image processing section 20 within the image processing device 1 according to the first embodiment of the present invention. In FIG. 3, a basic configuration of the input/output module 24 is shown. As in a configuration for describing a conceptual operation shown in FIG. 2, the input/output module 24 shown in FIG. 3 includes an image processing module input control section 241, an output buffer section 242, an external output control section 243, an external input control section 244, an input buffer section 245, and an image processing module output control section 246.

According to the configuration of the image processing module input control section 241, the output buffer section 242, and the external output control section 243 in the input/output module 24, input data (pixel data) output from the image processing module 23 connected to the previous stage is temporarily stored in the output buffer section 242 and the pixel data temporarily stored in the output buffer section 242 is output as external output data in response to a data output request from the connected external interface section 30. Also, according to the configuration of the external input control section 244, the input buffer section 245, and the image processing module output control section 246 in the input/output module 24, external input data (externally processed pixel data) output from the external interface section 30 is temporarily stored in the input buffer section 245 and the externally processed pixel data temporarily stored in the input buffer section 245 is output as output data in response to a data output request from the image processing module 23 connected to the subsequent stage. In the following description, the configuration of the image processing module input control section 241, the output buffer section 242, and the external output control section 243 is referred to as an “external output section” and the configuration of the external input control section 244, the input buffer section 245, and the image processing module output control section 246 is referred to as an “external input section”.

First, the external output section in the input/output module 24 will be described.

As described above, the output buffer section 242 is a data buffer configured to temporarily store input data (pixel data) input to the input/output module 24. In FIG. 3, the output buffer section 242 of a so-called double buffer configuration including two data buffers and configured to operate so that writing and reading of pixel data of one processing unit can be performed in the same period by alternately switching storage (writing) and output (reading) of pixel data in the data buffers to reverse operations is shown. The output buffer section 242 shown in FIG. 3 includes a selector 2421, two output buffers 2422-1 and 2422-2, and a selector 2423.

The selector 2421 is a selection section configured to select a data buffer in which pixel data is written in the output buffer section 242. The selector 2421 selects one output buffer 2422 which is either the output buffer 2422-1 or the output buffer 2422-2 as a data buffer in which pixel data is written in accordance with an output buffer writing selection signal OBWS output from the image processing module input control section 241. Then, the selector 2421 outputs the input data (pixel data) input to the input/output module 24 to the output buffer 2422 which is either of the output buffer 2422-1 or the output buffer 2422-2 which is selected.

The selector 2423 is a selection section configured to select a data buffer from which pixel data stored in the output buffer section 242 is read. In accordance with an output buffer reading selection signal OBRS output from the external output control section 243, the selector 2423 selects the output buffer 2422 which is either the output buffer 2422-1 or the output buffer 2422-2 as a data buffer from which the stored pixel data is read. Then, the selector 2423 outputs the pixel data read from the output buffer 2422 which is either the selected output buffer 2422-1 or the selected output buffer 2422-2 as external output data to the external interface section 30. Thereby, the external output data (pixel data) is transmitted to the external extension processing device 600 by the external interface section 30.

Each of the output buffer 2422-1 and the output buffer 2422-2 is a data buffer of a storage capacity for temporarily storing pixel data of a predetermined number of unit lines. The output buffer 2422 which is either the output buffer 2422-1 or the output buffer 2422-2 selected as the data buffer in which the pixel data is written by the selector 2421 writes (stores) input data (pixel data) input via the selector 2421 in accordance with an output buffer writing signal OBW output from the image processing module input control section 241. On the other hand, the output buffer 2422 which is either the output buffer 2422-1 or the output buffer 2422-2 selected as the data buffer from which the stored pixel data is read by the selector 2423 reads the stored pixel data to output the read pixel data to the selector 2423 in accordance with the output buffer reading signal OBR output from the external output control section 243.

As described above, the image processing module input control section 241 controls the storage (writing) of the input data (pixel data) output from the image processing module 23 connected to the stage previous to the input/output module 24 in the output buffer section 242. The image processing module input control section 241 shown in FIG. 3 includes an output buffer free capacity management section 2411 and an output buffer writing management section 2412.

The output buffer free capacity management section 2411 monitors the storage capacity of each of the output buffer 2422-1 and the output buffer 2422-2 provided in the output buffer section 242, and a state notification signal indicating an operation state of the input/output module 24 is output to the image processing module 23 connected to the previous stage in accordance with a result of monitoring the storage capacity. Also, the output buffer free capacity management section 2411 instructs the output buffer writing management section 2412 to store (write) the input data (pixel data) in the output buffer 2422.

More specifically, the output buffer free capacity management section 2411 monitors whether or not there is free storage capacity for writing (temporarily storing) the input data (pixel data) output from the image processing module 23 connected to the previous stage in the other output buffer 2422 different from the output buffer 2422 storing the pixel data which is not read by the external output control section 243. Then, if the result of monitoring the free storage capacity indicates that there is free storage capacity for writing (temporarily storing) the input data (pixel data) output from the image processing module 23 connected to the previous stage in the other output buffer 2422 different from the output buffer 2422 which has already stored the pixel data to be read by the external output control section 243, the output buffer free capacity management section 2411 determines that the output buffer 2422 is brought into a state in which input data (pixel data) output from the image processing module 23 connected to the previous stage can be written. In this case, the output buffer free capacity management section 2411 outputs a data request signal for requesting an output of input data (pixel data) as a state notification signal indicating a state in which input data can be received to the image processing module 23 connected to the previous stage. When a data acknowledge signal indicating that input data (pixel data) is to be output from the image processing module 23 connected to the previous stage in accordance with the output data request signal is input, the output buffer flee capacity management section 2411 outputs an output buffer writing control signal OBWC for issuing an instruction for receiving and writing (temporarily storing) the input data (pixel data) corresponding to the data acknowledge signal to the output buffer writing management section 2412. The output buffer writing control signal OBWC output by the output buffer free capacity management section 2411 includes information of the output buffer 2422 determined to have free storage capacity.

On the other hand, if a result of monitoring the free storage capacity indicates that there is no free storage capacity in the output buffer 2422, the output buffer free capacity management section 2411 determines that input data (pixel data) output from the image processing module 23 connected to the previous stage cannot be written in any output buffer 2422. In this case, the output buffer free capacity management section 2411 outputs a data request signal indicating that output of input data (pixel data) is not requested as a state notification signal indicating that input data cannot be received to the image processing module 23 connected to the previous stage. The output buffer free capacity management section 2411 may indicate that an output of input data (pixel data) is not requested by a signal different from the data request signal.

On the basis of the output buffer writing control signal OBWC output from the output buffer free capacity management section 2411, the output buffer writing management section 2412 outputs a control signal for controlling writing of input data (pixel data) to the output buffer section 242.

More specifically, the output buffer writing management section 2412 outputs an output buffer writing selection signal OBWS for selecting the output buffer 2422 for writing (temporarily storing) the input data (pixel data) output from the image processing module 23 connected to the previous stage to the selector 2421 provided in the output buffer section 242 on the basis of the information of the output buffer 2422 determined to have free storage capacity included in the output buffer writing control signal OBWC.

Also, in response to the output buffer writing control signal OBWC output from the output buffer free capacity management section 2411, the output buffer writing management section 2412 outputs an output buffer writing signal OBW indicating a timing at which input data (pixel data) output from the image processing module 23 connected to the previous stage is written in the output buffer 2422 selected within the output buffer section 242. At this time, the output buffer writing management section 2412 determines whether or not input data which has currently been input is valid pixel data on the basis of a data validity signal indicating whether or not each piece of pixel data included in the unit line output together with the input data (pixel data) from the image processing module 23 connected to the previous stage is valid pixel data. Then, the output buffer writing management section 2412 outputs the output buffer writing signal OBW at a timing at which only valid input data (pixel data) is written in the output buffer 2422. Thereby, the output buffer section 242 writes (temporarily stores) only valid input data (pixel data) in the selected output buffer 2422.

As described above, the external output control section 243 controls the output (reading) of input data (pixel data) stored in the output buffer section 242. The external output control section 243 shown in FIG. 3 includes an output buffer data amount management section 2431 and an output buffer reading management section 2432.

The output buffer data amount management section 2431 monitors the storage capacities of the output buffer 2422-1 and the output buffer 2422-2 provided in the output buffer section 242 and instructs the output buffer reading management section 2432 to output (read) the pixel data stored in the output buffer 2422 in accordance with the result of monitoring the storage capacities.

More specifically, the output buffer data amount management section 2431 monitors an amount of input data (pixel data) for which writing in the other output buffer 2422 different from the output buffer 2422 in which input data (pixel data) is written by the image processing module input control section 241 is completed. Then, if a result of monitoring the amount of pixel data indicates that the pixel data to be output as external output data to the external interface section 30 has already been stored in the output buffer 2422, the output buffer data amount management section 2431 determines that the output buffer 2422 is brought into a state in which the pixel data can be read and output to the external interface section 30. In this case, when the data output request signal for requesting the output of the external output data (pixel data) is input from the connected external interface section 30, the output buffer data amount management section 2431 outputs an output buffer reading control signal OBRC for issuing an instruction for reading (outputting) the external output data (pixel data) corresponding to the data output request signal to the output buffer reading management section 2432.

Also, the output buffer reading control signal OBRC output by the output buffer data amount management section 2431 includes information of the output buffer 2422 for which it is determined that writing of pixel data has been completed. The output buffer data amount management section 2431 may output a data output reception signal indicating that an output of external output data (pixel data) according to the data output request signal has been received to the external interface section 30.

On the other hand, if the result of monitoring the amount of pixel data indicates that the pixel data to be output as the external output data is not stored in the output buffer 2422, the output buffer data amount management section 2431 determines that pixel data cannot be read from any output buffer 2422. In this case, the output buffer data amount management section 2431 may output a data output reception signal indicating that the output of the external output data (pixel data) according to the data output request signal cannot be received to the external interface section 30. Also, at this time, the data output reception signal may indicate a state in which the output of the external output data (pixel data) cannot be received by a logic level of the data output reception signal or a signal different from the data output reception signal.

The output buffer reading management section 2432 outputs a control signal for controlling the reading (output) of input data (pixel data) stored in the output buffer section 242 to the output buffer section 242 on the basis of the output buffer reading control signal OBRC output from the output buffer data amount management section 2431.

More specifically, the output buffer reading management section 2432 outputs an output buffer reading selection signal OBRS for selecting the output buffer 2422 from which the stored pixel data is read (output) to the selector 2423 provided in the output buffer section 242 on the basis of information of the output buffer 2422 for which it is determined that writing of pixel data has been completed included in the output buffer reading control signal OBRC. Also, the output buffer reading management section 2432 outputs an output buffer reading signal OBR indicating a timing at which the stored pixel data is read and output to the connected external interface section 30 to the selected output buffer 2422 within the output buffer section 242 in accordance with the output buffer reading control signal OBRC output from the output buffer data amount management section 2431. Thereby, the output buffer section 242 reads stored pixel data and outputs the read pixel data as external output data to the external interface section 30 in accordance with the output buffer reading signal OBR. At this time, the output buffer reading management section 2432 outputs an output data validity signal indicating whether or not pixel data included in a unit line read (output) as the external output data from the output buffer 2422 is valid pixel data to the external interface section 30.

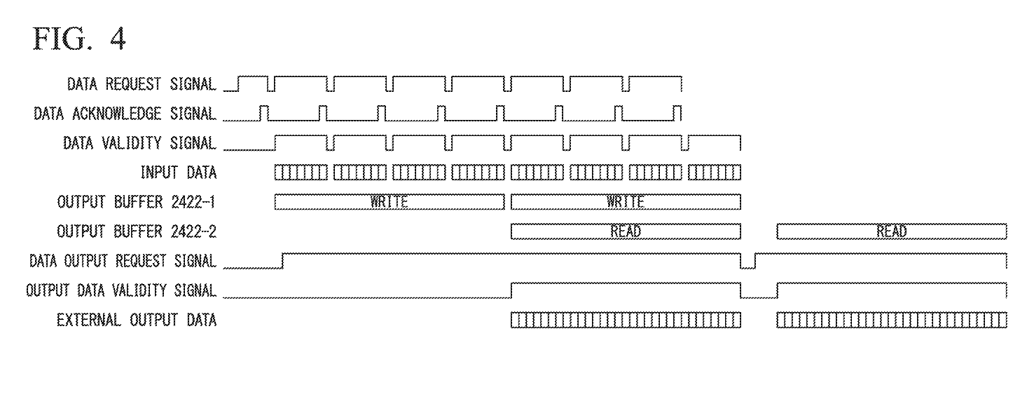

Here, the operation of the external output section in the input/output module 24 will be described. FIG. 4 is a timing chart showing an example of an operation of the external output section (the image processing module input control section 241, the output buffer section 242, and the external output control section 243) in the input/output module 24 provided in the image processing section 20 within the image processing device 1 according to the first embodiment of the present invention. In FIG. 4, an example in which the input/output module 24 receives and transmits pixel data from the image processing module 23 connected to the previous stage to the connected external interface section 30 is shown. In other words, in FIG. 4, an example of an operation in which the input/output module 24 requests the image processing module 23 connected to the previous stage to provide input data (pixel data) to temporarily store the pixel data in the output buffer section 242 and outputs the pixel data stored in the output buffer section 242 as external output data in accordance with a request for output data from the connected external interface section 30, i.e., the external extension processing device 600 is shown.

In FIG. 4, timings of a data request signal, a data acknowledge signal a data validity signal, and exchange of input data between the image processing module 23 connected to the previous stage and the input/output module 24 are shown. Also, in FIG. 4, states of operations of the output buffer 2422-1 and the output buffer 2422-2 provided in the output buffer section 242 are shown. Also, in FIG. 4, timings of a data output request signal, an output data validity signal, and exchange of external output data between the external interface section 30 and the input/output module 24 are shown.

In the description of FIG. 4, pixel data will be described as being received and transmitted from and to the external interface section 30 by using four unit lines as one processing unit. Also, in the description of FIG. 4, an operation from a state in which both the output buffer 2422-1 and the output buffer 2422-2 provided in the output buffer section 242 are not temporarily storing input data (pixel data) output from the image processing module 23 connected to the previous stage, i.e., both the output buffers 2422 have free storage capacity, will be described.

In the above-described state, the output buffer free capacity management section 2411 provided in the image processing module input control section 241 outputs a data request signal for requesting an output of input data (pixel data) of a first unit line to the image processing module 23 connected to the previous stage. Thereafter, the output buffer free capacity management section 2411 sets the data request signal to a state in which an output of input data (pixel data) is not requested when the data acknowledge signal indicating that pixel data of the first unit line is to be output in accordance with the output data request signal is input from the image processing module 23 connected to the previous stage. Then, the output buffer free capacity management section 2411 outputs the output buffer writing control signal OBWC for issuing an instruction for receiving the input data (pixel data) of the first unit line output from the image processing module 23 connected to the previous stage and writing (temporarily storing) the received input data in the output buffer 2422-1, to the output buffer writing management section 2412.

Also, when the data request signal output from the input/output module 24 is brought into a state in which output of the input data (pixel data) of the first unit line is not requested, the image processing module 23 connected to the previous stage determines that the input/output module 24 has recognized the data acknowledge signal and sets the data acknowledge signal to a state in which no pixel data is output.

Also, in FIG. 4, a “High” level of the data request signal indicates that the input/output module 24 can receive input data (pixel data), and a “Low” level of the data request signal indicates that no input data (pixel data) can be received. Also, in FIG. 4, a “High” level of the data acknowledge signal indicates that the image processing module 23 connected to the previous stage outputs pixel data in response to the data request signal and a “Low” level of the data acknowledge signal indicates that no pixel data is output.

Then, the image processing module 23 connected to the previous stage sequentially outputs the pixel data of the first unit line in accordance with the data request signal output by the input/output module 24. At this time, the image processing module 23 connected to the previous stage outputs a data validity signal when the output pixel data is valid pixel data.

In FIG. 4, a “High” level of the data validity signal indicates that the pixel data output by the image processing module 23 connected to the previous stage is valid pixel data, and a “Low” level of the data validity signal indicates that the pixel data is not valid, i.e., that the pixel data is invalid.

The output buffer writing management section 2412 provided in the image processing module input control section 241 outputs an output buffer writing selection signal OBWS indicating the selection of the output buffer 2422-1 to the selector 2421 provided in the output buffer section 242 on the basis of an output buffer writing control signal OBWC output from the output buffer free capacity management section 2411.

Thereby, the output buffer section 242 is brought into a state in which the input data (pixel data) of the first unit line output from the image processing module 23 connected to the previous stage is written (temporarily stored) in the output buffer 2422-1. The output buffer writing management section 2412 outputs an output buffer writing signal OBW for sequentially writing valid pixel data sequentially output from the image processing module 23 to the output buffer 2422-1 on the basis of the data validity signal output from the image processing module 23 connected to the previous stage. Thereby, valid pixel data of the first unit line sequentially output from the image processing module 23 connected to the previous stage is written and temporarily stored in the output buffer 2422-1.

At this time, even when a result of monitoring the free storage capacity in the output buffer 2422-1 indicates that input data (pixel data) currently input has been written, if it is determined that there is still free storage capacity in the output buffer 2422-1, the output buffer free capacity management section 2411 outputs the data request signal for requesting the output of the input data (pixel data) to the image processing module 23 connected to the previous stage again. In other words, if the output buffer 2422-1 is brought into a state in which input data (pixel data) of a second unit line can be written (temporarily stored), the output buffer free capacity management section 2411 outputs the data request signal for requesting the output of the input data (pixel data) of the second unit line to the image processing module 23 connected to the previous stage.

Thereby, the image processing module 23 connected to the previous stage sets the data request signal to a state in which the pixel data of the second unit line is output in accordance with the data request signal output again (the data request signal of the second unit line).

Then, when the output of the input data (pixel data) of the first unit line which is currently being output is completed, the image processing module 23 connected to the previous stage continues to output the pixel data of the second unit line and the data validity signal in accordance with the data request signal output from the input/output module 24 again. The output buffer writing management section 2412 continues to write valid pixel data of the second unit line sequentially output from the image processing module 23 connected to the previous stage in the output buffer 2422-1.

In this manner, the output buffer free capacity management section 2411 and the output buffer writing management section 2412 iterate the writing of input data (pixel data) of unit lines sequentially output from the image processing module 23 connected to the previous stage to the output buffer 2422-1 until there is no free storage capacity in the output buffer 2422-1, i.e., until the input data (pixel data) of a fourth unit line is written.

Then, when there is no free storage capacity in the output buffer 2422-1, the output buffer free capacity management section 2411 and the output buffer writing management section 2412 continue to similarly write valid pixel data sequentially output from the image processing module 23 connected to the previous stage in the output buffer 2422-2.

In other words, when writing of input data (pixel data) for four unit lines to the output buffer 2422-1 is completed, the output buffer free capacity management section 2411 and the output buffer writing management section 2412 continue to similarly write valid pixel data of fifth and subsequent unit lines sequentially output from the image processing module 23 connected to the previous stage to the output buffer 2422-2.

Also, when a data output request signal is input from the connected external interface section 30, the output buffer data amount management section 2431 provided in the external output control section 243 monitors an amount of valid pixel data written in the output buffer 2422-1 by the image processing module input control section 241.

Then, when writing of pixel data of four unit lines in the output buffer 2422-1 is completed, i.e., when there is no free storage capacity in the output buffer 2422-1, the output buffer data amount management section 2431 outputs an output buffer reading control signal OBRC for issuing an instruction for reading (outputting) the pixel data stored in the output buffer 2422-1 to the output buffer reading management section 2432.

In FIG. 4, a “High” level of the data output request signal indicates a state in which the external interface section 30 is requesting output of the external output data (pixel data) and a “Low” level of the data output request signal indicates a state in which the output of external output data (pixel data) is not being requested.

The output buffer reading management section 2432 provided in the external output control section 243 outputs an output buffer reading selection signal OBRS indicating the selection of the output buffer 2422-1 to the selector 2423 provided in the output buffer section 242 on the basis of the output buffer reading control signal OBRC output from the output buffer data amount management section 2431. Thereby, the output buffer section 242 reads the pixel data for the four unit lines stored in the output buffer 2422-1 and outputs the read pixel data to the external interface section 30. Then, the output buffer reading management section 2432 outputs the output buffer reading signal OBR for sequentially reading the pixel data from the output buffer 2422-1 to the output buffer 2422-1. Thereby, the pixel data for the four unit lines stored in the output buffer 2422-1 are sequentially read and sequentially output as external output data to the external interface section 30. At this time, the output buffer reading management section 2432 outputs the output data validity signal when the pixel data read from the output buffer 2422-1 and output as external output data is valid pixel data.

Also, in FIG. 4, a “High” level of the output data validity signal indicates that the external output data output to the external interface section 30 is valid pixel data and a “Low” level of the output data validity signal indicates that the pixel data is not valid, i.e., that the pixel data is invalid external output data.

Thereafter, when a data output request signal is input from the external interface section 30 again, the output buffer data amount management section 2431 and the output buffer reading management section 2432 continue to similarly sequentially read pixel data stored in the output buffer 2422-2 and cause the sequentially read pixel data to be sequentially output as external output data to the external interface section 30 after writing of pixel data in the output buffer 2422-2 is completed. In other words, when writing of pixel data for the next four unit lines (including fifth and subsequent unit lines) in the output buffer 2422-2 is completed, the output buffer data amount management section 2431 and the output buffer reading management section 2432 continue to similarly sequentially read the pixel data for the four unit lines including the fifth and subsequent unit lines stored in the output buffer 2422-2 and cause the sequentially read pixel data to be sequentially output as external output data to the external interface section 30.

In this manner, the external output section of the input/output module 24 temporarily stores the input data (pixel data) output from the image processing module 23 connected to the previous stage in the output buffer 2422 and reads the pixel data stored in the output buffer 2422 to output the read pixel data as external output data in response to a request for output data from the connected external interface section 30.

Next, returning to FIG. 3, the external input section in the input/output module 24 will be described.

As described above, the input buffer section 245 is a data buffer configured to temporarily store external input data (externally processed pixel data) input to the input/output module 24. In FIG. 3, similar to the output buffer section 242, the input buffer section 245 having a double buffer configuration including two data buffers is shown. The input buffer section 245 operates so that the externally processed pixel data of one processing unit is written and read in the same period by alternately switching the storage (writing) and output (reading) of the externally processed pixel data in each data buffer to reverse operations. The input buffer section 245 shown in FIG. 3 includes a selector 2451, two input buffers 2452-1 and 2452-2, and a selector 2453.

The selector 2451 is a selection section configured to select a data buffer in which externally processed pixel data is written in the input buffer section 245. The selector 2451 selects the input buffer 2452 which is either the input buffer 2452-1 or the input buffer 2452-2 as a data buffer in which externally processed pixel data is written in accordance with an input buffer writing selection signal IBWS output from the external input control section 244. Then, the selector 2451 outputs the external input data (externally processed pixel data) input to the input/output module 24 to the input buffer 2452 which is either the selected input buffer 2452-1 or the selected input buffer 2452-2.

The selector 2453 is a selection section configured to select a data buffer from which externally processed pixel data stored in the input buffer section 245 is read. The selector 2453 selects the input buffer 2452 which is either the input buffer 2452-1 or the input buffer 2452-2 as a data buffer from which the stored externally processed pixel data is read in accordance with the input buffer reading selection signal IBRS output from the image processing module output control section 246. The selector 2453 outputs the externally processed pixel data read from the input buffer 2452 which is either the selected input buffer 2452-1 or the selected input buffer 2452-2 as output data to the image processing module 23 connected to the subsequent stage.

Each of the input buffer 2452-1 and the input buffer 2452-2 is a data buffer of a storage capacity for temporarily storing externally processed pixel data for a predetermined number of unit lines. The input buffer 2452 which is either the input buffer 2452-1 or the input buffer 2452-2 selected as the data buffer in which the externally processed pixel data is written by the selector 2451 writes (stores) external input data (externally processed pixel data) input via the selector 2451 in accordance with the input buffer writing signal IBW output from the external input control section 244. On the other hand, the input buffer 2452 which is either the input buffer 2452-1 or the input buffer 2452-2 selected as the data buffer from which the stored externally processed pixel data is read by the selector 2453 reads the stored externally processed pixel data to output the read externally processed pixel data to the selector 2453 in accordance with an output input buffer reading signal IBR output from the image processing module output control section 246.

As described above, the external input control section 244 controls the storage (writing) of the external input data (externally processed pixel data) output from the external interface section 30 in the input buffer section 245. The external input control section 244 shown in FIG. 3 includes an input buffer free capacity management section 2441 and an input buffer writing management section 2442.

The input buffer free capacity management section 2441 monitors the storage capacities of the input buffer 2452-1 and the input buffer 2452-2 provided in the input buffer section 245 and instructs the input buffer writing management section 2442 to store (write) externally input data (externally processed pixel data) for the input buffer 2452 in accordance with a result of monitoring the storage capacity.

More specifically, the input buffer free capacity management section 2441 monitors whether or not there is free storage capacity for writing (temporarily storing) external input data (externally processed pixel data) output from the connected external interface section 30 in the other input buffer 2452 different from the input buffer 2452 storing externally processed pixel data which is not read by the image processing module output control section 246. Then, if a result of monitoring the free storage capacity indicates that there is free storage capacity in the input buffer 2452 different from the input buffer 2452 which has already stored externally processed pixel data to be read by the image processing module output control section 246, the input buffer free capacity management section 2441 determines that the input buffer 2452 is brought into a state in which the external input data (externally processed pixel data) output from the external interface section 30 can be written. In this case, when a data input request signal for requesting input of external input data (externally processed pixel data) is input from the external interface section 30, the input buffer free capacity management section 2441 outputs an input buffer writing control signal IBWC for issuing an instruction for receiving and writing (temporarily storing) external input data (externally processed pixel data) corresponding to a data input request signal to the input buffer writing management section 2442. Also, the input buffer writing control signal IBWC output from the input buffer free capacity management section 2441 includes information of the input buffer 2452 determined to have free storage capacity.

Also, the input buffer free capacity management section 2441 may output a data input reception signal indicating reception of an input of external input data (externally processed pixel data) according to the data input request signal to the external interface section 30. Also, if a result of monitoring the free storage capacity indicates that there is no free storage capacity in the input buffer 2452, the input buffer free capacity management section 2441 determines that external input data (externally processed pixel data) output from the external interface section 30 cannot be written in any input buffer 2452. In this case, the input buffer free capacity management section 2441 may output a data input reception signal indicating a state in which the external input data cannot be received to the connected external interface section 30. Also, the input buffer free capacity management section 2441 may indicate that the output of the external input data (externally processed pixel data) is requested or not requested by a signal different from the data input reception signal (for example, an external data output request signal or the like).

The input buffer writing management section 2442 outputs a control signal for controlling writing of external input data (externally processed pixel data) to the input buffer section 245 on the basis of the input buffer writing control signal IBWC output from the input buffer free capacity management section 2441.

More specifically, the input buffer writing management section 2442 outputs an input buffer writing selection signal IBWS for selecting the input buffer 2452 in which the external input data (externally processed pixel data) output from the external interface section 30 is written (temporarily stored) to the selector 2451 provided in the input buffer section 245 on the basis of information of the input buffer 2452 determined to have free storage capacity included in the input buffer writing control signal IBWC. Also, the input buffer writing management section 2442 outputs an input buffer writing signal IBW indicating a timing at which the external input data (externally processed pixel data) output from the external interface section 30 is written (temporarily stored) to the selected input buffer 2452 within the input buffer section 245 in accordance with the input buffer writing control signal IBWC output from the input buffer free capacity management section 2441. At this time, the input buffer writing management section 2442 determines whether or not currently input external input data is externally processed pixel data which is valid on the basis of an input data validity signal indicating whether or not externally processed pixel data included in a unit line output together with the external input data (externally processed pixel data) from the external interface section 30 is externally processed pixel data which is valid. The input buffer writing management section 2442 outputs the input buffer writing signal IBW of the timing at which only the valid external input data (externally processed pixel data) is output to the input buffer 2452. Thereby, the input buffer section 245 writes (temporarily stores) only valid external input data (externally processed pixel data) in the selected input buffer 2452.

As described above, the image processing module output control section 246 controls the output (reading) of the external input data (externally processed pixel data) stored in the input buffer section 245. The image processing module output control section 246 shown in FIG. 3 includes an input buffer data amount management section 2461 and an input buffer reading management section 2462.

The input buffer data amount management section 2461 monitors the storage capacity of each of the input buffer 2452-1 and the input buffer 2452-2 provided in the input buffer section 245, and instructs the input buffer reading management section 2462 to output (read) the externally processed pixel data stored in the input buffer 2452 in accordance with the result of monitoring the storage capacity.

More specifically, the input buffer data amount management section 2461 monitors an amount of external input data (externally processed pixel data) for which writing in the other input buffer 2452 different from the input buffer 2452 in which external input data (externally processed pixel data) is written by the external input control section 244 is completed. Then, if a result of monitoring the amount of externally processed pixel data indicates that externally processed pixel data to be output as output data to the image processing module 23 connected to the subsequent stage has already been stored in the input buffer 2452, the input buffer data amount management section 2461 determines that the input buffer 2452 is brought into a state in which the externally processed pixel data can be read and output to the image processing module 23 connected to the subsequent stage. In this case, when a data request signal for requesting the output of output data (externally processed pixel data) is input from the image processing module 23 connected to the subsequent stage, the input buffer data amount management section 2461 outputs an input buffer reading control signal IBRC for issuing an instruction for reading (outputting) output data (externally processed pixel data) corresponding to the data request signal to the input buffer reading management section 2462. The input buffer reading control signal IBRC output by the input buffer data amount management section 2461 includes information of the input buffer 2452 for which it is determined that writing of externally processed pixel data has been completed.

Also, the input buffer data amount management section 2461 outputs a data acknowledge signal indicating that output of output data (externally processed pixel data) according to the data request signal has been received to the image processing module 23 connected to the subsequent stage.

On the other hand, if the result of monitoring the amount of externally processed pixel data indicates that the externally processed pixel data to be output as the output data is not stored in the input buffer 2452, the input buffer data amount management section 2461 determines that externally processed pixel data cannot be read from any input buffer 2452. In this case, the input buffer data amount management section 2461 outputs a data acknowledge signal indicating that the output of the output data (externally processed pixel data) according to the data request signal cannot be received to the image processing module 23 connected to the subsequent stage. Also, at this time, the data acknowledge signal may indicate that the output of the output data (externally processed pixel data) cannot be received by a logic level of the data acknowledge signal or a signal different from the data acknowledge signal.

The input buffer reading management section 2462 outputs a control signal for controlling the reading (outputting) of the external input data (externally processed pixel data) stored in the input buffer section 245 to the input buffer section 245 on the basis of the input buffer reading control signal IBRC output from the input buffer data amount management section 2461.

More specifically, the input buffer reading management section 2462 outputs an input buffer reading selection signal IBRS for selecting the input buffer 2452 from which the stored externally processed pixel data is read (output) to the selector 2453 provided in the input buffer section 245 on the basis of information of the input buffer 2452 for which it is determined that the writing of the externally processed pixel data has been completed included in the input buffer reading control signal IBRC. The input buffer reading management section 2462 outputs the input buffer reading signal IBR indicating a timing at which the stored externally processed pixel data is read and output to the image processing module 23 connected to the subsequent stage to the selected input buffer 2452 within the input buffer section 245 in accordance with the input buffer reading control signal IBRC output from the input buffer data amount management section 2461. Thereby, the input buffer section 245 reads the stored externally processed pixel data in accordance with the input buffer reading signal IBR and outputs the read externally processed pixel data as output data to the image processing module 23 connected to the subsequent stage. At this time, the input buffer reading management section 2462 outputs a data validity signal indicating whether or not externally processed pixel data included in a unit line read (output) as output data from the input buffer 2452 is valid to the image processing module 23 connected to the subsequent stage.

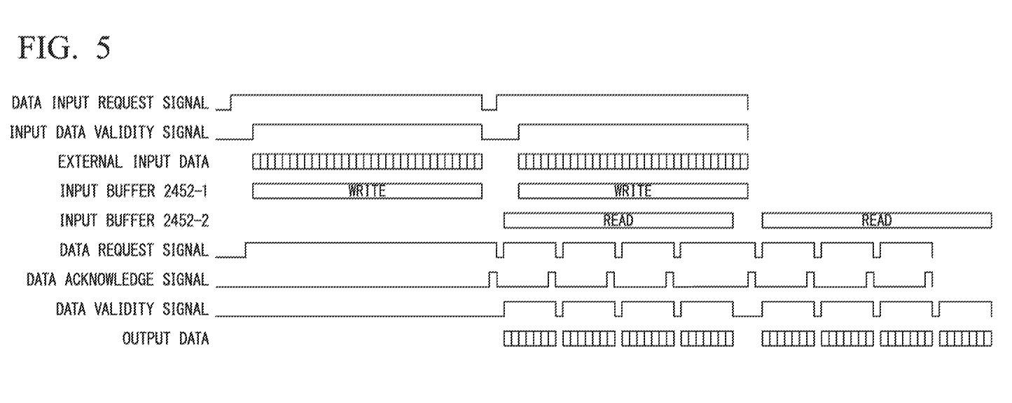

Here, an operation of the external input section in the input/output module 24 will be described. FIG. 5 is a timing chart showing an example of the operation of the external input section (the external input control section 244, the input buffer section 245, and the image processing module output control section 246) in the input/output module 24 provided in the image processing section 20 within the image processing device 1 according to the first embodiment of the present invention. In FIG. 5, an example in which the input/output module 24 receives and transmits externally processed pixel data from the connected external interface section 30 to the image processing module 23 connected to the subsequent stage is shown. In other words, in FIG. 5, an example of an operation in which the input/output module 24 temporarily stores the external input data (externally processed pixel data) output from the connected external interface section 30 and outputs the externally processed pixel data stored in the input buffer section 245 as output data in response to a data output request from the image processing module 23 connected to the subsequent stage is shown.

In FIG. 5, timings of the data input request signal, the input data validity signal, and exchange of the external input data between the connected external interface section and the input/output module 24 are shown. Also, in FIG. 5, the state of an operation of each of the input buffer 2452-1 and the input buffer 2452-2 provided in the input buffer section 245 is shown. Also, in FIG. 5, timings of the data request signal, the data acknowledge signal, the data validity signal, and exchange of the output data between the image processing module 23 connected to the subsequent stage and the input/output module 24 are shown.

Also, in the description of FIG. 5, externally processed pixel data will be described as being transmitted and received to and from the image processing module 23 connected to the subsequent stage by using four unit lines as one processing unit. Also, in the description of FIG. 5, an operation from a state in which both the input buffer 2452-1 and the input buffer 2452-2 provided in the input buffer section 245 are not temporarily storing external input data (externally processed pixel data) output from the external interface section 30, i.e., both the input buffers 2452 have free storage capacity, will be described.

In the above-described state, when a data input request signal for requesting an input of external input data (externally processed pixel data) of a first processing unit is input from the connected external interface section 30, the input buffer free capacity management section 2441 provided in the external input control section 244 monitors whether or not there is free storage capacity for writing (temporarily storing) the external input data (the externally processed pixel data) in the input buffer 2452-1. Then, the input buffer free capacity management section 2441 outputs an input buffer writing control signal IBWC for issuing an instruction for receiving the external input data (the externally processed pixel data) of the first processing unit corresponding to the data input request signal and writing (temporarily storing) the received external input data (externally processed pixel data) in the input buffer 2452-1 to the input buffer writing management section 2442.

Also, in FIG. 5, a “High” level of the data input request signal indicates that the external interface section 30 is requesting input of external input data (externally processed pixel data), and a “low” level of the external interface section 30 indicates that an input of external input data (externally processed pixel data) is not being requested.

Then, the external interface section 30 outputs the externally processed pixel data of the first processing unit together with the input data validity signal indicating that the externally processed pixel data is valid.

In FIG. 5, a “High” level of the input data validity signal indicates that the externally processed pixel data output from the external interface section 30 is valid and a “Low” level of the input data validity signal indicates that the externally processed pixel data is not valid, i.e., that the externally processed pixel data is invalid.

The input buffer writing management section 2442 provided in the external input control section 244 outputs an input buffer writing selection signal IBWS indicating the selection of the input buffer 2452-1 to the selector 2451 provided in the input buffer section 245 on the basis of the input buffer writing control signal IBWC output from the input buffer free capacity management section 2441. Thereby, the input buffer section 245 is brought into a state in which the external input data (the externally processed pixel data) of the first processing unit output from the external interface section 30 is written (temporarily stored) in the input buffer 2452-1. The input buffer writing management section 2442 outputs the input buffer writing signal IBW for sequentially writing externally processed pixel data which is valid sequentially output from the external interface section 30 to the input buffer 2452-1 on the basis of the input data validity signal output from the external interface section 30. Thereby, externally processed pixel data of the first processing unit which is valid sequentially output from the external interface section 30 is written and temporarily stored in the input buffer 2452-1.

When the output of the currently output external input data (externally processed pixel data) of the first processing unit is completed, the external interface section 30 continues to output a data input request signal for requesting an input of external input data (externally processed pixel data) of a second processing unit and output the externally processed pixel data of the second processing unit together with the input data validity signal indicating the externally processed pixel data which is valid.

At this time, the input buffer free capacity management section 2441 outputs the input buffer writing control signal IBWC for issuing an instruction for receiving external input data (externally processed pixel data) of the second processing unit corresponding to the data input request signal output from the external interface section 30 and writing (temporarily storing) the received external input data (externally processed pixel data) in the input buffer 2452-2, to the input buffer writing management section 2442. Then, the input buffer writing management section 2442 continues to receive externally processed pixel data of the second processing unit which is valid sequentially output from the external interface section 30 and cause the received externally processed pixel data to be written and temporarily stored in the input buffer 2452-2 on the basis of the input buffer writing control signal IBWC of the second processing unit output from the input buffer free capacity management section 2441.

In this manner, the input buffer free capacity management section 2441 and the input buffer writing management section 2442 write the external input data (the externally processed pixel data) sequentially output from the connected external interface section 30 in the input buffer 2452-1 and the input buffer 2452-2.

Also, when a data request signal for requesting an output of output data (externally processed pixel data) of a first unit line is input from the image processing module 23 connected to the subsequent stage, the input buffer data amount management section 2461 provided in the image processing module output control section 246 monitors an amount of externally processed pixel data which is valid written in the input buffer 2452-1 by the external input control section 244. Then, if the writing of the externally processed pixel data of the first processing unit in the input buffer 2452-1 is completed, i.e., if there is no free storage capacity in the input buffer 2452-1, the input buffer data amount management section 2461 outputs a data acknowledge signal indicating that the output of the externally processed pixel data of the first unit line according to the data request signal has been received to the image processing module 23 connected to the subsequent stage. Thereby, the image processing module 23 connected to the subsequent stage sets the data request signal for requesting the output of the externally processed pixel data of the first unit line in a state in which the output of the output data (the externally processed pixel data) is not requested. The input buffer data amount management section 2461 outputs an input buffer reading control signal IBRC for issuing an instruction for reading and outputting the externally processed pixel data of the first unit line stored in the input buffer 2452-1 to the input buffer reading management section 2462.

Also, in FIG. 5, a “High” level of the data request signal indicates that the image processing module 23 connected to the subsequent stage is requesting output of output data (externally processed pixel data), and a “Low” level of the data request signal indicates that the output of the output data (the externally processed pixel data) is not being requested.

The input buffer reading management section 2462 provided in the image processing module output control section 246 outputs an input buffer reading selection signal IBRS indicating the selection of the input buffer 2452-1 to the selector 2453 provided in the input buffer section 245 on the basis of the input buffer reading control signal IBRC output from the input buffer data amount management section 2461.

Thereby, the input buffer section 245 is brought into a state in which the externally processed pixel data stored in the input buffer 2452-1 is read and output to the image processing module 23 connected to the subsequent stage. The input buffer reading management section 2462 outputs an input buffer reading signal IBR for sequentially reading the externally processed pixel data of the first unit line from the input buffer 2452-1 to the input buffer 2452-1. Thereby, the externally processed pixel data of the first unit line stored in the input buffer 2452-1 is sequentially read and sequentially output as output data of the first unit line to the image processing module 23 connected to the subsequent stage. At this time, when the externally processed pixel data of the first unit line read from the input buffer 2452-1 and output as output data is valid, the input buffer reading management section 2462 outputs a data validity signal.

In FIG. 5, a “High” level of the data validity signal indicates that the output data output to the image processing module 23 connected to the subsequent stage is externally processed pixel data which is valid and a “Low” level of the data validity signal indicates that the externally processed pixel data is not valid, i.e., that the externally processed pixel data is invalid output data.

Thereafter, when a data request signal for requesting an output of output data (externally processed pixel data) of a second unit line is input from the image processing module 23 connected to the subsequent stage, the input buffer data amount management section 2461 outputs a data acknowledge signal indicating that the output of the externally processed pixel data of the second unit line has been received to the image processing module 23 connected to the subsequent stage. Then, after the reading of the currently output externally processed pixel data of the first unit line is completed, the input buffer data amount management section 2461 continues to output the input buffer reading control signal IBRC for issuing an instruction for reading and outputting the externally processed pixel data of the second unit line stored in the input buffer 2452-1 to the input buffer reading management section 2462. Thereby, the input buffer reading management section 2462 continues to sequentially read the externally processed pixel data of the second unit line from the input buffer 2452-1 and sequentially output the read externally processed data as the output data of the second unit line to the image processing module 23 connected to the subsequent stage together with the data validity signal.

In this manner, the input buffer data amount management section 2461 and the input buffer reading management section 2462 iterate the reading of the externally processed pixel data stored in the input buffer 2452-1 until the reading of all the externally processed pixel data is completed, i.e., until the output of the output data (the externally processed pixel data) of the fourth unit line is completed, in accordance with the data request signal input from the image processing module 23 connected to the subsequent stage. When the reading of the externally processed pixel data stored in the input buffer 2452-1 is completed, the input buffer data amount management section 2461 and the input buffer reading management section 2462 continue to similarly read the externally processed pixel data stored in the input buffer 2452-2 in accordance with the data request signal input from the image processing module 23 connected to the subsequent stage. In other words, when the output of the output data (the externally processed pixel data) for four unit lines from the input buffer 2452-1 is completed, the input buffer data amount management section 2461 and the input buffer reading management section 2462 continue to similarly output output data (externally processed pixel data) of fifth and subsequent unit lines from the input buffer 2452-2 to the image processing module 23 connected to the subsequent stage.

In this manner, the external input section of the input/output module 24 temporarily stores the external input data (the externally processed pixel data) output from the connected external interface section 30 in the input buffer section 245 and reads the externally processed pixel data stored in the input buffer section 245 to output the read externally processed pixel data as output data in response to a data output request from the image processing module 23 connected to the subsequent stage.

According to such a configuration, the input/output module 24 provided in the image processing section 20 outputs input data (pixel data) output from the image processing module 23 connected to the previous stage to the connected external interface section 30 and outputs external input data (externally processed pixel data) output from the external interface section 30 to the image processing module 23 connected to the subsequent stage. Thereby, the input/output module 24 can incorporate external image processing of the external extension processing device 600 connected by the external interface section 30 between the image processing module 23 connected to the previous stage and the image processing module 23 connected to the subsequent stage for which a pipeline is configured in the image processing section 20.

Also, in the configuration of the input/output module 24 shown in FIG. 3, a configuration in which pixel data is transmitted and received to and from the image processing module 23 connected to the previous stage or the subsequent stage or the external interface section 30 according to a request signal, an acknowledge signal, and a validity signal is shown. However, a method in which the input/output module 24 exchanges pixel data with the image processing module 23 connected to the previous stage or the subsequent stage or the external interface section 30 is not limited to a method based on a request signal, an acknowledge signal, and a validity signal and a data transmission method based on various other methods may be adopted.

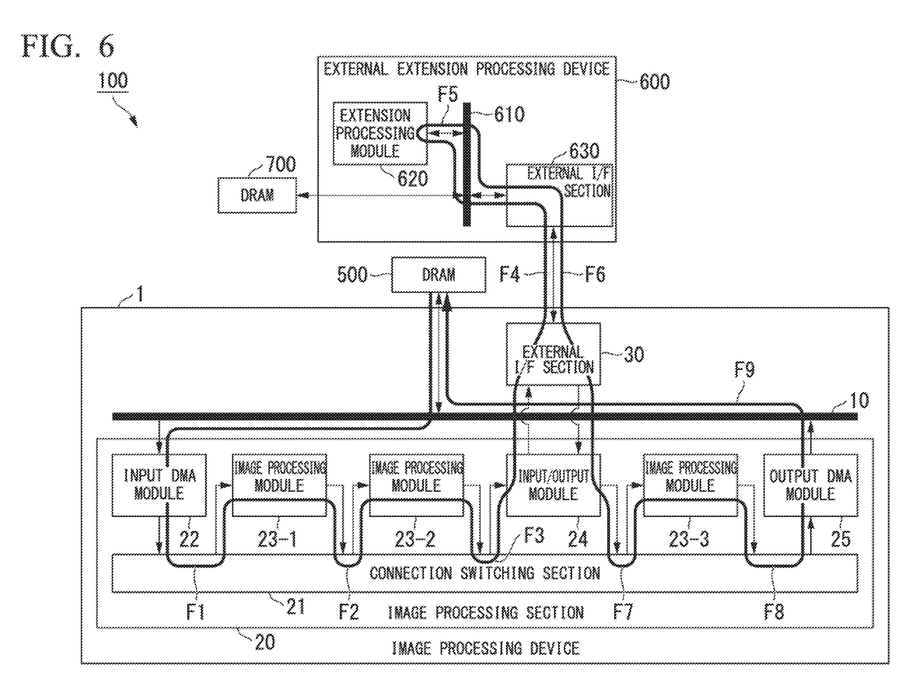

Next, a flow of data in pipeline processing in which external image processing of the external extension processing device 600 is incorporated by the input/output module 24 will be described. FIG. 6 is a diagram schematically showing a flow of pixel data including the input/output module 24 provided in the image processing section 20 within the image processing device 1 according to the first embodiment of the present invention. In FIG. 6, the flow of pixel data when external image processing of the external extension processing device 600 is incorporated into the pipeline processing configured in the image processing section 20 is shown. More specifically, in the configuration of the imaging device 100 shown in FIG. 1, a flow of pixel data when external image processing of the external extension processing device 600 is incorporated into a series of image processing based on pipeline processing by incorporating the input/output module 24 between the image processing module 23-2 and the image processing module 23-3 provided in the image processing section 20 within the image processing device 1 is shown.

In the pipeline processing in the image processing section 20 provided in the image processing device 1, the image processing module 23 and the external extension processing device 600 are configured to smoothly perform pipeline processing by performing predetermined image processing on pixel data output from the image processing module 23 of the previous stage or the external extension processing device 600 in parallel. In other words, the image processing module 23 and the external extension processing device 600 perform different image processing in the same period. However, in the description of the flow of the pixel data shown in FIG. 6, for ease of description, a data flow focused on pixel data of one processing unit will be described. In the flow of pixel data shown in FIG. 6, processing is performed in the following flow.

(Flow F1): First, the input DMA module 22 reads pixel data included in block image data stored in the DRAM 500 for each unit line by DMA via the DMA bus 10. Then, the input DMA module 22 outputs the read pixel data to the image processing module 23-1 of a connection destination for performing the next image processing via the connection switching section 21.

(Flow F2): Subsequently, the image processing module 23-1 performs predetermined image processing on the pixel data output from the input DMA module 22 of the connection destination via the connection switching section 21 and outputs the processed pixel data after the image processing is performed to the image processing module 23-2 of the connection destination for performing the next image processing via the connection switching section 21.

(Flow F3): Subsequently, the image processing module 23-2 performs predetermined image processing on the processed pixel data output from the image processing module 23-1 of the connection destination via the connection switching section 21 and outputs processed pixel data after the image processing is further performed to the external extension processing device 600 for performing the next image processing via the connection switching section 21. At this time, the connection switching section 21 outputs the processed pixel data output from the image processing module 23-2 to the input/output module 24.

(Flow F4): Subsequently, the input/output module 24 directly outputs the processed pixel data output from the image processing module 23-2 of the connection destination via the connection switching section 21 to the external interface section 30 without involving the DMA bus 10 and transmits the output processed pixel data to the external extension processing device 600 via the external interface section 30.

(Flow F5): Subsequently, the external extension processing device 600 receives the processed pixel data transmitted via the external interface section 30 provided in the image processing device 1 by the external interface section 630 and outputs the received processed pixel data to the extension processing module 620 via the DMA bus 610.

Then, the extension processing module 620 performs predetermined external image processing on the processed pixel data output from the external interface section 630 via the DMA bus 610, and outputs processed pixel data (externally processed pixel data) after the external image processing is performed to the external interface section 630 via the DMA bus 610.

(Flow F6): Subsequently, the external interface section 630 transmits the externally processed pixel data output from the extension processing module 620 via the DMA bus 610 to the image processing device 1. The image processing device 1 receives externally processed pixel data transmitted via the external interface section 630 provided in the external extension processing device 600 by the external interface section 30. The external interface section 30 directly outputs the received externally processed pixel data to the input/output module 24 without involving the DMA bus 10.

(Flow F7): Subsequently, the input/output module 24 outputs the externally processed pixel data transmitted from the external extension processing device 600 via the external interface section 30 to the image processing module 23-3 of the connection destination for performing the next image processing via the connection switching section 21.

(Flow F8): Subsequently, the image processing module 23-3 performs predetermined image processing on the externally processed pixel data output from the input/output module 24 of the connection destination via the connection switching section 21 and outputs externally processed pixel data (processed pixel data) after the image processing is further performed to the output DMA module 25 via the connection switching section 21.

(Flow F9): Subsequently, the output DMA module 25 writes (stores) the processed pixel data output from the image processing module 23-3 of the connection destination via the connection switching section 21 in the DRAM 500 by DMA via the DMA bus 10.

In this manner, the image processing device 1 executes a series of image processing in which external image processing of the external extension processing device 600 is incorporated into the pipeline processing configured in the image processing section 20.

According to the present first embodiment, there is provided an image processing device (the image processing device 1) in which an image processing section (the image processing section 20) for configuring a pipeline by connecting a plurality of processing modules (the image processing modules 23-1 to 23-3) for performing predetermined processing on input data (pixel data) in series and performing pipeline processing due to each of the image processing modules 23-1 to 23-3 sequentially performing the processing is connected to a data bus (the DMA bus 10) and performs image processing on pixel data read from a data storage section (the DRAM 500) connected to the DMA bus 10 via the DMA bus 10, wherein the image processing section includes an input/output module (the input/output module 24) incorporated into the pipeline as a processing module configured to perform processing different from the processing to be performed by each of the image processing modules 23-1 to 23-3, and wherein the input/output module 24 directly outputs processed data (input data, pixel data, and processed pixel data) obtained by performing the processing of a first processing module (for example, the image processing module 23-2) which is the processing module located at a stage previous to a position where the input/output module 24 is incorporated into the pipeline to an external processing section (the external extension processing device 600) outside the image processing section 20 without involving the DMA bus 10 (as external output data), and directly outputs externally processed data (external input data or externally processed pixel data) input by the external extension processing device 600 performing external processing (external image processing) on the processed data (the input data, the pixel data, or the processed pixel data) to a second processing module (for example, the image processing module 23-3) which is the processing module located at a stage subsequent to the first processing module (for example, the image processing module 23-2) in the pipeline without involving the DMA bus 10 (as output data).

Also, according to the present first embodiment, the image processing device 1 in which the input/output module 24 includes an output buffer section (the output buffer section 242) configured to temporarily store the processed data (the input data, the pixel data, or the processed pixel data); and an input buffer section (the input buffer section 245) configured to temporarily store the externally processed data (the external input data or the externally processed pixel data) is configured, wherein the input/output module 24 temporarily stores the processed data (the processed pixel data) output by the first processing module (for example, the image processing module 23-2) in the output buffer section 242 and outputs the processed data (the processed pixel data) stored in the output buffer section 242 in response to a request from the external extension processing device 600 (as external output data), and wherein the input/output module 24 temporarily stores the externally processed data (the external input data or externally processed pixel data) output by the external extension processing device 600 in the input buffer section 245 and outputs the externally processed data (the external input data or the externally processed pixel data) stored in the input buffer section 245 in response to a request from the second processing module (as output data).

Also, according to the present first embodiment, the image processing device 1 in which the input/output module 24 further includes a processing module input control section (the image processing module input control section 241) configured to control writing of the processed data (the input data, the pixel data, or the processed pixel data) in the output buffer section 242 on the basis of the storage capacity of the output buffer section 242; an external output control section (the external output control section 243) configured to control reading of the processed data (the input data, the pixel data, or the processed pixel data) from the output buffer section 242 on the basis of the amount of the processed data (the input data, the pixel data, or the processed pixel data) stored in the output buffer section 242; an external input control section (the external input control section 244) configured to control writing of the externally processed data (the external input data or the externally processed pixel data) in the input buffer section 245 on the basis of the storage capacity of the input buffer section 245; and a processing module output control section (the image processing module output control section 246) configured to control reading of the externally processed data (the external input data or the externally processed pixel data) from the input buffer section 245 on the basis of the amount of the externally processed data (the external input data or the externally processed pixel data) stored in the input buffer section 245 is configured.

Also, according to the present first embodiment, the image processing device 1 in which the image processing module input control section 241 writes the processed data (the input data, the pixel data, or the processed pixel data) in the output buffer section 242 for each unit (for example, each unit line) for performing the processing in the first processing module (for example, the image processing module 23-2), the external output control section 243 reads the processed data (the input data, the pixel data, or the processed pixel data) stored in the output buffer section 242 for each unit (for example, four unit lines) for performing the external image processing in the external extension processing device 600, the external input control section 244 writes the externally processed data (the external input data or the externally processed pixel data) in the input buffer section 245 for each unit (for example, four unit lines) for performing the external image processing in the external extension processing device 600, and the image processing module output control section 246 reads the externally processed data (the external input data or the externally processed pixel data) stored in the input buffer section 245 for each unit (for example, unit line) for performing the processing in the second processing module (for example, the image processing module 23-3) is configured.

Also, according to the present first embodiment, the image processing device 1 in which the input/output module 24 is incorporated at at least one position of a beginning, a middle, and an end of the pipeline is configured.

Also, according to the present first embodiment, the image processing device 1 further includes an external interface section (the external interface section 30) configured to input and output data (input data, pixel data, processed pixel data, external output data, external input data, externally processed pixel data, or output data) to and from the external extension processing device 600, wherein the input/output module 24 performs data transmission from and to the external extension processing device 600 via the external interface section 30.

Also, according to the present first embodiment, the image processing device 1 in which the processed data (the input data, the pixel data, or the processed pixel data) and the externally processed data (the external input data or the externally processed pixel data) are image data (for example, still-image data), each of a unit (a unit line) for performing the processing in the first processing module (for example, the image processing module 23-2) and the second processing module (for example, the image processing module 23-3) and a unit (for example, four unit lines) for performing the external image processing in the external extension processing device 600 is a size in which the image data of one frame (for example, the still-image data) is divided into a plurality of predetermined blocks (for example, block image data), and the storage capacity of the output buffer section 242 and the storage capacity of the input buffer section 245 are less than the storage capacity for storing pixel data included in the image data of one frame (for example, the still-image data) is configured.

As described above, in the image processing device 1 according to the first embodiment, the input/output module 24 to which the external interface section 30 is directly connected without involving the DMA bus 10 is provided within the image processing section 20 configured to perform pipeline processing. Thereby, in the image processing device 1 of the first embodiment, it is possible to transmit processed pixel data during pipeline processing to the external extension processing device 600 connected outside the image processing device 1. In the image processing device 1 of the first embodiment, it is possible to perform subsequent image processing in the pipeline processing on the processed pixel data (externally processed pixel data) obtained through image processing performed by the external extension processing device 600.

Thus, in the image processing device 1 of the first embodiment, it is possible to incorporate image processing of the external extension processing device 600 for providing extensibility into image processing based on pipeline processing which has already been configured.

Moreover, in the image processing device 1 of the first embodiment, the external interface section 30 can transmit pixel data for use in image processing to be extended to and from the external extension processing device 600 without using a storage section such as the DRAM 500. Thus, in the image processing device 1 of the first embodiment, it is possible to perform a series of image processing in a state in which the image processing to be extended has been incorporated without dividing the already configured pipeline processing into parts. Thereby, in the image processing device 1 of the first embodiment, it is possible to extend image processing without causing overload on the bus bandwidth of the DRAM, increase of the power consumption of the image processing device 1, or the like and deteriorating the performance of the imaging device 100 equipped with the image processing device 1 of the first embodiment.

Also, a configuration in which external image processing of the external extension processing device 600 is incorporated between the image processing module 23-2 and the image processing module 23-3 provided in the image processing section 20 within the image processing device 1 in the image processing device 1 of the first embodiment has been described. However, as described above, in the image processing device 1 of the first embodiment, the connection switching section 21 can change the order of image processing to be performed by the image processing section 20 or the position of external image processing to be incorporated into the pipeline. Accordingly, a position at which the external image processing is incorporated into the pipeline processing in the image processing device 1 of the first embodiment is not limited to the position described in the first embodiment. For example, the external image processing of the external extension processing device 600 can be incorporated between the image processing module 23-1 and the image processing module 23-2 according to the setting of the connection switching section 21.

Also, in the image processing device 1 of the first embodiment, a configuration in which the input/output module 24 provided in the image processing section 20 is connected to the external interface section 30 provided in the image processing device 1 and exchanges pixel data with the external extension processing device 600 provided outside the image processing device 1 via the external interface section 30 is shown.

However, the configuration of the input/output module 24 is not limited to the configuration shown in the first embodiment. For example, a configuration in which the input/output module 24 has a function of the external interface section 30 and the exchange of the pixel data is directly performed between the input/output module 24 and the external extension processing device 600 may be adopted. Also, in the input/output module 24 of this configuration, for example, in a case in which the external extension processing device 600 is an image processing device (system LSI) exclusively connected to the image processing device 1 in order to perform presumed external image processing or the like, only a function of transmitting data in a predetermined specific data transmission specification or scheme may be provided as a function of the external interface section 30. In this case, in the external extension processing device 600 specific to the image processing device 1, a delay time until the externally processed pixel data is output by performing external image processing after the pixel data is input can be ascertained in advance. Thus, if the pipeline processing in the image processing section 20 is smoothly performed, the configuration of the input/output module 24 may not include the output buffer section 242 and the input buffer section 245, i.e., may be a configuration in which no pixel data is buffered. Also, if a data buffer is provided in the image processing modules 23 assumed to be connected to a previous stage and a subsequent stage, the input/output module 24 may be configured so that the input/output module 24 does not buffer pixel data by using the data buffer provided in each image processing module 23 as data buffers of the output buffer section 242 and the input buffer section 245.

Also, in the image processing device 1 of the first embodiment, a configuration in which a component for executing the image processing to be extended by incorporating the image processing into the pipeline processing is the external extension processing device 600 connected outside the image processing device 1 has been described. However, according to the configuration of the image processing device 1, it is also conceivable that the image processing device 1 includes a component for executing image processing to be extended by incorporating the imaging processing into pipeline processing. In this case, likewise, the input/output module 24 can incorporate image processing capable of being extended into image processing based on pipeline processing already configured in the image processing section 20 by exchanging pixel data with a component for executing image processing to be extended provided in the image processing device 1 instead of the external interface section 30.

### Second Embodiment

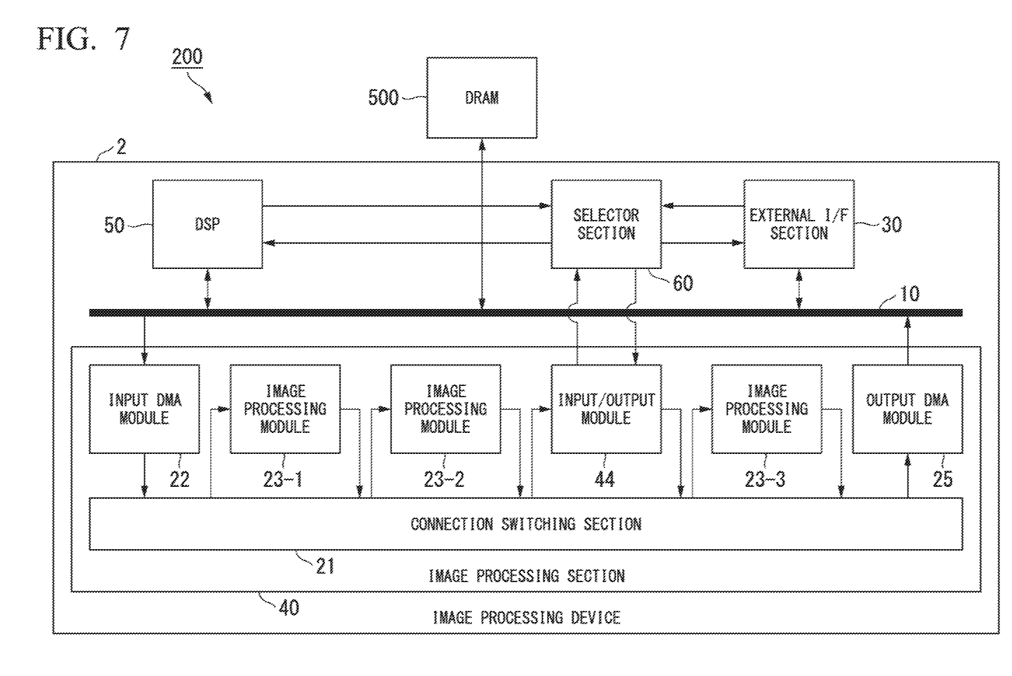

Next, a second embodiment of the present invention will be described. Also, in the following description, for example, a case in which the image processing device according to the second embodiment of the present invention is mounted in an imaging device such as a still-image camera (hereinafter referred to as an “imaging device 200”) will be described. FIG. 7 is a block diagram showing a schematic configuration of an image processing device according to a second embodiment of the present invention. Also, in FIG. 7, a DRAM 500 is shown as a component in the imaging device 200 related to an image processing device 2 according to the second embodiment of the present invention.

The image processing device 2 shown in FIG. 7 includes a DMA bus 10, an image processing section 40, an external interface (I/F) section 30, a digital signal processor (DSP) 50, and a selector section 60. Also, the image processing section 40 includes a connection switching section 21, an input DMA module 22, three image processing modules 23-1 to 23-3, an input/output module 44, and an output DMA module 25.

The configuration of the image processing device 2 shown in FIG. 7 is a configuration in which the image processing section 20 provided in the image processing device 1 of the first embodiment shown in FIG. 1 is replaced with the image processing section 40 and the digital signal processor 50 and the selector section 60 are further included. Also, the image processing section 40 provided in the image processing device 2 shown in FIG. 7 has a configuration in which the input/output module 24 provided in the image processing section 20 provided in the image processing device 1 of the first embodiment shown in FIG. 1 is replaced with the input/output module 44.

Also, the other components of the image processing device 2 and the image processing section 40 provided in the image processing device 2 are similar to those of the image processing device 1 of the first embodiment shown in FIG. 1 and the image processing section 20 provided in the image processing device 1. Accordingly, in the following description, the components of the image processing device 2 and the image processing section 40 provided in the image processing device 2 similar to those of the image processing device 1 of the first embodiment shown in FIG. 1 and the image processing section 20 provided in the image processing device 1 are denoted by the same reference signs and a detailed description related to the components will be omitted. Also, in FIG. 7, as in the imaging device 100 shown in FIG. 1, shown of other components connected to each component provided in the imaging device 200 and the DMA bus 10 in the image processing device 2 is also omitted.

Similar to the image processing section 20 provided in the image processing device 1 of the first embodiment shown in FIG. 1, the image processing section 40 performs pipeline processing in various predetermined image processing of the image processing device 2 on the input block image data. Also, similar to the image processing section 20 provided in the image processing device 1 of the first embodiment, the image processing section 40 also has a function of changing the configuration of the pipeline.

Also, similar to the image processing section 20 provided in the image processing device 1 of the first embodiment, the image processing section 40 has a function of incorporating image processing different from image processing to be executed by each of the image processing modules 23-1 to 23-3 into pipeline processing.

However, in the image processing device 2, image processing to be executed by the digital signal processor 50 (hereinafter referred to as “DSP image processing”) can be incorporated into pipeline processing as image processing for extending the image processing in the image processing section 40. Here, the image processing (the DSP image processing) to be executed in the digital signal processor 50 and incorporated into the pipeline processing is image processing which is not executed in the image processing module 23 which is any one of the image processing modules 23-1 to 23-3.

In the configuration of the imaging device 200 shown in FIG. 7, it is possible to incorporate image processing of either external image processing to be executed by a component such as a system LSI provided outside the image processing device 2 (the external extension processing device 600 in the first embodiment shown in FIG. 1) or DSP image processing to be executed by the digital signal processor 50 in the pipeline processing in the image processing section 40. In the following description, for ease of description, the component provided outside the image processing device 2 will be described as the external extension processing device 600 provided outside the image processing device 1 in the first embodiment shown in FIG. 1. Also, in the following description, the external image processing and the DSP image processing are referred to as “extended image processing” when they are represented without distinction. In the image processing section 40, the input/output module 44 is incorporated into the pipeline configuration as an image processing module for executing the extended image processing and therefore the extended image processing to be executed by the external extension processing device 600 or the digital signal processor 50 is incorporated into pipeline processing.

Also, in the image processing device 2, as in the image processing section 20 provided in the image processing device 1 of the first embodiment, the pipeline configuration in the image processing section 40 is changed (set) by, for example, a system control section (not shown).

In FIG. 7, a configuration in which the extended image processing to be executed by the external extension processing device 600 or the digital signal processor 50 is incorporated into a pipeline by incorporating the input/output module 44 between the image processing module 23-2 and the image processing module 23-3 is shown. In other words, in the image processing section 40 shown in FIG. 7, a state in which a pipeline for sequentially performing image processing of the image processing module 23-1, image processing of the image processing module 23-2, image processing of the external extension processing device 600 or the digital signal processor 50, and image processing of the image processing module 23-3 is configured is shown.

Also, in the image processing device 2, as in the image processing section 20 provided in the image processing device 1 of the first embodiment, a position where the input/output module 44 is incorporated into the pipeline is set by, for example, the system control section (not shown). Accordingly, in the image processing device 2, as in the image processing section 20 provided in the image processing device 1 of the first embodiment, a position where the input/output module 44 is incorporated into the pipeline is not limited to a position shown in FIG. 7 and the input/output module 44 can be incorporated at any position within the pipeline.

Similar to the input/output module 24 of the image processing section 20 provided in the image processing device 1 of the first embodiment, the input/output module 44 is an interface module for incorporating extended image processing to be executed by a component provided outside the image processing section 40 into pipeline processing. Also, although the input/output module 24 and the external interface section 30 are directly connected without involving the DMA bus 10 in the first embodiment, the input/output module 44 is directly connected to the selector section 60 without involving the DMA bus 10. For example, in accordance with control from the system control section (not shown), the input/output module 44 outputs pixel data input via the connection switching section 21 from either the input DMA module 22 or the image processing module 23 which is a connection destination to which the connection is switched by the connection switching section 21 to the external extension processing device 600 connected to the external interface section 30 or the digital signal processor 50 via the selector section 60. Also, for example, in accordance with control from the system control section (not shown), the input/output module 44 outputs pixel data subjected to extended image processing input via the selector section 60 from the external extension processing device 600 connected to the external interface section 30 or the digital signal processor 50 to any one of the image processing modules 23 which is a connection destination to which a connection is switched by the connection switching section 21 or the output DMA module 25.

As described above, the input/output module 44 incorporates extended image processing of either of external image processing to be executed by the external extension processing device 600 connected to the external interface section 30 or the DSP image processing to be executed by the digital signal processor 50 into the pipeline processing in the image processing section 40. Thus, the input/output module 44 adds information of an output destination indicating a component provided outside the image processing section 40 and to which pixel data for use in the extended image processing is output (hereinafter referred to as “output destination information”) to pixel data as information indicating the extended image processing of either external image processing or DSP image processing to be incorporated into the pipeline processing and outputs the pixel data with the output destination information. This output destination information is information indicating a component provided outside the image processing section 40 and to which the pixel data for use in the extended image processing is output such as the external extension processing device 600 connected to the external interface section 30 or the digital signal processor 50.

Also, the input/output module 44 may add the output destination information to the pixel data for use in the extended image processing. However, for example, a component to which the pixel data for use in the extended image processing is input may add the output destination information so that the output destination information is included in additional information such as so-called header information or marker information added to a beginning or an end of the pixel data as information such as settings of image processing to be used when the image processing is executed.

Also, a detailed information of the configuration of the input/output module 44, the configuration of the pixel data to be exchanged by the input/output module 44, the operation when the input/output module 44 incorporates the extended image processing into the pipeline processing of the image processing section 40, and the like will be described below. Also, in the following description, pixel data after DSP image processing is executed is referred to as “DSP-processed pixel data” when it is distinguished from pixel data to be subjected to image processing stored in the DRAM 500, processed pixel data after any one of the image processing modules 23 performs image processing, and externally processed pixel data after the external extension processing device 600 performs external image processing. In the following description, the externally processed pixel data and DSP-processed pixel data are referred to as “extended processed pixel data” when they are represented without distinction. In the following description, the processed pixel data, the externally processed pixel data, the DSP-processed pixel data, and the extended processed pixel data are simply referred to as “processed pixel data” when they are represented without distinction.

In this manner, in the image processing section 40, as in the image processing section 20 provided in the image processing device 1 of the first embodiment, each image processing module 23 also performs a series of image processing based on pipeline processing, for example, in accordance with control from the system control section (not shown). Similar to the image processing section 20 provided in the image processing device 1 of the first embodiment, the image processing section 40 causes a component provided outside the image processing section 40 to execute extended image processing which is not executed in any image processing modules 23 to incorporate the extended image processing into the pipeline processing, for example, in accordance with the control from the system control section (not shown). At this time, in the image processing section 40, as in the image processing section 20 provided in the image processing device 1 of the first embodiment, the input/output module 44 is incorporated into a configuration of the pipeline as an image processing module for executing the extended image processing.

Thereby, in the image processing device 2, as in the image processing device 1 of the first embodiment, it is possible to extend the pipeline processing in the image processing section 40 by performing image processing which cannot be executed by the image processing section 40 as in the pipeline processing performed by the image processing section 40. However, in the image processing device 2, unlike the image processing device 1 of the first embodiment, the extended image processing of either the external image processing to be executed by the external extension processing device 600 or the DSP image processing to be executed by the digital signal processor 50 is selected and incorporated into pipeline processing. Thus, as described above, output destination information indicating a component of either the external extension processing device 600 or the digital signal processor 50 to which the pixel data for use in the extended image processing output by the input/output module 44 is output is added to the pixel data.

The selector section 60 is a selection section configured to select the component of the input/output destination of the pixel data an the basis of the output destination information added to the pixel data for use in the extended image processing output by the input/output module 44. If the output destination information added to the pixel data for use in the extended image processing output by the input/output module 44 indicates an output to the external extension processing device 600 provided outside the image processing device 2, the selector section 60 directly outputs the pixel data input from the input/output module 44 to the external interface section 30 without involving the DMA bus 10. Thereby, the pixel data output from the input/output module 44 is transmitted to the external extension processing device 600 provided outside the image processing device 2 by the external interface section 30. The selector section 60 directly outputs the externally processed pixel data transmitted from the external extension processing device 600 provided outside the image processing device 2 via the external interface section 30 to the input/output module 44 without involving the DMA bus 10.

Also, in a case in which the output destination information added to the pixel data for use in the extended image processing output by the input/output module 44 indicates an output to the external extension processing device 600 provided outside the image processing device 2, an operation when the input/output module 44 incorporates the external image processing into the pipeline processing of the image processing section 40 is similar to that of the input/output module 24 of the image processing section provided in the image processing device 1 of the first embodiment. Accordingly, a detailed description of the operation when the input/output module 44 incorporates the external image processing into the pipeline processing of the image processing section 40 will be omitted.

On the other hand, if the output destination information added to the pixel data for use in the extended image processing output by the input/output module 44 indicates an output to the digital signal processor 50, the selector section 60 outputs the pixel data input from the input/output module 44 to the digital signal processor 50 without involving the DMA bus 10. Then, the selector section 60 directly outputs the externally processed pixel data transmitted from the digital signal processor 50 to the input/output module 44 without involving the DMA bus 10. Thereby, in the image processing section 40, the DSP image processing to be executed by the digital signal processor 50 is incorporated into the pipeline configured within the image processing section 40.

The digital signal processor 50 is a signal processing section provided inside the image processing device 2 and configured to perform DSP image processing incorporated into a pipeline configured within the image processing section 40 provided in the image processing device 2. The digital signal processor 50 executes image processing which is not executed in any image processing module 23 within the image processing section 40 provided in the image processing device 2, i.e., DSP image processing for extending image processing to be executed in the image processing device 2. The digital signal processor 50 performs predetermined digital DSP image processing on pixel data for use in extended image processing directly input from the input/output module 44 without involving the DMA bus 10 in the imaging device 200 and directly outputs pixel data subjected to the DSP image processing (DSP-processed pixel data) to the input/output module 44 without involving the DMA bus 10.

Also, the digital signal processor 50 performs various signal processing in addition to the DSP image processing to be incorporated into the pipeline configured within the image processing section 40. Thus, as shown in FIG. 7, the digital signal processor 50 is also connected to the DMA bus 10. Accordingly, the digital signal processor 50 can also execute various signal processing using the DRAM 500 connected to the DMA bus 10. In the configuration of the image processing device 2 shown in FIG. 7, the digital signal processor 50 is assumed to have a configuration in which DSP image processing is executed without using the DRAM 500. However, the digital signal processor 50 may use the DRAM 500 when DSP image processing is performed on pixel data for use in extended image processing.

According to such a configuration, in the imaging device 200, the extended image processing of either the external image processing to be executed by the external extension processing device 600 or the DSP image processing to be executed by the digital signal processor 50 is incorporated into the pipeline processing based on the image processing to be executed by each of the image processing modules 23 within the image processing section 40 provided in the image processing device 2. Thereby, in the imaging device 200, the external extension processing device 600 or the digital signal processor 50 can also extend image processing with respect to image processing which cannot be executed by only the image processing device 2 as in the pipeline processing performed by the image processing section 40 provided in the image processing device 2.

Next, the configuration of the input/output module 44 provided in the image processing section 40 in the image processing device 2, the configuration of the pixel data to be exchanged by the input/output module 44, and the operation of the input/output module 44 will be described. Also, similar to the input/output module 24 of the image processing section 20 provided in the image processing device 1 of the first embodiment, the input/output module 44 can also be incorporated at any position within the pipeline. In the following description, the image processing modules 23 will be described as being connected to a stage previous to and a stage subsequent to the input/output module 44 similar to the input/output module 24 of the image processing section 20 provided in the image processing device 1 of the first embodiment. A concept of an operation in which the input/output module 44 provided in the image processing section 40 exchanges pixel data with the external interface section 30 or the digital signal processor 50 is similar to a conceptual operation in which the input/output module 24 of the image processing section 20 provided in the image processing device 1 of the first embodiment shown in FIG. 2 exchanges pixel data, except for an operation via the selector section 60. Accordingly, a detailed description of the conceptual operation of the pixel data exchange in the input/output module 44 will be omitted.

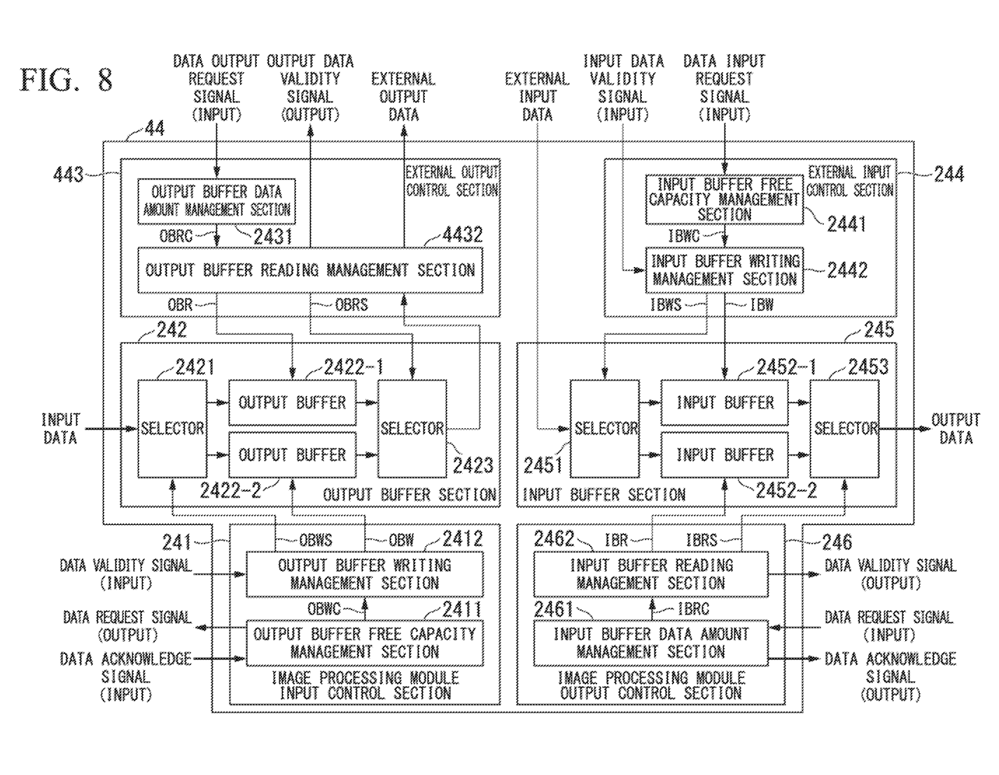

FIG. 8 is a block diagram showing a schematic configuration of the input/output module 44 provided in the image processing section 40 within the image processing device 2 according to the second embodiment of the present invention. In FIG. 8, a basic configuration of the input/output module 44 is shown. The input/output module 44 shown in FIG. 8 includes an image processing module input control section 241, an output buffer section 242, an external output control section 443, an external input control section 244, an input buffer section 245, and an image processing module output control section 246. The input/output module 44 shown in FIG. 8 has a configuration in which the external output control section 243 provided in the input/output module 24 of the image processing section 20 provided in the image processing device 1 of the first embodiment is replaced with the external output control section 443. In the external output control section 443, a function of adding output destination information indicating the component of the output destination to pixel data for use in extended image processing is added to the function of the external output control section 243 provided in the input/output module 24 of the image processing section 20 provided in the image processing device 1 of the first embodiment.

Also, the other components of the input/output module 44 are similar to those of the input/output module 24 of the image processing section 20 provided in the image processing device 1 of the first embodiment shown in FIG. 3. Accordingly, in the following description, the components included in the input/output module 44 similar to those included in the input/output module 24 in the first embodiment shown in FIG. 3 are denoted by the same reference signs and a detailed description of the components will be omitted.

Also, in the input/output module 44, as in the input/output module 24, the configuration of the image processing module input control section 241, the output buffer section 242, and the external output control section 443 is an external output section.

Also, in the input/output module 44, as in the input/output module 24, according to the configuration of the external output section, the input data (pixel data) output from the image processing module 23 connected to the previous stage is temporarily stored in the output buffer section 242 and the pixel data temporarily stored in the output buffer section 242 is read and output as external output data in accordance with a request for output data from the component of the output destination of the pixel data. Also, in the input/output module 44, the configuration of the external input section is similar to that of the input/output module 24. In other words, in the input/output module 44, the configuration of the external input control section 244, the input buffer section 245, and the image processing module output control section 246 is an external input section.

Similar to the external output control section 243 provided in the input/output module 24 in the first embodiment, the external output control section 443 controls an output (reading) of input data (pixel data) stored in the output buffer section 242. The external output control section 443 shown in FIG. 8 includes an output buffer data amount management section 2431 and an output buffer reading management section 4432. The external output control section 443 has a configuration in which the output buffer reading management section 2432 in the external output control section 243 of the input/output module 24 in the first embodiment is replaced with an output buffer reading management section 4432.

The output buffer data amount management section 2431 monitors the storage capacities of the output buffer 2422-1 and the output buffer 2422-2 provided in the output buffer section 242, and outputs an output buffer reading control signal OBRC for issuing an instruction for outputting (reading) pixel data stored in the output buffer 2422 to the output buffer reading management section 4432 in accordance with the result of monitoring the storage capacities.

The output buffer reading management section 4432 outputs an output buffer reading selection signal OBRS and an output buffer reading signal OBR to the output buffer section 242 for controlling reading (output) of input data (pixel data) stored in the output buffer section 242 on the basis of the output buffer reading control signal OBRC output from the output buffer data amount management section 2431. Thereby, the output buffer section 242 reads the stored pixel data in accordance with the output buffer reading signal OBR

In the input/output module 44, the pixel data read from the output buffer section 242 is input to the output buffer reading management section 4432 without being output as external output data. Then, the output buffer reading management section 4432 adds output destination information to the pixel data read (output) from the output buffer section 242 and outputs the pixel data to which the output destination information is added as the external output data to the selector section 60. At this time, the output buffer reading management section 4432 also outputs an output data validity signal indicating whether or not each piece of pixel data included in a unit line output as external output data is valid pixel data to the selector section 60.

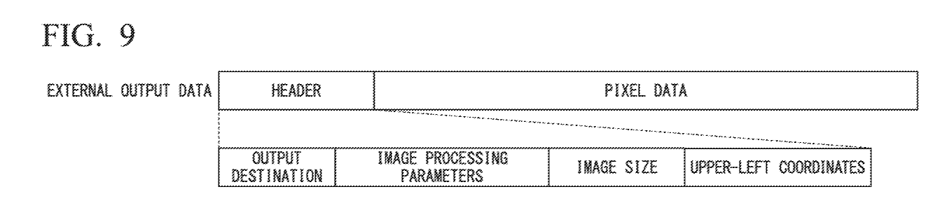

Here, the configuration of the external output data to which the output destination information is added by the output buffer reading management section 4432, i.e., the configuration of the pixel data exchanged by the input/output module 44, will be described. FIG. 9 is a diagram showing an example of a configuration of external output data output by the input/output module 44 provided in the image processing section 40 within the image processing device 2 according to the second embodiment of the present invention. In FIG. 9, an example in which the output buffer reading management section 4432 adds the output destination information so that the output destination information is included in the additional information (more specifically, header information) is shown.

In the external output data, the header information is added to a field in front of the pixel data for use in the extended image processing, i.e., a field of a header side of the external output data. The output buffer reading management section 4432 adds output destination information so that the output destination information is included in the header information. In FIG. 9, a configuration of the header information including information of an “output destination”, “image processing parameters”, an “image size”, and “upper-left coordinates” is shown.

Here, the information of the “output destination” included in the header information is output destination information added by the output buffer reading management section 4432. According to this output destination information, the selector section 60 can output the external output data to any of the appropriate components even when there are a plurality of output destinations for outputting the external output data output from the input/output module 44. In the image processing device 2, the information of the “output destination” (the output destination information) included in the header information is output destination information indicating the external extension processing device 600 connected to the external interface section 30 or the digital signal processor 50 as an output destination. Accordingly, on the basis of the information on the “output destination” included in the header information (the output destination information), the selector section 60 outputs the pixel data for use in the extended image processing included in the external output data to the component indicated by the output destination information.

Also, the information of the “image processing parameters”, the “image size”, and the “upper-left coordinates” included in the header information is information (additional information) such as settings of image processing to be used when each component for executing extended image processing (the external extension processing device 600 or the digital signal processor 50 in the image processing device 2) executes the extended image processing.

More specifically, the information of the “image processing parameters” included in the header information is information of the settings (the parameters) of the extended image processing (the external image processing or the DSP image processing) to be performed on the pixel data included in the external output data. As the information of the “image processing parameters”, for example, there is information such as parameters such as a value of a filter coefficient in a filtering process, a set value in an image interpolation process, a value of a resizing ratio in a resizing process, and a value of a distortion coefficient in a distortion correction process.

Also, the information of the “image size” included in the header information is information about a size of the image data included in the external output data. The information of the “image size” is, for example, information such as an amount of data of pixel data (the number of pixels), a size of block image data (the number of pixels in a horizontal direction and the number of pixels in a vertical direction), and a size of a still image of one frame (the number of pixels in the horizontal direction and the number of pixels in the vertical direction).

Also, the information of the “upper-left coordinates” included in the header information is information about a position (coordinates) of the pixel data included in the external output data with respect to a reference position (coordinates). The information of the “upper-left coordinates” is, for example, information such as coordinates for indicating a positional relationship of pixel data corresponding to a pixel located at the upper left in a field of the image represented by pixel data included in the external output data (for example, first pixel data) with respect to reference coordinates (0, 0) at coordinates of an upper-left pixel generally handled as a reference position when image processing is performed on a still image of one frame.

A component to which the external output data, i.e., the pixel data for use in the extended image processing, is input (the external extension processing device 600 or the digital signal processor 50) can perform extended image processing suitable for the input pixel data by using the information of the “image processing parameters”, the “image size”, and the “upper-left coordinates” included in the header information input simultaneously with the pixel data. Also, for example, information of any of the “image processing parameters”, the “image size”, and the “upper-left coordinates” may include information indicating a position of the pixel data included in the external output data in block image data within a still image of one frame, in other words, whether the pixel data included in the external output data is first block image data on which image processing starts for a still image of one frame and whether the pixel data included in the external output data is last block image data on which the image processing ends for a still image of one frame. Thereby, it is possible to perform extended image processing in consideration of a situation of image processing on a still image of one frame.

Also, generally, in the image processing device, it is also conceivable that the information to be used when the extended image processing is executed may not be output simultaneously with the pixel data for use in the extended image processing as the header information. However, in the case of this configuration, for example, it is necessary for the system control section (not shown) to perform setting similar to the information included in the header information individually for each component which executes the extended image processing and it may be difficult to synchronize each component for executing the extended image processing with one of the image processing modules 23 provided in the image processing section 40 in the pipeline processing. Thus, outputting the information to be used when the extended image processing is executed as the header information simultaneously with pixel data for use in extended image processing is conceived to be a method effective for facilitating synchronization between each of the components that execute the extended image processing and one of the image processing modules 23 provided in the image processing section 40 in the pipeline processing.

Also, the configuration of external output data to which the output buffer reading management section 4432 adds the output destination information to output the external output data is not limited to the configuration shown in FIG. 9, and various configurations are conceivable. Also, the information such as the settings of the image processing used for executing the extended image processing is not limited to the information shown in FIG. 9 and various information and settings are conceivable.

Also, the timings of the operations of the external output section and the external input section in the input/output module 44 can be considered to be similar to the timings of the operations of the external output section and the external input section in the input/output module 24 of the image processing section 20 provided in the image processing device 1 of the first embodiment shown in FIG. 4 and FIG. 5, except that the configuration of the external output data is different. Accordingly, a detailed description of the timings of the operations of the external output section and the external input section in the input/output module 44 will be omitted.

According to such a configuration, the input/output module 44 provided in the image processing section 40 can output the input data (pixel data) output from the image processing module 23 connected to the previous stage to any component provided outside the image processing section 40 and output the external input data (the externally processed pixel data) output from any component provided outside the image processing section 40 to the image processing module 23 connected to the subsequent stage.

Thereby, the input/output module 44 can incorporate extended image processing of any component provided outside the image processing section 40 between the image processing module 23 connected to the previous stage and the image processing module 23 connected to the subsequent stage in which the pipeline is configured in the image processing section 40.

Also, in the configuration of the input/output module 44 shown in FIG. 8, as in the input/output module 24 in the first embodiment shown in FIG. 3, a configuration in which pixel data is exchanged according to a request signal, an acknowledge signal, and a valid signal is shown. However, the input/output module 44 may exchange pixel data according to various other data transmission methods.

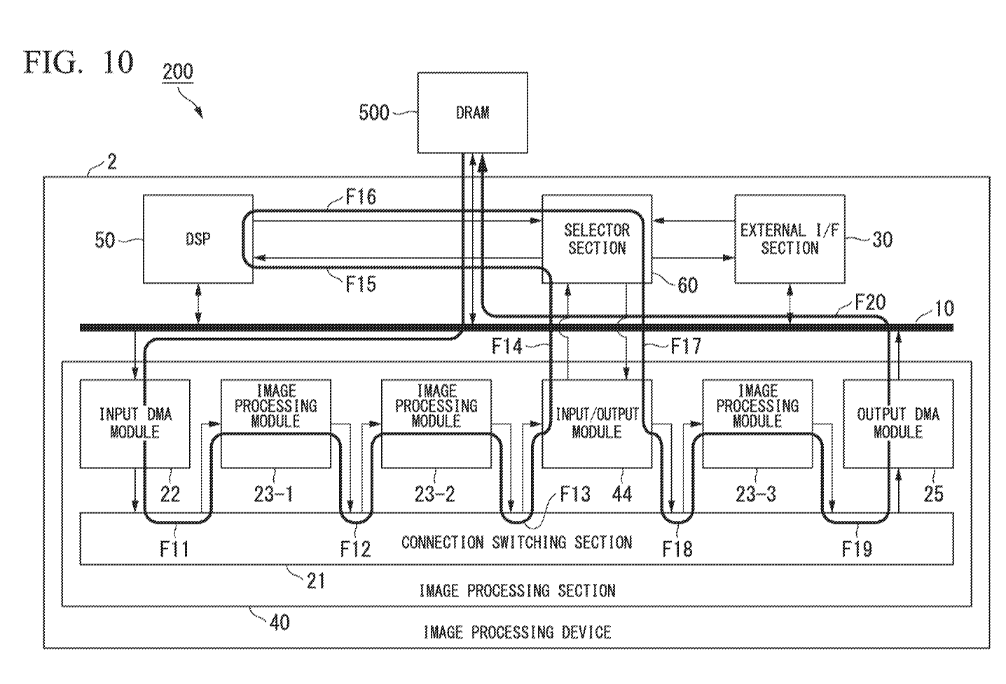

Next, a flow of data in pipeline processing into which extended image processing of any component provided outside the image processing section 40 is incorporated by the input/output module 44 will be described. FIG. 10 is a diagram schematically showing a flow of pixel data including the input/output module 44 provided in the image processing section 40 within the image processing device 2 according to the second embodiment of the present invention. In FIG. 10, a flow of pixel data when the DSP image processing of the digital signal processor 50 is incorporated into the pipeline processing configured in the image processing section 40 is shown. More specifically, in the configuration of the imaging device 200 shown in FIG. 7, a flow of pixel data when the DSP image processing of the digital signal processor 50 is incorporated into a series of image processing based on the pipeline processing by incorporating the input/output module 44 between the image processing module 23-2 and the image processing module 23-3 provided in the image processing section 40 within the image processing device 2 is shown.

In the pipeline processing in the image processing section 40 provided in the image processing device 2, as in the pipeline processing in the image processing section provided in the image processing device 1 of the first embodiment, the image processing module 23 and the digital signal processor 50 perform predetermined image processing on pixel data output from the image processing module 23 of the previous stage or the digital signal processor 50 in parallel so that the pipeline processing can be performed smoothly. In other words, the image processing module 23 and the digital signal processor 50 perform different image processing in the same period. However, in the description of the flow of the pixel data shown in FIG. 10, for ease of description, as in the description of the flow of pixel data in the image processing device 1 of the first embodiment, a flow of data focused on pixel data of one processing unit will be described. In the flow of pixel data shown in FIG. 10, processing is performed in the following flow.

(Flow F11): First, the input DMA module 22 reads pixel data included in the block image data stored in the DRAM 500 for each unit line by DMA via the DMA bus and outputs the read pixel data to the image processing module 23-1 of the connection destination for performing the next image processing via the connection switching section 21.

(Flow F12): Subsequently, the image processing module 23-1 performs predetermined image processing on the pixel data output from the input DMA module 22 of the connection destination via the connection switching section 21 and outputs the processed pixel data after image processing is performed to the image processing module 23-2 of the connection destination for performing the next image processing via the connection switching section 21.

(Flow F13): Subsequently, the image processing module 23-2 performs predetermined image processing on the processed pixel data output from the image processing module 23-1 of the connection destination via the connection switching section 21 and outputs processed pixel data after image processing is further performed to the digital signal processor 50 for performing the next image processing via the connection switching section 21. At this time, the connection switching section 21 outputs the processed pixel data output from the image processing module 23-2 to the input/output module 44.

(Flow F14): Subsequently, the input/output module 44 adds output destination information indicating the digital signal processor 50 to the processed pixel data output from the image processing module 23-2 of the connection destination via the connection switching section 21. Then, the input/output module 44 directly outputs the processed pixel data to which the output destination information is added to the selector section 60 without involving the DMA bus 10.

(Flow F15): Subsequently, the selector section 60 selects the digital signal processor 50 as a component of the input/output destination of the processed pixel data on the basis of the output destination information added to the processed pixel data input from the input/output module 44. Then, the selector section 60 directly transmits processed pixel data input from the input/output module 44 without involving the DMA bus 10 to the selected digital signal processor 50.

(Flow F16): Subsequently, the digital signal processor 50 performs predetermined DSP image processing on the processed pixel data transmitted via the selector section 60 provided in the image processing device 2 and outputs the processed pixel data (DSP-processed pixel data) after the DSP image processing is performed to the selector section 60.

(Flow F17): Subsequently, the selector section 60 directly outputs the DSP-processed pixel data output from the digital signal processor 50 to the input/output module 44 without involving the DMA bus 10.

(Flow F18): Subsequently, the input/output module 44 outputs the DSP-processed pixel data directly output from the selector section 60 without involving the DMA bus 10 to the image processing module 23-3 of the connection destination for performing the next image processing via the connection switching section 21.

(Flow F19): Subsequently, the image processing module 23-3 performs predetermined image processing on the DSP-processed pixel data output from the input/output module 44 of the connection destination via the connection switching section 21 and outputs DSP-processed pixel data (processed pixel data) after image processing is further performed to the output DMA module 25 via the connection switching section 21.

(Flow F20): Subsequently, the output DMA module 25 writes (stores) the processed pixel data output from the image processing module 23-3 of the connection destination via the connection switching section 21 in the DRAM 500 by DMA via the DMA bus 10.

In this manner, in the image processing device 2, a series of image processing in which DSP image processing of the digital signal processor 50 is incorporated into the pipeline processing configured in the image processing section 40 is executed.

According to the second embodiment, the image processing device (the image processing device 2) in which the external output control section (the external output control section 443) adds output destination information indicating any external processing section (the external extension processing device 600 or the digital signal processor 50) to which the processed data (input data, pixel data, or processed pixel data) is output among a plurality of external processing sections (the external extension processing device 600 and the digital signal processor 50) to the processed data (the input data, the pixel data, or the processed pixel data for use in the extended image processing) is configured.

Also, according to the present second embodiment, the image processing device 2 in which the output destination information is included in additional information in which information of a setting of the external processing (extended image processing, external image processing, or DSP image processing) (settings of image processing) to be performed on the processed data (input data, pixel data, or processed pixel data) by the external processing section (the external extension processing device 600 or the digital signal processor 50) is shown is configured.

As described above, in the image processing device 2 of the second embodiment, the input/output module 44 to which the selector section 60 is directly connected without involving the DMA bus 10 is provided within the image processing section 40 for performing pipeline processing. At this time, in the image processing device 2 of the second embodiment, the input/output module 44 adds the output destination information for selecting the component for transmitting the pixel data to the pixel data by the selector section 60 and outputs the pixel data with the output destination information. Thereby, in the image processing device 2 of the second embodiment, the selector section 60 can select the component of the input/output destination of the pixel data on the basis of the output destination information added to the pixel data and transmit processed pixel data during the pipeline process to a component provided outside the image processing section 40 indicated by the output destination information. Then, in the image processing device 2 of the second embodiment, it is possible to perform subsequent image processing in pipeline processing on extended processed pixel data (externally processed pixel data or DSP-processing pixel data) obtained through image processing performed by a component provided outside the image processing section 40 shown in the output destination information. Thereby, in the image processing device 2 of the second embodiment, as in the image processing device 1 of the first embodiment, it is possible to incorporate image processing of a component provided outside the image processing section 40 for providing extensibility into image processing based on pipeline processing which has already been configured.

Moreover, in the image processing device 2 of the second embodiment, as in the image processing device 1 of the first embodiment, the pixel data for use in the image processing to be extended can be transmitted to and from the component provided outside the image processing section 40 without using a storage section such as the DRAM 500. Thus, in the image processing device 2 of the second embodiment, as in the image processing device 1 of the first embodiment, it is possible to perform a series of image processing in a state in which image processing to be extended is incorporated without dividing the already configured pipeline processing into parts. Thereby, in the image processing device 2 of the second embodiment, as in the image processing device 1 of the first embodiment, it is possible to extend image processing without causing overload on the bus bandwidth of the DRAM, increase of the power consumption of the image processing device 2, or the like and deteriorating the performance of the imaging device 200 equipped with the image processing device 2 of the second embodiment.

Also, in the image processing device 2 of the second embodiment, a configuration in which DSP image processing of the digital signal processor 50 is incorporated between the image processing module 23-2 and the image processing module 23-3 provided in the image processing section 40 within the image processing device 2 has been described. However, as described above, in the image processing device 2 of the second embodiment, the selector section 60 can select the component of the input/output destination of the pixel data. Accordingly, in the image processing device 2 of the second embodiment, as in the image processing device 1 of the first embodiment, it is possible to implement a configuration in which external image processing of the external extension processing device 600 is incorporated.

Also, in the image processing device 2 of the second embodiment, the concept of changing the order of image processing performed by the image processing section 40 and the position of extended image processing to be incorporated into the pipeline by the connection switching section 21 is similar to that of the image processing device 1 of the first embodiment.

Also, in the image processing device 2 of the second embodiment, a configuration in which the input/output module 44 provided in the image processing section 40 is connected to the selector section 60 provided in the image processing device 2 and pixel data is received and transmitted from and to a component provided outside the image processing section 40 via the selector section 60 is shown. However, the configuration of the input/output module 44 is not limited to the configuration shown in the second embodiment. For example, the input/output module 44 may be configured to include the functions of the selector section 60 and the external interface section 30.

In the input/output module 44 of this configuration, as in the input/output module 24 according to the first embodiment, a delay time from an input of pixel data to an output thereof in a component provided outside the image processing section 40 is considered and configurations of the output buffer section 242 and the input buffer section 245 may be used together. In other words, a configuration in which the buffering of pixel data in the input/output module 44 is omitted may be adopted.

Also, in the image processing device 1 of the first embodiment, a configuration in which one input/output module 24 is provided in the image processing section 20 and one input/output module 44 is provided in the image processing section 40 in the image processing device 2 of the second embodiment has been described. However, in the image processing device of the present invention, the number of input/output modules provided in the image processing section is not limited to the number shown in the first embodiment and the second embodiment, i.e., one. In other words, in the image processing device of the present invention, a plurality of input/output modules may be provided in the image processing section. By providing a plurality of input/output modules in the image processing section, it is possible to incorporate image processing to be executed by a component provided outside the image processing section at a plurality of positions within the pipeline already configured in the image processing section.

### Third Embodiment

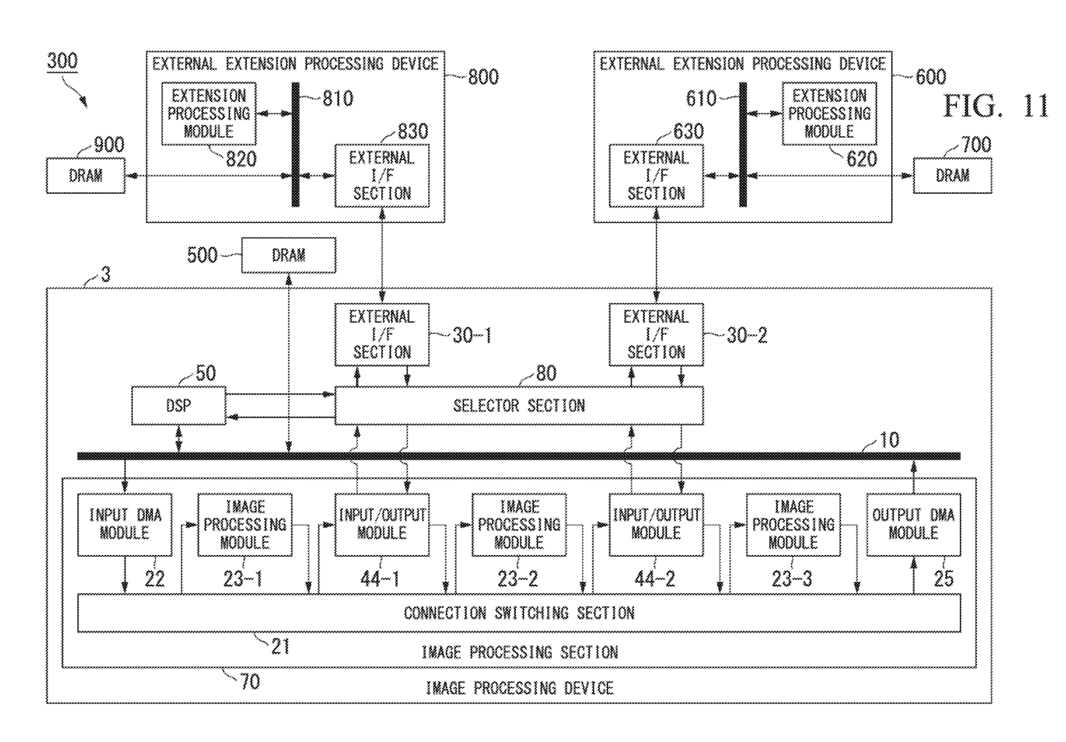

Next, a third embodiment of the present invention will be described. Also, in the following description, for example, a case in which an image processing device according to the third embodiment of the present invention is mounted in an imaging device such as a still-image camera (hereinafter referred to as an “imaging device 300”) will be described. FIG. 11 is a block diagram showing a schematic configuration of the image processing device according to the third embodiment of the present invention.

The image processing device 3 according to the third embodiment of the present invention shown in FIG. 11 is configured to include a plurality (two) of input/output modules 44 in the image processing section 40 of the image processing device 2 of the second embodiment shown in FIG. 7.

Also, in FIG. 11, a DRAM 500, an external extension processing device 600, a DRAM 700, an external extension processing device 800 including a DMA bus 810, an extension processing module 820, and an external interface (I/F) section 830, and a DRAM 900 are collectively shown as components within the imaging device 300 related to the image processing device 3 of the third embodiment of the present invention. Also, the external extension processing device 800 is an image processing device (system LSI) similar to the external extension processing device 600, except that predetermined external digital image processing to be performed on input pixel data is different. Also, the DRAM 900 is also a data storage section similar to the DRAM 700 except that the DRAM 900 is connected to the external extension processing device 800.

The image processing device 3 shown in FIG. 11 includes a DMA bus 10, an image processing section 70, two external interface (I/F) sections 30 (an external interface section 30-1 and an external interface section 30-2), a digital signal processor (DSP) 50, and a selector section 80. Also, the image processing section 70 includes a connection switching section 21, an input DMA module 22, three image processing modules 23-1 to 23-3, two input/output modules 44 (an input/output module 44-1 and an input/output module 44-2), and an output DMA module 25.

In the configuration of the image processing device 3 shown in FIG. 11, when the two input/output modules 44 are provided in the image processing section 40 provided in the image processing device 2 of the second embodiment shown in FIG. 7, the image processing section 40 and the selector section 60 provided in the image processing device 2 of the second embodiment are replaced with the image processing section 70 and the selector section 80.

Also, the other components of the image processing device 3 and the image processing section 70 provided in the image processing device 3 are similar to those of the image processing device 2 of the second embodiment shown in FIG. 7 and the image processing section 40 provided in the image processing device 2. Accordingly, in the following description, the components of the image processing device 3 and the image processing section 70 provided in the image processing device 3 similar to the components of the image processing device 2 of the second embodiment shown in FIG. 7 and the image processing section 40 provided in the image processing device 2 are denoted by the same reference signs and a detailed description of the components will be omitted. Also, in FIG. 11, as in the imaging device 200 shown in FIG. 7, shown of other components connected to each component provided in the imaging device 300 and the DMA bus 10 in the image processing device 3 is also omitted.

Similar to the image processing section 40 provided in the image processing device 2 of the second embodiment shown in FIG. 7, the image processing section 70 performs pipeline processing for various predetermined image processing in the image processing device 3 on the input block image data. Also, similar to the image processing section 40 provided in the image processing device 2 of the second embodiment, the image processing section 70 also has a function of changing the configuration of the pipeline.

Also, similar to the image processing section 40 provided in the image processing device 2 according to the second embodiment, the image processing section 70 includes a function of incorporating image processing different from image processing to be executed by each of the image processing modules 23-1 to 23-3 into pipeline processing. However, the image processing device 3 can incorporate any two pieces of extended image processing into DSP image processing to be executed by the digital signal processor 50, external image processing to be executed by the external extension processing device 600, and external image processing to be executed by the external extension processing device 800 in the pipeline processing as image processing for extending image processing in the image processing section 70. Also, in the image processing device 3, as in the image processing section 40 provided in the image processing device 2 of the second embodiment, the configuration of the pipeline in the image processing section 70 is changed (set), for example, by a system control section (not shown).

In FIG. 11, a configuration in which external image processing to be executed by the external extension processing device 800 is incorporated into the pipeline by incorporating the input/output module 44-1 between the image processing module 23-1 and the image processing module 23-2 and in which the external image processing to be executed by the external extension processing device 600 is incorporated into the pipeline by incorporating the input/output module 44-2 between the image processing module 23-2 and the image processing module 23-3 is shown. In other words, in the image processing section 70 shown in FIG. 11, a state in which a pipeline for sequentially performing image processing of the image processing module 23-1, image processing of the external extension processing device 800, image processing of the image processing module 23-2, image processing of the external extension processing device 600, and image processing of the image processing module 23-3 is configured is shown.

Also, in the image processing device 3, as in the image processing section 40 provided in the image processing device 2 of the second embodiment, a position where the input/output module 44 is incorporated into the pipeline is set by, for example, the system control section (not shown). Accordingly, in the image processing device 3, as in the image processing section 40 provided in the image processing device 2 of the second embodiment, a position where the input/output module 44 is incorporated into the pipeline is not limited to the position shown in FIG. 11 and the input/output module 44 can be incorporated at any position within the pipeline.

Each of the input/output module 44-1 and the input/output module 44-2 is similar to the input/output module 44 of the image processing section 40 provided in the image processing device 2 of the second embodiment. However, in the image processing device 3, output destination information included in the external output data to be output by each input/output module 44 in order to incorporate the extended image processing to be executed by a component provided outside the image processing section 70 at two positions of the pipeline indicates a different component. Thus, external output data output by each input/output module 44 is output to a component corresponding to the output destination information, i.e., any one of the digital signal processor 50, the external extension processing device 600, and the external extension processing device 800, by the selector section 80. Also, the external input data input to each input/output module 44 is input from the component corresponding to the output destination information included in the external output data via the selector section 80.

Similar to the selector section 60 provided in the image processing device 2 of the second embodiment, the selector section 80 selects a component for transmitting pixel data for use in extended image processing to output the pixel data on the basis of the output destination information included in the external output data output by each of the input/output modules 44. Then, the selector section 80 outputs the external input data (extended processing pixel data) transmitted from the selected component to any one of the corresponding input/output modules 44.

In the imaging device 300 according to such a configuration, any two pieces of extended image processing within DSP image processing to be executed by the digital signal processor 50, external image processing to be executed by the external extension processing device 600, and external image processing to be executed by the external extension processing device 800 are incorporated into a series of image processing based on the pipeline processing to be executed by each of the image processing modules 23 within the image processing section 70 provided in the image processing device 3. Thereby, in the imaging device 300, the digital signal processor 50, the external extension processing device 600, or the external extension processing device 800 can execute two pieces of image processing that cannot be executed by only the image processing device 3 as in the pipeline processing performed by the image processing section 70 and execute a series of image processing based on the pipeline processing of the image processing section 70.

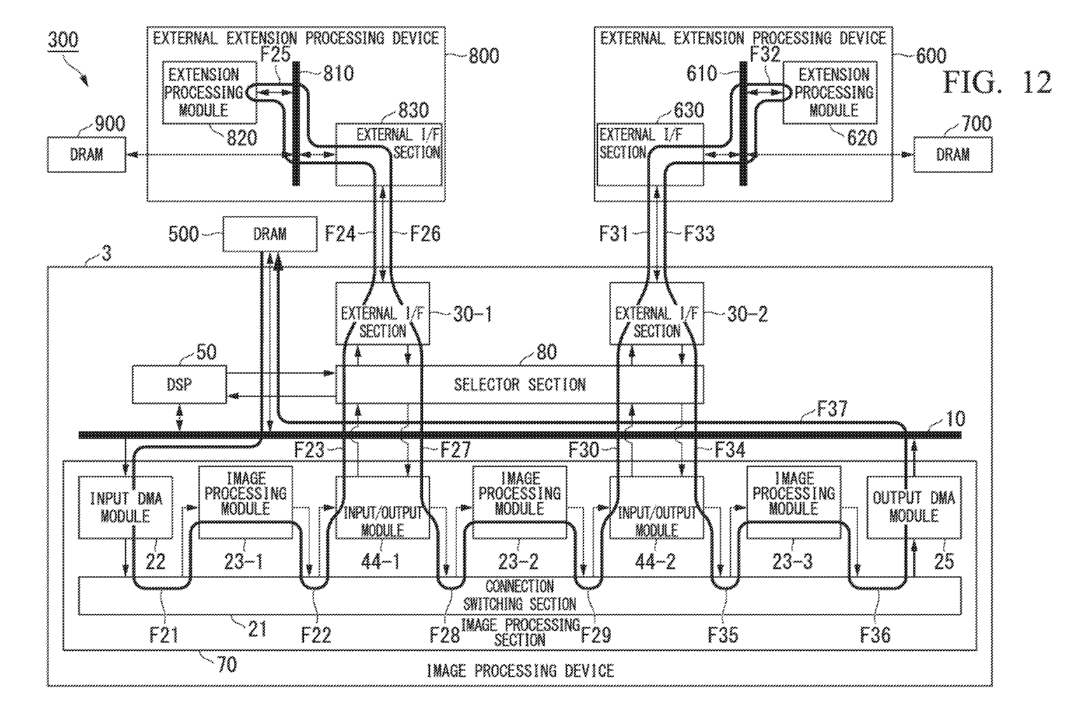

Next, a flow of data in the pipeline processing into which the extended image processing of any component provided outside the image processing section 70 is incorporated by the two input/output modules 44 will be described. FIG. 12 is a diagram schematically showing a flow of pixel data including the input/output module 44 provided in the image processing section 70 within the image processing device 3 according to the third embodiment of the present invention. In FIG. 12, a flow of pixel data when the external image processing of the external extension processing device 800 and the external image processing of the external extension processing device 600 are incorporated into the pipeline processing configured in the image processing section 70 is shown. More specifically, in the configuration of the imaging device 300 shown in FIG. 11, flows of pixel data when external image processing of the external extension processing device 800 is incorporated into a series of image processing based on pipeline processing by incorporating the input/output module 44-1 between the image processing module 23-1 and the image processing module 23-2 provided in the image processing section 70 in the image processing device 3 and when external image processing of the external extension processing device 800 is incorporated into a series of image processing based on pipeline processing by incorporating the input/output module 44-2 between the image processing module 23-2 and the image processing module 23-3 are shown.

Also, in the pipeline processing in the image processing section 70 provided in the image processing device 3, as in the pipeline processing in the image processing section 40 provided in the image processing device 2 of the second embodiment, the image processing module 23, the external extension processing device 800, and the external extension processing device 600 perform different predetermined image processing on input pixel data in parallel in the same period so that the pipeline processing can be performed smoothly. However, in the description of the flow of the pixel data shown in FIG. 12, for ease of description, as in the description of the flow of pixel data in the image processing device 2 of the second embodiment, a flow of data focused on pixel data of one processing unit will be described. In the flow of pixel data shown in FIG. 12, processing is performed in the following flow.

(Flow F21): First, the input DMA module 22 reads pixel data included in the block image data stored in the DRAM 500 for each unit line by DMA via the DMA bus 10, and outputs the read pixel data to the image processing module 23-1 of the connection destination for performing the next image processing via the connection switching section 21.

(Flow F22): Subsequently, the image processing module 23-1 performs predetermined image processing on the pixel data output from the input DMA module 22 of the connection destination via the connection switching section 21 and outputs processed pixel data after the image processing is performed to the external extension processing device 800 for performing the next image processing via the connection switching section 21. At this time, the connection switching section 21 outputs the processed pixel data output from the image processing module 23-1 to the input/output module 44-1.

(Flow F23): Subsequently, the input/output module 44-1 adds output destination information indicating the external extension processing device 800 to the processed pixel data output from the image processing module 23-1 of the connection destination via the connection switching section 21. Then, the input/output module 44-1 directly outputs the processed pixel data to which the output destination information is added to the selector section 80 without involving the DMA bus 10.

(Flow F24): Subsequently, the selector section 80 selects the external interface section 30-1 as a component of the input/output destination of the processed pixel data on the basis of the output destination information added to the processed pixel data input from the input/output module 44-1. Then, the selector section 80 directly outputs the processed pixel data input from the input/output module 44-1 without involving the DMA bus 10 to the selected external interface section 30-1. Thereby, the processed pixel data output from the input/output module 44-1 via the selector section 80 is further transmitted to the external extension processing device 800 via the external interface section 30-1.

(Flow F25): Subsequently, the external extension processing device 800 receives the processed pixel data transmitted via the external interface section 30-1 provided in the image processing device 3 by the external interface section 830 and outputs the processed pixel data to the extension processing module 820 via the DMA bus 810.

Then, the extension processing module 820 performs predetermined external image processing on the processed pixel data output from the external interface section 830 via the DMA bus 810 and outputs the processed pixel data (the externally processed pixel data) after the external image processing is performed to the external interface section 830 via the DMA bus 810.

(Flow F26): Subsequently, the external interface section 830 transmits the externally processed pixel data output from the extension processing module 820 to the image processing device 3 via the DMA bus 810. The image processing device 3 receives the externally processed pixel data transmitted via the external interface section 830 provided in the external extension processing device 800 by the external interface section 30-1 and the external interface section 30-1 outputs the received externally processed pixel data to the selector section 80.

(Flow F27): Subsequently, the selector section 80 directly outputs the externally processed pixel data output from the external interface section 30-1 to the input/output module 44-1 without involving the DMA bus 10.

(Flow F28): Subsequently, the input/output module 44-1 outputs the externally processed pixel data directly output from the selector section 80 without involving the DMA bus 10 to the image processing module 23-2 of the connection destination for performing the next image processing via the connection switching section 21.

(Flow F29): Subsequently, the image processing module 23-2 performs predetermined image processing on the externally processed pixel data output from the input/output module 44-1 of the connection destination via the connection switching section 21 and outputs the externally processed pixel data (the processed pixel data) after the image processing is further performed to the external extension processing device 600 for performing the next image processing via the connection switching section 21. At this time, the connection switching section 21 outputs the processed pixel data output from the image processing module 23-2 to the input/output module 44-2.

(Flow F30): Subsequently, the input/output module 44-2 adds the output destination information indicating the external extension processing device 600 to the processed pixel data output from the image processing module 23-2 of the connection destination via the connection switching section 21. Then, the input/output module 44-2 directly outputs the processed pixel data to which the output destination information is added to the selector section 80 without involving the DMA bus 10.

(Flow F31): Subsequently, the selector section 80 selects the external interface section 30-2 as a component of the input/output destination of the processed pixel data on the basis of the output destination information added to the processed pixel data input from the input/output module 44-2. Then, the selector section 80 outputs the processed pixel data directly input from the input/output module 44-2 without involving the DMA bus 10 to the selected external interface section 30-2. Thereby, the processed pixel data output from the input/output module 44-2 via the selector section 80 is further transmitted to the external extension processing device 600 via the external interface section 30-2.

(Flow F32): Subsequently, the external extension processing device 600 receives the processed pixel data transmitted via the external interface section 30-2 provided in the image processing device 3 by the external interface section 630 and outputs the processed pixel data to the extension processing module 620 via the DMA bus 610. Then, the extension processing module 620 performs predetermined external image processing on the processed pixel data output from the external interface section 630 via the DMA bus 610 and outputs processed pixel data (externally processed pixel data) after the external image processing is performed to the external interface section 630 via the DMA bus 610.

(Flow F33): Subsequently, the external interface section 630 transmits the externally processed pixel data output from the extension processing module 620 via the DMA bus 610 to the image processing device 3. The image processing device 3 receives the externally processed pixel data transmitted via the external interface section 630 provided in the external extension processing device 600 by the external interface section 30-2 and the external interface section 30-2 outputs the received externally processed pixel data to the selector section 80.

(Flow F34): Subsequently, the selector section 80 directly outputs the externally processed pixel data output from the external interface section 30-2 to the input/output module 44-2 without involving the DMA bus 10.

(Flow F35): Subsequently, the input/output module 44-2 sequentially outputs the externally processed pixel data output directly from the selector section 80 without involving the DMA bus 10 to the image processing module 23-3 of the connection destination for performing the next image processing via the connection switching section 21.

(Flow F36): Subsequently, the image processing module 23-3 performs predetermined image processing on the externally processed pixel data output from the input/output module 44-2 of the connection destination via the connection switching section 21 and outputs externally processed pixel data (processed pixel data) after the image processing is further performed to the output DMA module 25 via the connection switching section 21.

(Flow F37): Subsequently, the output DMA module 25 writes (stores) the processed pixel data output from the image processing module 23-3 of the connection destination via the connection switching section 21 in the DRAM 500 by DMA via the DMA bus 10.

In this manner, in the image processing device 3, a series of image processing in which external image processing of the external extension processing device 800 and external image processing of the external extension processing device 600 are incorporated into the pipeline processing configured in the image processing section 70 is executed.

As described above, in the image processing device 3 of the third embodiment, two input/output modules 44 to which the selector section 80 is directly connected without involving the DMA bus 10 are provided within the image processing section 70 for performing pipeline processing. At this time, in the image processing device 3 of the third embodiment, each input/output module 44 adds output destination information for selecting the components to which pixel data is transmitted by the selector section 80 to the pixel data and outputs the pixel data with the output destination information. Thereby, in the image processing device 3 of the third embodiment, the selector section 80 can select a component of an input/output destination of pixel data corresponding to each input/output module 44 on the basis of the output destination information added to the pixel data and transmit the processed pixel data during the pipeline processing at a position of each input/output module 44 to each component provided outside the image processing section 70 indicated by the output destination information. In the image processing device 3 according to the third embodiment, it is possible to perform subsequent image processing of the pipeline processing at a position of each input/output module 44 with respect to extended processed pixel data (externally processed pixel data or DSP-processed pixel data) obtained by performing image processing in a component provided outside the image processing section 70. Thereby, in the image processing device 3 of the third embodiment, as in the image processing device 2 of the second embodiment, it is possible to incorporate a plurality of pieces of image processing of a plurality of components provided outside the image processing section 70 for providing extensibility into image processing based on the pipeline processing which has already been configured.

Moreover, in the image processing device 3 of the third embodiment, as in the image processing device 2 of the second embodiment, it is also possible to transmit the pixel data for use in the image processing to be extended to and from a plurality of components provided outside the image processing section 70 without using a storage section such as the DRAM 500. Thus, in the image processing device 3 of the third embodiment, as in the image processing device 2 of the second embodiment, it is also possible to perform a series of image processing in a state in which a plurality of pieces of image processing to be extended are incorporated without dividing the already configured pipeline processing into parts. Thereby, in the image processing device 3 of the third embodiment, as in the image processing device 2 of the second embodiment, it is also possible to extend image processing without causing overload on the bus bandwidth of the DRAM, increase of the power consumption of the image processing device 1, or the like and deteriorating the performance of the imaging device 300 equipped with the image processing device 3 of the third embodiment.

In the image processing device 3 of the third embodiment, a configuration in which external image processing of the external extension processing device 800 or the external extension processing device 600 is incorporated at positions between the image processing module 23-1 and the image processing module 23-2 provided in the image processing section 70 within the image processing device 3 and between the image processing module 23-2 and the image processing module 23-3 provided therein has been described. However, as described above, because the selector section 80 can select a component of the input/output destination of the pixel data in the image processing device 3 of the third embodiment, it is possible to implement a configuration in which DSP image processing of the digital signal processor 50 is incorporated at any position within the pipeline in the image processing section 70.

Also, in the image processing device 3 of the third embodiment, a configuration in which the input/output module 44-1 is incorporated between the image processing module 23-1 and the image processing module 23-2 provided in the image processing section 70 within the image processing device 3 and in which the input/output module 44-2 is incorporated between the image processing module 23-2 and the image processing module 23-3 has been described. However, as described above, in the image processing device 3 of the third embodiment, the connection switching section 21 can change the order of image processing to be performed by the image processing section 70 and the position of the input/output module 44 to be incorporated into the pipeline. Thus, the input/output module 44-1 and the input/output module 44-2 can be configured to be incorporated into a pipeline consecutively. For example, a configuration in which external image processing of the external extension processing device 800 and external image processing of the external extension processing device 600 may be consecutively incorporated between the image processing module 23-1 and the image processing module 23-2 may be adopted.

Also, in the image processing device 3 of the third embodiment, the concept of changing the order of image processing performed by the image processing section 70 and the position of extended image processing to be incorporated into the pipeline by the connection switching section 21 is similar to that of the image processing device 2 of the second embodiment.

Also, in the image processing device 3 of the third embodiment, a configuration in which the external interface section 30-1 transmits processed pixel data to the external extension processing device 800 and the external interface section 30-2 transmits processed pixel data to the external extension processing device 600 is shown. In other words, a case in which the external interface section 30 has a configuration corresponding to one component provided outside the image processing device 3 has been described. However, the external component corresponding to the external interface section 30 is not limited to one component, and may be configured to correspond to a plurality of external components. For example, the external interface section 30 may be a connection section of a PCI-Express specification corresponding to a plurality of channels. In this case, the external interface section 30 may select an external component for executing image processing on the processed pixel data and transmit the processing pixel data to the selected component on the basis of the output destination information added to the input processed pixel data.

Also, in the image processing device 1 of the first embodiment, a configuration in which external image processing of the external extension processing device 600 connected outside the image processing device 1 is incorporated into a series of pipeline processing in the image processing section 20 provided in the image processing device 1 has been described. In the image processing device 2 of the second embodiment, a configuration in which DSP image processing of the digital signal processor 50 connected outside the image processing section 40 is incorporated into a series of pipeline processing in the image processing section 40 provided in the image processing device 2 has been described. Further, in the image processing device 3 of the third embodiment, a configuration in which external image processing of the external extension processing device 800 and the external extension processing device 600 connected outside the image processing device 3 is incorporated into a series of pipeline processing in the image processing section 70 provided in the image processing device 3 has been described. In other words, in the first to third embodiments, a configuration in which processed pixel data obtained by partially performing the pipeline processing in the image processing section is temporarily transmitted outside the image processing section and consecutive image processing of the pipeline processing is performed in the image processing section after processed pixel data (extension processing pixel data) obtained by performing image processing outside the image processing section is transmitted has been described.

However, for example, according to the configuration of the imaging device equipped with the image processing device, a configuration in which the image processing section provided in the image processing device executes pipeline processing from the middle may also be conceived. More specifically, for example, a case in which a structure of pixel data output by a solid-state imaging device mounted in the imaging device is different from a structure of pixel data input in the pipeline processing configured in the image processing section or the like is conceivable. In this case, in the imaging device, it is conceivable that an external imaging processing device corresponding to a solid-state imaging device for outputting pixel data having a different structure be mounted, the external imaging processing device execute image processing of a method different from that of previous-stage image processing in the pipeline processing configured in the image processing section provided in the image processing device, and subsequent-stage image processing in the pipeline processing configured in the image processing section provided in the image processing device following image processing of the external imaging processing device be performed thereafter.

Also, for example, according to the configuration of the imaging device equipped with the image processing device, a configuration in which the image processing section provided in the image processing device partially executes pipeline processing may be conceived. More specifically, for example, a case in which the structure of the pixel data input to the display section mounted in the imaging device is different from the structure of the pixel data output from the pipeline processing configured in the image processing section or the like may be conceived. In this case, in the imaging device, it is conceivable that an external display processing device corresponding to the display section for inputting pixel data having a different structure be mounted, the image processing device execute previous-stage image processing in the pipeline processing configured in the image processing section, and the external display processing device perform image processing of a method different from that of subsequent-stage image processing in the pipeline processing configured in the image processing section following the previous-stage image processing of the image processing device thereafter and output an image processing result to the display section.

In other words, in the image processing device, a configuration in which the processed pixel data obtained by executing the pipeline processing in the image processing section is only transmitted (output) outside the image processing section or the extended processed pixel data obtained by executing the extended image processing in a component outside the image processing device (or the image processing section) is only transmitted (input) is also conceivable. In this case, in the input/output module provided in the image processing section, it is possible to implement a configuration in which only the transmission (output) of the processed pixel data to the external component or the transmission (input) of the extended processed pixel data from the external component is performed by operating either a component related to the transmission (output) of the processed pixel data outside the image processing section or a component related to the transmission (input) of the extended processed pixel data from the outside of the image processing section.

### First Application Example

Next, a first application example of the present invention will be described. The first application example is an example of a configuration in which only the transmission (input) of extended processed pixel data from an external component is implemented by operating only a component related to the transmission (input) of the extended processed pixel data from the outside of the image processing section in an input/output module provided in the image processing section. Also, in the following description, for example, a case in which the image processing device 1 according to the first embodiment of the present invention is mounted in an imaging device such as a still-image camera (hereinafter referred to as an “imaging device 400”) will be described. Also, the first application example can be conceived in a similar manner for the image processing device 2 of the second embodiment and the image processing device 3 of the third embodiment.

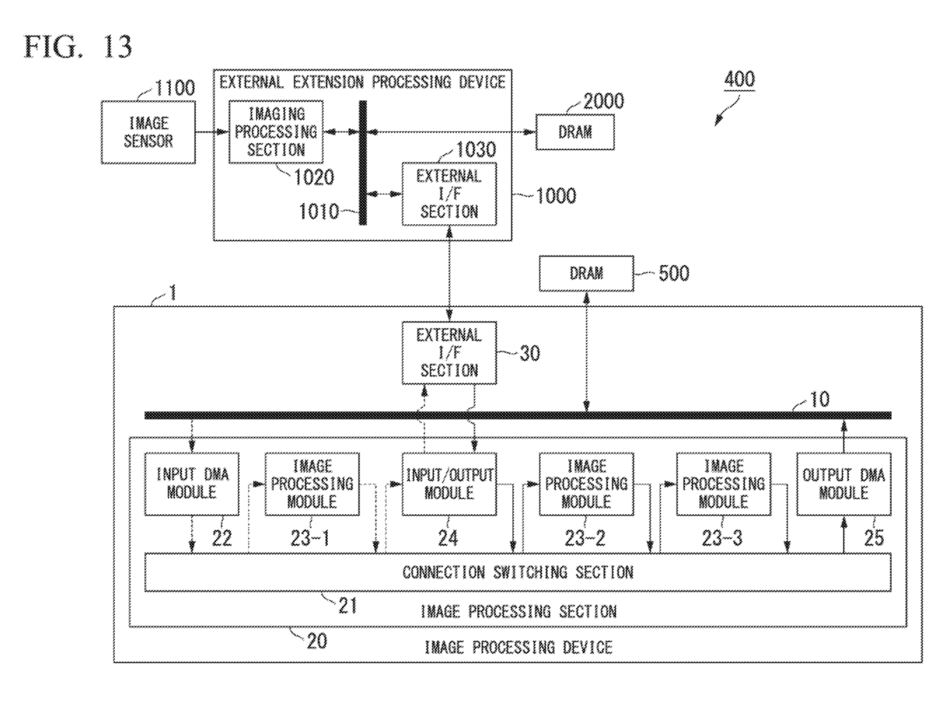

FIG. 13 is a block diagram showing a schematic configuration of a first application example in which the image processing device 1 according to the first embodiment of the present invention is mounted. Also, in FIG. 13, in the imaging device 400 of the configuration of the first application example, a DRAM 500, an external extension processing device 1000 including a DMA bus 1010, an imaging processing section 1020, and an external interface (I/F) section 1030, an image sensor 1100, and a DRAM 2000 are collectively shown as components related to the image processing device 1. Also, in FIG. 13, as in the imaging device 100 shown in FIG. 1, shown of other components connected to each component provided in the imaging device 400 and the DMA bus 10 in the image processing device 1 is also omitted.

The image sensor 1100 is a solid-state imaging device configured to output a pixel signal obtained by photoelectrically converting an optical image of a subject formed by a lens provided in the imaging device 400. Also, the external extension processing device 1000 is an imaging processing device (system LSI) configured to output pixel data of a digital signal obtained by performing control of the image sensor 1100 or predetermined image processing on the pixel signals input from the image sensor 1100 and further performing predetermined digital external image processing. Also, the DRAM 2000 is a data storage section configured to store various data processed in the external extension processing device 1000. Also, the DRAM 2000 may be a data storage section similar to the DRAM 700 connected to the external extension processing device 600 in the imaging device 100 shown in FIG. 1. In other words, the DRAM 2000 may be similar to the DRAM 700, except that the DRAM 2000 is connected to the external extension processing device 1000.

In the image processing device 1 shown in FIG. 13, the external extension processing device 1000 performs subsequent image processing on the processed pixel data (externally processed pixel data) after the external image processing is performed. More specifically, in the image processing device 1 shown in FIG. 13, the image processing section 20 performs pipeline processing based on various predetermined image processing from the image processing module 23-2 with respect to externally processed pixel data output from the external extension processing device 1000 and writes (stores) processed pixel data in the DRAM 500. Thus, in the image processing section 20, the input/output module 24 is connected to a stage previous to the image processing module 23-2. In other words, in the image processing section 20, the connection switching section 21 switches the connection of each component so that the output terminal of the input/output module 24 and the input terminal of the image processing module 23-2 are connected. In the image processing section 20, components related to the transmission (input) of the externally processed pixel data from the external extension processing device 1000, i.e., only the external input control section 244, the input buffer section 245, and the image processing module output control section 246 provided in the input/output module 24 are operated. Thereby, in the image processing device 1 shown in FIG. 13, processed pixel data is written (stored) in the DRAM 500 by consecutively performing pipeline processing for sequentially performing image processing of the image processing module 23-2 and image processing of the image processing module 23-3 on the externally processed pixel data output from the external extension processing device 1000.

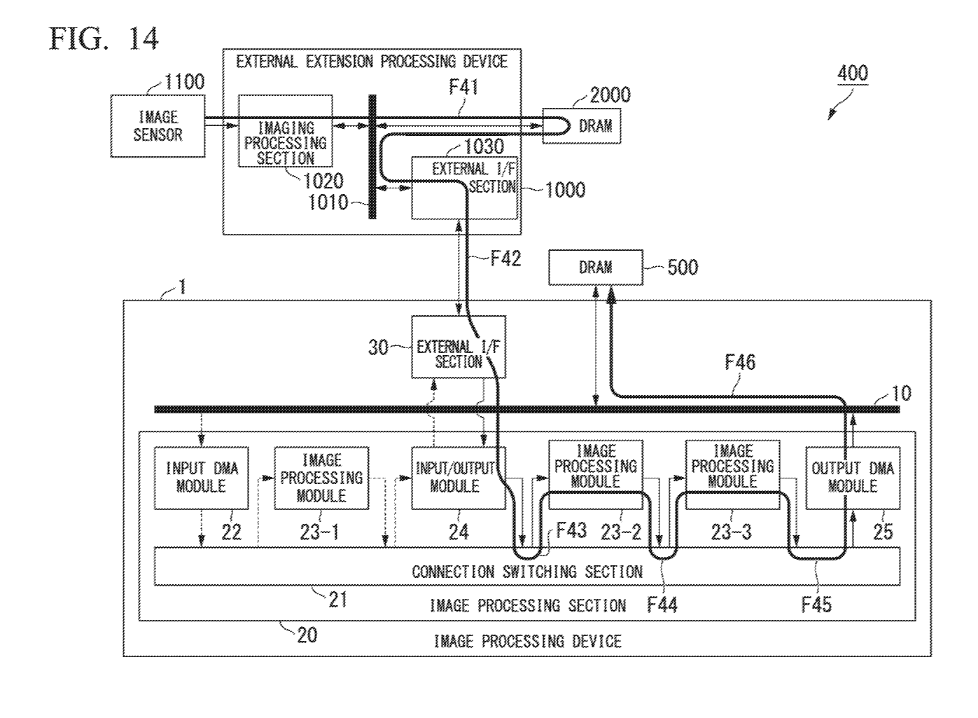

Next, a flow of data in the pipeline processing for performing the subsequent image processing on the externally processed pixel data output from the external extension processing device 1000 will be described. FIG. 14 is a diagram schematically showing a flow of pixel data including the input/output module 24 provided in the image processing section 20 within the image processing device 1 according to the first application example of the present invention. In FIG. 14, the flow of pixel data when the pipeline processing configured in the image processing section 20 is performed from the middle thereof after the external image processing of the external extension processing device 1000 is shown. More specifically, a flow of pixel data when pipeline processing subsequent to external image processing of the external extension processing device 1000 is performed by incorporating the input/output module 24 into a stage previous to the image processing module 23-2 provided in the image processing section within the image processing device 1 in the configuration of the imaging device 400 shown in FIG. 13 is shown.

In the pipeline processing in the image processing section 20 provided in the image processing device 1 shown in FIG. 13, the external extension processing device 1000 and the image processing module 23 perform predetermined different image processing on an input pixel signal or pixel data in parallel in the same period, so that the pipeline processing is smoothly performed. However, in the description of the flow of the pixel data shown in FIG. 14, for ease of description, as in the description of the flow of pixel data in the image processing device 1 shown in FIG. 6, a flow of data focused on pixel data of one processing unit will be described. In the flow of pixel data shown in FIG. 14, processing is performed in the following flow.

(Flow F41): First, the external extension processing device 1000 performs a predetermined imaging process and external image processing on a pixel signal input from the image sensor 1100 by the imaging processing section 1020 and temporarily writes (stores) externally processed pixel data after the external image processing is performed in the DRAM 2000 via the DMA bus 1010. Thereafter, the external extension processing device 1000 reads the externally processed pixel data stored in the DRAM 2000 and outputs the read externally processed pixel data to the external interface section 1030 via the DMA bus 1010.

(Flow F42): Subsequently, the external interface section 1030 transmits the externally processed pixel data (read) output from the DRAM 2000 via the DMA bus 1010 to the image processing device 1. The image processing device 1 receives externally processed pixel data transmitted via the external interface section 1030 provided in the external extension processing device 1000 by the external interface section 30. The external interface section 30 directly outputs the received externally processed pixel data to the input/output module 24 without involving the DMA bus 10.

(Flow F43): Subsequently, the input/output module 24 outputs the externally processed pixel data transmitted from the external extension processing device 1000 via the external interface section 30 to the image processing module 23-2 of the connection destination for performing the next image processing via the connection switching section 21.

(Flow F44): Subsequently, the image processing module 23-2 performs predetermined image processing on the externally processed pixel data output from the input/output module 24 of the connection destination via the connection switching section 21, and outputs externally processed pixel data (processed pixel data) after the image processing is performed to the image processing module 23-3 of the connection destination for performing the next image processing via the connection switching section 21.

(Flow F45): Subsequently, the image processing module 23-3 performs predetermined image processing on the processed pixel data output from the image processing module 23-2 of the connection destination via the connection switching section 21 and outputs processed pixel data after the image processing is further performed to the output DMA module 25 via the connection switching section 21.

(Flow F46): Subsequently, the output DMA module 25 writes (stores) the processed pixel data output from the image processing module 23-3 of the connection destination via the connection switching section 21 in the DRAM 500 by DMA via the DMA bus 10.

In this manner, the image processing device 1 can perform subsequent image processing on processed pixel data (externally processed pixel data) after the external extension processing device 1000 performs the external image processing from the middle of the pipeline processing configured in the image processing section 20. In other words, in the image processing device 1, the input/output module 24 can be used only for transmission (input) of externally processed pixel data from the external extension processing device 1000. In other words, the image processing device 1 can perform pipeline processing configured in the image processing section 20 from the middle thereof as if pipeline processing were performed on pixel data included in the block image data stored in the DRAM 500.

### Second Application Example

Next, a second application example of the present invention will be described. The second application example is an example of a configuration in which only transmission (output) of the processed pixel data to the external component is implemented by operating only the component related to the transmission (output) of the processed pixel data to the outside of the image processing section in the input/output module provided in the image processing section. Also, in the following description, for example, a case in which the image processing device 1 according to the first embodiment of the present invention is mounted in an imaging device such as a still-image camera (hereinafter referred to as an “imaging device 450”) will be described. Also, the first application example can also be conceived in a similar manner for the image processing device 2 of the second embodiment and the image processing device 3 of the third embodiment.

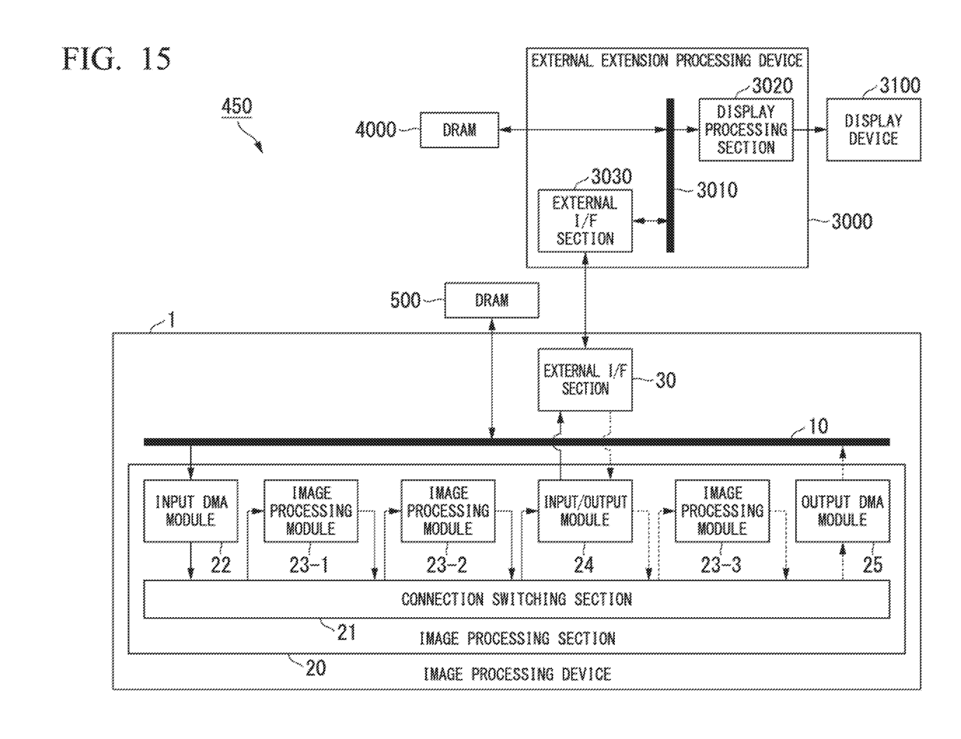

FIG. 15 is a block diagram showing a schematic configuration of the second application example in which the image processing device 1 according to the first embodiment of the present invention is mounted. In FIG. 15, in the imaging device 450 having the configuration of the second application example, a DRAM 500, an external extension processing device 3000 including a DMA bus 3010, a display processing section 3020, and an external interface (I/F) section 3030, a display device 3100, and a DRAM 4000 are collectively shown as components related to the image processing device 1. Also, in FIG. 15, as in the imaging device 100 shown in FIG. 1 and the imaging device 400 shown in FIG. 13, shown of other components connected to each component provided in the imaging device 450 and the DMA bus 10 in the image processing device 1 is also omitted.

For example, the display device 3100 is a display device such as a liquid crystal display (LCD) for displaying image data in the imaging device 450 processed by the external extension processing device 3000. Also, the external extension processing device 3000 is a display processing device (system LSI) for outputting image data obtained by performing predetermined display processing to be displayed on the display device 3100 with respect to the pixel data input from the image processing device 1. Also, the DRAM 4000 is a data storage section configured to store various data processed in the external extension processing device 3000. Also, the DRAM 4000 may be a data storage section similar to the DRAM 700 connected to the external extension processing device 600 in the imaging device 100 shown in FIG. 1 or the DRAM 2000 connected to the external extension processing device 1000 in the imaging device 400 shown in FIG. 13. In other words, the DRAM 4000 may be similar to the DRAM 700 or DRAM 2000, except that the DRAM 4000 is connected to the external extension processing device 3000.

In the image processing device 1 shown in FIG. 15, processed pixel data obtained by partially performing pipeline processing of image processing in the image processing section 20 is output to the external extension processing device 3000. More specifically, in the image processing device 1 shown in FIG. 15, the image processing section 20 outputs processed pixel data obtained by performing pipeline processing based on various predetermined image processing before the image processing module 23-2 on pixel data read from the DRAM 500 to the external extension processing device 3000. Thus, in the image processing section 20, the input/output module 24 is connected to the stage subsequent to the image processing module 23-2. In other words, in the image processing section 20, the connection switching section 21 switches the connection of each component so that the output terminal of the image processing module 23-2 and the input terminal of the input/output module 24 are connected. Then, in the image processing section 20, the components related to the transmission (output) of the processing pixel data to the external extension processing device 3000, i.e., only the image processing module input control section 241, the output buffer section 242, and the external output control section 243 provided in the input/output module 24, are operated. Thereby, in the image processing device 1 shown in FIG. 15, processed pixel data obtained by performing pipeline processing for sequentially performing image processing of the image processing module 23-1 and image processing of the image processing module 23-2 on pixel data read from the DRAM 500 is output to the external extension processing device 3000.

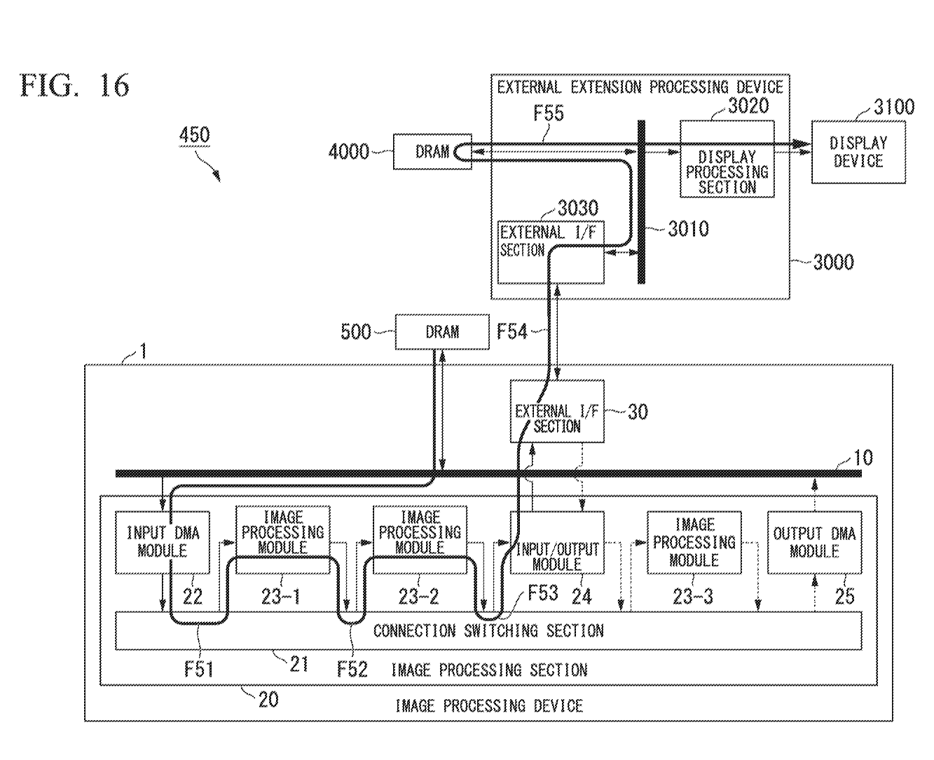

Next, a flow of data in pipeline processing when the image processing section outputs processed pixel data obtained by partially performing the pipeline processing of image processing to the external extension processing device 3000 will be described. FIG. 16 is a diagram schematically showing the flow of pixel data including the input/output module 24 provided in the image processing section 20 within the image processing device 1 according to the second application example of the present invention. In FIG. 16, the flow of pixel data when the pipeline processing configured in the image processing section 20 is partially performed and the pixel data is output to the external extension processing device 3000 is shown. More specifically, a flow of pixel data when the pixel data is output to the external extension processing device 3000 by incorporating the input/output module 24 into a stage subsequent to the image processing module 23-2 provided in the image processing section 20 within the image processing device 1 and performing pipeline processing until the image processing module 23-2 in the configuration of the imaging device 450 shown in FIG. 15 is shown.

In the pipeline processing in the image processing section 20 provided in the image processing device 1 shown in FIG. 15, the image processing module 23 and the external extension processing device 3000 perform predetermined different image processing on input pixel data or processed pixel data in parallel in the same period, so that the pipeline processing is smoothly performed. However, in the description of the flow of the pixel data shown in FIG. 16, for ease of description, as in the description of the flow of pixel data in the image processing device 1 mounted in the imaging device 100 shown in FIG. 6 and the description of the flow of pixel data in the image processing device 1 mounted in the imaging device 400 shown in FIG. 14, a flow of data focused on pixel data of one processing unit will be described. In the flow of pixel data shown in FIG. 16, processing is performed in the following flow.

(Flow F51): First, the input DMA module 22 reads pixel data included in block image data stored in the DRAM 500 for each unit line by DMA via the DMA bus 10 and outputs the read pixel data to the image processing module 23-1 of the connection destination for performing the next image processing via the connection switching section 21.

(Flow F52): Subsequently, the image processing module 23-1 performs predetermined image processing on the pixel data output from the input DMA module 22 of the connection destination via the connection switching section 21 and outputs processed pixel data after image processing is performed to the image processing module 23-2 of the connection destination for performing the next image processing via the connection switching section 21.

(Flow F53): Subsequently, the image processing module 23-2 performs predetermined image processing on the processed pixel data output from the image processing module 23-1 of the connection destination via the connection switching section 21 and outputs processed pixel data after the image processing is further performed to the external extension processing device 3000 of the output destination via the connection switching section 21. At this time, the connection switching section 21 outputs the processed pixel data output from the image processing module 23-2 to the input/output module 24.

(Flow F54): Subsequently, the input/output module 24 directly outputs the processed pixel data output from the image processing module 23-2 of the connection destination via the connection switching section 21 to the external interface section 30 without involving the DMA bus 10 and transmits the output processed pixel data to the external extension processing device 3000 via the external interface section 30.

(Flow F55): Subsequently, the external extension processing device 3000 receives the processed pixel data transmitted via the external interface section 30 provided in the image processing device 1 by the external interface section 3030 and temporarily writes (stores) the received processed pixel data in the DRAM 4000 via the DMA bus 3010. Thereafter, the external extension processing device 3000 reads the processed pixel data stored in the DRAM 4000, outputs the read processed pixel data to the display processing section 3020 via the DMA bus 3010, and outputs image data obtained by performing a predetermined display process on the processed pixel data read by the display processing section 3020 to the display device 3100. Thereby, the display device 3100 displays an image corresponding to the image data output from the external extension processing device 3000.

In this manner, in the image processing device 1, it is also possible to output the processed pixel data obtained by partially performing the pipeline processing configured in the image processing section 20 to the external extension processing device 3000. In other words, in the image processing device 1, the input/output module 24 can be used for only transmission (output) of processed pixel data to the external extension processing device 3000. In other words, in the image processing device 1, it is possible to partially perform the pipeline processing configured in the image processing section as if processed pixel data obtained by performing the pipeline processing were written (stored) in the DRAM 500.

According to the first application example and the second application example, there is provided an image processing device (the image processing device 1) in which an image processing section (the image processing section 20) for configuring a pipeline by connecting a plurality of processing modules (the image processing modules 23-1 to 23-3) for performing predetermined processing on input data (pixel data) in series and performing pipeline processing by each of the image processing modules 23-1 to 23-3 sequentially performing the processing is connected to a data bus (the DMA bus 10) and performs image processing on pixel data read from a data storage section (the DRAM 500) connected to the DMA bus 10 via the DMA bus 10, wherein the image processing section 20 includes an input/output module (the input/output module 24) incorporated into the pipeline as a processing module configured to perform processing different from the processing to be performed by each of the image processing modules 23-1 to 23-3, and wherein the input/output module 24 directly outputs processed data (input data, pixel data, or processed pixel data) obtained by performing the processing of a first processing module (for example, the image processing module 23-2) which is the processing module located at a stage previous to a position where the input/output module 24 is incorporated into the pipeline to an external processing section (for example, the external extension processing device 3000) outside the image processing section 20 without involving the DMA bus 10 (as external output data), directly outputs externally processed data (external input data or externally processed pixel data) input from the external processing section (for example, the external extension processing device 1000) outside the image processing section 20 to a second processing module (for example, the image processing module 23-2) which is the processing module located at a stage subsequent to the position where the input/output module 24 is incorporated into the pipeline without involving the DMA bus 10, or performs both a direct output of the processed data (the input data, the pixel data, or the processed pixel data) to the external processing section (for example, the external extension processing device 600) outside the image processing section 20 without involving the DMA bus 10 (as external output data) and a direct output of the externally processed data (the external input data or the externally processed pixel data) input by the external extension processing device 600 performing the external processing (external image processing) on the processed data (the input data, the pixel data, or the processed pixel data) to the second processing module (for example, the image processing module 23-3) without involving the DMA bus 10 (as output data).

As described above, in the image processing device 1 of the first application example, the external extension processing device 1000 can perform subsequent image processing on processing pixel data (externally processed pixel data) after external image processing is performed from the middle of the pipeline processing configured in the image processing section 20 by operating only the external input control section 244, the input buffer section 245, and the image processing module output control section 246 provided in the input/output module 24. Also, as described above, in the image processing device 1 of the second application example, it is possible to output processed pixel data obtained by partially performing the pipeline processing configured in the image processing section 20 to the external extension processing device 3000 by operating only the image processing module input control section 241, the output buffer section 242, and the external output control section 243 provided in the input/output module 24. Thereby, in the image processing device 1 of the first application example and the image processing device 1 of the second application example, it is possible to incorporate image processing of an external component (the external extension processing device 1000 or the external extension processing device 3000) which was not assumed during the development of the image processing device 1 into image processing of the pipeline processing which has already been configured.

Also, in the image processing device 1 of the first application example, a configuration in which externally processed pixel data temporarily written (stored) in the DRAM 2000 connected to the external extension processing device 1000 is transmitted (input) to the image processing device 1 has been described. However, the external extension processing device 1000 may be configured to transmit (input) externally processed pixel data without involving the DRAM 2000. In other words, the external extension processing device 1000 may be configured to transmit (input) the externally processed pixel data output by the imaging processing section 1020 to the image processing device 1 of the first application example via the DMA bus 1010 and the external interface section 1030. Also, in the image processing device 1 of the second application example, a configuration in which a display process is performed after the processed pixel data transmitted (output) by the image processing device 1 is temporarily written (stored) in the DRAM 4000 connected to the external extension processing device 3000 has been described. However, the external extension processing device 3000 may be configured to receive processed pixel data transmitted (output) by the image processing device 1 without involving the DRAM 4000. In other words, the external extension processing device 3000 may be configured to output processed pixel data transmitted (output) by the image processing device 1 to the display processing section 3020 via the external interface section 3030 and the DMA bus 3010.

As described above, according to each embodiment of the present invention, the image processing section provided in the image processing device includes the input/output module for directly connecting to a component provided outside the image processing section without involving the DMA bus. In other words, in each embodiment of the present invention, the input/output module for directly connecting to an image processing device for performing image processing which is not executed by any image processing module provided in the image processing section without involving the DMA bus is provided to extend the image processing to be executed in the image processing section. Also, in each embodiment of the present invention, the connection switching section for switching the connection of each processing module provided in the image processing section, i.e., switching the connection of the pipeline configured in the image processing section, is provided. In each embodiment of the present invention, when the image processing to be executed by the image processing device is extended, the input/output module is incorporated as an image processing module into the pipeline configured in the image processing section. Thus, in each embodiment of the present invention, it is possible to incorporate image processing to be executed by a component provided outside the image processing section into a series of image processing based on the pipeline processing to be executed by each image processing module provided in the image processing section. Thereby, in each embodiment of the present invention, as in the pipeline processing performed by the image processing modules provided in the image processing section, it is possible to extend a series of image processing based on pipeline processing of the image processing section.

Moreover, in each embodiment of the present invention, the input/output module provided in the image processing device directly transmits pixel data for use in image processing to be extended to the component provided outside the image processing section without involving the DMA bus. Thus, in each the embodiment of the present invention, it is possible to perform a series of image processing in a state in which the image processing to be extended is incorporated without separating the pipeline processing already configured by the image processing modules provided in the image processing section. Thus, in each embodiment of the present invention, it is possible to extend image processing without causing overload on the bus bandwidth of the DMA bus and increase of the power consumption of the image processing device, or the like and deteriorating the performance of the imaging device equipped with the image processing device. For example, it is possible to implement an imaging device for performing basic image processing by mounting the image processing device 1 of the first embodiment and implement an imaging device for high-performance image processing by mounting both the image processing device 1 and the external extension processing device 600.

Also, in each embodiment of the present invention, the configuration in which each processing module constituting the pipeline is provided in the image processing section provided in the image processing device has been described. However, in addition to the image processing device, various processing devices are conceivable as the processing device for performing a series of processing according to the pipeline configuration. In addition to imaging devices, various systems are also conceivable as systems requiring the extension of a series of processing according to pipeline configuration. Accordingly, a processing device and a system to which the concept of the present invention can be applied are not limited to the image processing device and the imaging device described in each embodiment of the present invention. The concept of the present invention can be similarly applied to any system equipped with a processing device for performing pipeline processing by connecting a plurality of processing modules in series to configure a pipeline. In this case, it is possible to obtain effects similar to those of the present invention.

While preferred embodiments of the present invention have been described and shown above, the present invention is not limited to the embodiments and modified examples thereof. Within a range not departing from the gist or spirit of the present invention, additions, omissions, substitutions, and other modifications to the configuration can be made.

Also, the present invention is not to be considered as being limited by the foregoing description, and is limited only by the scope of the appended claims.

What is claimed is:

1. An image processing device in which an image processing section for configuring a pipeline by connecting a plurality of processing modules for performing predetermined processing on input data in series and performing pipeline processing by each of the processing module sequentially performing the processing is connected to a data bus and performs image processing on data read from a data storage section connected to the data bus via the data bus,
wherein the image processing section includes
an input/output module incorporated into the pipeline as a processing module configured to perform processing different from the processing to be performed by each of the processing modules, and
wherein the input/output module outputs processed data obtained by performing the processing of a first processing module which is the processing module located at a stage previous to a position where the input/output module is incorporated into the pipeline to an external processing section outside the image processing section, via an external interface section for inputting and outputting data to and from the external processing section without involving the data bus, and outputs externally processed data input by the external processing section performing external processing on the processed data to a second processing module which is the processing module located at a stage subsequent to the first processing module in the pipeline via the external interface section without involving the data bus,
wherein the external interface section converts data to be transmitted in a format according to a specification of the image processing section when pixel data is received from the input/output module into a format of pixel data to be processed by the external processing section, and
wherein the external interface section converts a format of externally processed pixel data output from the external processing section into a format in which the image processing section performs image processing when the externally processed pixel data is transmitted from the external processing section.

2. An image processing device in which an image processing section for configuring a pipeline by connecting a plurality of processing modules for performing predetermined processing on input data in series and performing pipeline processing by each of the processing module sequentially performing the processing is connected to a data bus and performs image processing on data read from a data storage section connected to the data bus via the data bus,
wherein the image processing section includes
an input/output module incorporated into the pipeline as a processing module configured to perform processing different from the processing to be performed by each of the processing modules, and
wherein the input/output module outputs processed data obtained by performing the processing of a first processing module which is the processing module located at a stage previous to a position where the input/output module is incorporated into the pipeline to an external processing section outside the image processing section, via an external interface section for inputting and outputting data to and from the external processing section without involving the data bus, outputs externally processed data input from the external processing section to a second processing module which is the processing module located at a stage subsequent to the position where the input/output module is incorporated into the pipeline via the external interface section without involving the data bus, or performs both output of the processed data to the external processing section via the external interface section without involving the data bus and output of the externally processed data input by the external processing section performing the external processing on the processed data to the second processing module via the external interface section without involving the data bus,
wherein the external interface section converts data to be transmitted in a format according to a specification of the image processing section when pixel data is received from the input/output module into a format of pixel data to be processed by the external processing section, and
wherein the external interface section converts a format of externally processed pixel data output from the external processing section into a format in which the image processing section performs image processing when the externally processed pixel data is transmitted from the external processing section.

3. The image processing device according to claim 1,
wherein the input/output module includes
an output buffer section configured to temporarily store the processed data; and
an input buffer section configured to temporarily store the externally processed data,
wherein the input/output module temporarily stores the processed data output by the first processing module in the output buffer section and outputs the processed data stored in the output buffer section in response to a request from the external processing section, and
wherein the input/output module temporarily stores the externally processed data output by the external processing section in the input buffer section and outputs the externally processed data stored in the input buffer section in response to a request from the second processing module.

4. The image processing device according to claim 3,
wherein the input/output module further includes
a processing module input control section configured to control writing of the processed data in the output buffer section on the basis of a storage capacity of the output buffer section;
an external output control section configured to control reading of the processed data from the output buffer section on the basis of the amount of the processed data stored in the output buffer section;
an external input control section configured to control writing of the externally processed data in the input buffer section on the basis of the storage capacity of the input buffer section; and
a processing module output control section configured to control reading of the externally processed data from the input buffer section on the basis of the amount of the externally processed data stored in the input buffer section.

5. The image processing device according to claim 4,
wherein the processing module input control section writes the processed data in the output buffer section for each unit for performing the processing in the first processing module,
wherein the external output control section reads the processed data stored in the output buffer section for each unit for performing the external processing in the external processing section,
wherein the external input control section writes the externally processed data in the input buffer section for each unit for performing the external processing in the external processing section, and
wherein the processing module output control section reads the externally processed data stored in the input buffer section for each unit for performing the processing in the second processing module.

6. The image processing device according to claim 5,
wherein the external output control section adds output destination information indicating any external processing section to which the processed data is output among a plurality of external processing sections to the processed data.

7. The image processing device according to claim 6,
wherein the output destination information is included in additional information in which information of a setting of the external processing to be performed on the processed data by the external processing section is shown.

8. The image processing device according to claim 1,
wherein the input/output module is incorporated at at least one position of a beginning, a middle, and an end of the pipeline.

9. The image processing device according to claim 5,
wherein the processed data and the externally processed data are image data,
wherein each of a unit for performing the processing in the first processing module and the second processing module and a unit for performing the external processing in the external processing section is a size in which the image data of one frame is divided into a plurality of predetermined blocks, and
wherein the storage capacity of the output buffer section and the storage capacity of the input buffer section are less than the storage capacity for storing pixel data included in the image data of one frame.
